(19) United States
(12) Patent Application Publication
(10) Pub. No.: US 2013/0157628 A1
(43) Pub. Date: Jun. 20, 2013

(54) SMART PHONE BASED ELECTRONIC FENCE SYSTEM

(71) Applicants: BRYANT Y. KIM, DALLAS, TX (US); JOON S. KIM, DALLAS, TX (US); JAMES A. HARRISON, Addison, TX (US)

(72) Inventors: BRYANT Y. KIM, DALLAS, TX (US); JOON S. KIM, DALLAS, TX (US); JAMES A. HARRISON, Addison, TX (US)

(73) Assignee: DT SYSTEMS, INC., DALLAS, TX (US)

(21) Appl. No.: 13/528,156

(22) Filed: Jun. 20, 2012

Related U.S. Application Data
(63) Continuation-in-part of application No. 12/611,856, filed on Nov. 3, 2009.
(60) Provisional application No. 61/499,018, filed on Jun. 20, 2011.
(60) Provisional application No. 61/145,066, filed on Jan. 15, 2009.

(51) Int. Cl. A01K 15/02; A01K 27/00; H04M 3/42; A01K 15/04

(52) U.S. Cl. CPC A01K 15/023; A01K 15/04; A01K 27/009; H04M 3/42
USPC 455/414.1; 119/721

(57) ABSTRACT

An electronic fence system capable of guiding animals under training to return to a predetermined restricted area is disclosed. The fence system may utilize either a plurality of loops to determine direction of travel for a receiver unit or, alternatively, a GPS system. For embodiments utilizing the GPS system, electronic fences are defined in relation to GPS location information. A lock-down mode is used to contain an animal to a very constricted area when a control command is received to initialize the lock down mode or upon a specified condition. Specified conditions include the animal approaching or entering a specified area or, alternatively, a threshold level of charge being reached for a battery that provides power for the receiver unit. A smart phone is communicatively coupled to a controller or interface device which, in turn, is communicatively coupled to a trainer/receiver.

### CROSS REFERENCE TO RELATED PATENTS/PATENT APPLICATIONS

### Provisional Priority Claim

The present U.S. Utility patent application claims priority pursuant to 35 U.S.C. §119(e) to the following U.S. Provisional patent application which is hereby incorporated herein by reference in its entirety and made part of the present U.S. Utility patent application for all purposes:

1. U.S. Provisional Patent Application Ser. No. 61/499,018, entitled “Electronic Fence System,” (Attorney Docket No. DT013), filed 06-20-2011, pending.

### Continuation-in-Part (CIP) Priority Claim, 35 U.S.C. §120

The present U.S. Utility patent application also claims priority pursuant to 35 U.S.C. §120, as a continuation-in-part (CIP), to the following U.S. Utility patent application which is hereby incorporated herein by reference in its entirety and made part of the present U.S. Utility patent application for all purposes:

1. U.S. Utility patent application Ser. No. 12/611,856, entitled “Electronic Fence System,” (Attorney Docket No. DT012), filed 11-03-2009, pending, which claims priority pursuant to 35 U.S.C. §119(e) to the following U.S. Provisional patent application which is hereby incorporated herein by reference in its entirety and made part of the present U.S. Utility patent application for all purposes:
a. U.S. Provisional Application Ser. No. 61/145,066, entitled “Electronic Fence System,” (Attorney Docket No. DT012), filed Jan. 15, 2009, now expired.

U.S. Utility patent application Ser. No. 12/611,856 claims priority pursuant to 35 U.S.C. §119 to the following Korean Patent Application which is incorporated herein by reference in its entirety for all purposes:
b. Korean Patent Application Serial No. 1-1-2008-0764623-11 filed Nov. 4, 2008, pending.

### BACKGROUND OF THE INVENTION

1. Field of the Invention

The present invention relates to an electronic fence, and more particularly, to an electronic fence capable of guiding animals under training to return to a restricted area.

2. Description of the Related Art

In general, an invisible electronic fence (I-Fence) refers to a system for defining a certain range of areas whereby a moving object including a pet animal, a hunting dog, a working dog and a person lead active lives, and then monitoring and tracking its location by radiating a control signal in accordance with a communication protocol if he or she is out of the range.

The prior art system employs a method of installing a fence by laying electronic fence wires under the ground at a corresponding area.

Then, through using a radio signal obtained from the electronic wires, an electronic shock, vibration, or both of them simultaneously can be transferred to an animal.

Also, the transmitter includes a lightning protecting circuit for protecting the electronic fence wires from energy like a strike of lightning.

Also, when a pet animal (dogs and the like) departs from the fence and comes back there, an electronic shock may be occurred. Thus, when the animal gets a shock, he conceives the owner doesn't want him any more and can depart from the destination.

However, these prior art methods have such problems as described below:

That is, when an object departs from a limited region drastically, it is impossible to control the animal. As a result, there comes an uncontrollable state. References herein to objects herein are references to trainers and/or receivers worn by an animal that are capable of providing one or more different types of stimulation to contain the animal within a bounded area.

In prior art electronic fence systems, electric wires are laid over wide regions, consuming much time and cost. Furthermore, with electric wires, a visible fence is available only in the case of animals. However, when a laid wire is exposed to an animal, the wire can be easily broken causing the system to fail.

Also, communications between a master and a plurality of collars is uniformly operated, so it is difficult to manage it separately with such prior art systems.

Further, when an departs from a boundary area, it is impossible to track the position of the object.

In the meantime, FIG. 1 is a block diagram of showing a handheld master terminal according to a prior art electronic fence system. In FIG. 1, a transmitter 10 uses an electric wave wire antenna 15 to deliver an electric wave. The transmitter 10 includes an electric shock level controller 11 for adjusting an electric shock subjecting to an animal, an antenna check lamp 12, a power switch 13 and a transmitting output level regulator 14. In the following, the operating procedure of a handheld master terminal of a prior art electronic fence system such as FIG. 1 will be described.

### SUMMARY OF THE INVENTION

Accordingly, the present invention has been made to solve the above-mentioned problems occurring in the prior art, and the present invention provides an electronic fence system and a control method thereof for acting as a suitable guide which monitors activities of an object through using radio communication and restricts the same within a certain range of area via data communication in order to return the animal to the limited area.

### BRIEF DESCRIPTION OF THE DRAWINGS

The above and other aspects, features and advantages of the present invention will be more apparent from the following detailed description taken in conjunction with the accompanying drawings, in which:

FIG. 1 is a block diagram of showing a handheld master terminal according to a prior art electronic fence system;

FIG. 2 is a block diagram of showing an object control unit for an electronic fence system;

FIG. 3 is a conception view of an electronic fence system to which the present invention is applied;

FIG. 4 is a block diagram of one example of a handheld master terminal according to the present invention;

FIG. 5 is a block diagram of another example of a handheld master terminal according to the present invention;

FIG. 6 is a block diagram of one example of an object control unit according to the present invention;

FIG. 7 is a block diagram of another example of an object control unit according to the present invention;

FIG. 8 is a flow chart showing a control method of an electronic fence system according to an embodiment of the present invention;

FIG. 9 is a detailed flow chart showing an operation example of a fence mode in FIG. 8;

FIG. 10 is a detailed flow chart showing an operation example of a tracking mode in FIG. 8;

FIG. 11 is a detailed flow chart showing an operation example of a training mode in FIG. 8;

FIG. 12 is a conception view showing an example wherein the present invention is applied in the case of an animal;

FIG. 13 is a conception view showing one operation example when FIG. 3 is applied to a fence mode;

FIG. 14 is a flow chart showing an operation of the fence mode in FIG. 13;

FIG. 15 is a conception view showing another operation example when FIG. 3 is applied to a fence mode;

FIG. 16 is a flow chart showing an operation of the fence mode in FIG. 15;

FIG. 17 is a conception view showing one operation example when FIG. 3 is applied to a tracking mode;

FIG. 18 is a flow chart showing an operation of the tracking mode in FIG. 17;

FIG. 19 is a conception view showing an example of performing a sound processing according to the present invention;

FIG. 20 is a conception view showing an example of expanding a fence range according to the present invention;

FIG. 21 is a conception view showing a construction example of an object control unit according to the present invention;

FIG. 22 is a table showing a menu example of a tracking mode of a handheld master terminal;

FIG. 23 is a conception view showing a method of setting a fence area in a fence mode of a handheld master terminal;

FIG. 24 is a table showing one menu example of a fence mode of a handheld master terminal;

FIG. 25 is a table showing another menu example of a fence mode of a handheld master terminal;

FIG. 26 is a conception view showing a construction example of a basic screen in a compass mode of a handheld master terminal;

FIG. 27 is a table showing an example of an asset menu for managing an object control unit of a handheld master terminal;

FIG. 28 is a table showing an example of a group menu for managing a group of a handheld master terminal;

FIG. 29 is a table showing an example of a setup menu for managing a system of a handheld master terminal;

FIG. 30 is a table showing an example of a mark menu of a handheld master terminal;

FIG. 31 is a conception view showing main functions of an electronic fence system wherein the present invention is applied in the case of an animal;

FIG. 32 is a conception view showing main functions of an electronic fence system wherein the present invention is applied in the case of a human;

FIG. 33 is a conception view showing an example of calculating locations in an electronic fence system of the present invention;

FIG. 34 is a flow chart of a location calculation method of an electronic fence system according to an embodiment of the present invention;

FIG. 35 is a conception view showing the first operation method of an electronic system according to the present invention;

FIG. 36 is a conception view showing the second operation method of an electronic system according to the present invention;

FIG. 37 is a conception view showing an operation example of a fence mode of an electronic fence system according to the present invention;

FIG. 38 is a conception view showing an operation example of a lock-down mode of an electronic fence system according to the present invention;

FIG. 39 is a conception view showing the first setting method of an electronic fence in an electronic fence system according to the present invention;

FIG. 40 is a conception view showing the second setting method of an electronic fence in an electronic fence system according to the present invention;

FIGS. 41 (a) and (b) are conception views showing the first range expanding method in an electronic fence system according to the present invention;

FIG. 42 is a conception view showing the second range expanding method in an electronic fence system according to the present invention;

FIG. 43 is a conception view showing the third range expanding method in an electronic fence system according to the present invention;

FIG. 44 is a conception view showing an operation method of a cellular network and an SMS in an electronic fence system according to the present invention;

FIG. 45 is a flow chart showing the first reference location setting method in an electronic fence system according to the present invention;

FIG. 46 is a conception view showing the system construction of a fence mode in an electronic fence system according to the present invention;

FIG. 47 is a flow chart showing the operation of a fence mode and a tracking mode in an electronic fence system according to the present invention;

FIG. 48 is a conception view showing an operation example of a tracking mode in an electronic fence system according to the present invention;

FIG. 49 is a flow chart showing an operation example in an electronic fence system according to the present invention;

FIG. 50 is a flow chart of operating in a fence mode in FIG. 49;

FIG. 51 is a flow chart of operating in a tracking mode in FIG. 49;

FIG. 52 is a flow chart of operating in a training mode in FIG. 49;

FIG. 53 is a conception view showing an example of a call command in the present invention;

FIG. 54 is a conception view showing the structure of a GPS reception antenna, which is movable, according to the present invention; and

FIG. 55 is a conception view showing the construction of control command keys of a handheld master terminal having a built-in GPS antenna according to the present invention.

The above and other objects, features, and advantages of the present invention will be apparent from the following detailed description of the preferred embodiments of the invention in conjunction with the accompanying drawings, in which:

FIG. 56 is a functional block diagram of an electronic fence system according to one embodiment of the invention.

FIG. 57 is a functional illustration of an electronic fence system according to one embodiment of the invention.

FIG. 58 is a functional illustration of a transmitter unit display for defining fence boundaries for an electronic fence system according to one embodiment of the invention.

FIG. 59 is a functional block diagram that illustrates an additional aspect of the embodiments of the invention.

FIG. 60 is a functional block diagram that illustrates an electronic fence system that utilizes a cellular network element to support communications between transmitter units and receiver units according to an embodiment of the invention.

FIGS. 60 and 61 are functional network diagrams of a mesh network of electronic fence components according to two embodiment of the invention.

FIG. 62 is a functional block diagram of a modularized receiver unit according to one embodiment of the invention.

FIG. 63 is a functional block diagram of a receiver unit according to one embodiment of the invention.

FIG. 64 is a functional block diagram of a receiver unit according to one embodiment of the present invention.

FIG. 65 is a flowchart that illustrates a method according to one embodiment of the invention.

FIG. 66 is a functional block diagram of a hand held transmitter unit for an animal training system according to one embodiment of the invention.

FIG. 67 is a plurality of diagrams that illustrate hand held controller displays in relation to transmitter commanded intensity curves that reflect operation of a controller according to one embodiment of the invention for the Rise mode of operation.

FIG. 68 is an embodiment of a fence system that includes a smart phone that communicates with a controller which in turn communicates with a trainer.

FIG. 69 is an alternative embodiment of a fence system that includes a smart phone that communicates with a wireless interface device that, in turn, communicates with a trainer.

FIGS. 70-71 are signal sequence diagrams that illustrate operation according to one or more embodiments of the invention.

FIGS. 72-73 are flow charts that illustrate operation according to one or more embodiments of the invention.

FIGS. 74-76 are functional block diagrams that illustrate alternative embodiments of a smart phone and a controller.

FIGS. 77-79 are system diagrams that illustrate various aspects of the embodiments of a electronic fence system.

FIG. 80 is a functional block diagram of an alternative embodiment of the invention.

FIG. 81 is a functional block diagram of a receiver according to one embodiment of the invention.

### DETAILED DESCRIPTION OF THE EXEMPLARY EMBODIMENTS

Hereinafter, exemplary embodiments of an electronic fence system using a GPS according to the present invention will be described with reference to the accompanying drawings. Further, in the following description of the present invention, a detailed description of known functions and configurations incorporated herein will be omitted when it may make the subject matter of the present invention rather unclear. Furthermore, the following terms are defined in consideration of their functions in the present invention, but they can be varied according to intentions of a user and/or an operator or a judicial precedent, and therefore the meaning of each term must be read based on the entire contents of the present specification.

Particularly, the present invention can act as a guide which monitors activities of an object through using radio communication and restricts the same within a certain range of area via data communication in order to return the animal to the limited area.

Some conceptions being employed in the present invention will be defined below:
E-Fence (Electronic Fence): refers to a fence using radio frequencies, which is called ‘electronic fence’. It is also called I-Fence (Invisible Fence). The E-Fence of the present invention means an electronic fence using a bidirectional radio frequency telecommunication solution technology (for example, ZigBee) and a GPS technology. The E-Fence means a system for defining a certain range of areas whereby a moving object including a pet animal, a hunting dog, a working dog and a person lead active lives, and if he or she is out of the range, then monitoring by radiating a defined signal.
free region: refers to a space in which an object leads active lives freely in a limited area.
boundary area: refers to a region which is not out of a defined fence, and also a region in which a warning signal from a handheld master terminal is received, however a warning signal can occur in itself (a fence mode).
limited area: refers to a region to be controlled in the final stage among an area where a fence is constructed using radio frequencies, and this area is controlled by sending various warning messages to possibly prevent an object from departing from this area.
GPS module: refers to a global positioning system in which location information can be obtained by adding a GPS chipset.
Handheld master terminal: means a control system for serving as a control tower and performing a monitoring function in the present invention.
Object control unit: means an attachment adhering to an object. (For example, this means an object control unit in the case of an animal). An object control unit may also be referenced in here as a trainer or a receive that is worn by the animal.
Animal Confinement: means an electronic fence for an animal.
Dog Collar: means an object control unit 200 in the present invention, which is in contrast to a handheld master terminal or controller. In particular, the dog collar reporting its location/condition information via a radio signal under the control of the handheld master terminal and accept/execute a command provided by the handheld master terminal.

Also, a handheld master terminal and an object control unit, that is a main component of the present invention, perform the following functions:
Hand master terminal: refers to a device 100 for monitoring a motion of an object, this device is equipped with a LCD display, and receives a radio signal provided by an object control unit to perform a proper control.
Object control unit: means a dog collar 200 attached to an object, this provides a piece of information regarding a motion of an object (location, time, a distance from a terminal, a travel route, etc.) to a handheld master terminal 100 and also provides the handheld master terminal 100 with precise orientation information using a GPS module. Also, when an object departs from a limited area, the object control unit may send a defined signal (a sound, a vibration, and in the case of an animal, an electric stimulus is added) and receive a command (a sound, a vibration and an electric stimulus) directly from the handheld master terminal to execute that command.

Also, the embodiments of the present invention can employ the following technologies to realize the concept of an invisible fence, and the detail of the technologies will be described below:
A technology that identifies a distance between two components using geographic information provided by a global positioning satellite (GPS) of a region in which the invisible fence is to be set, and a bidirectional RF communication method, and confines and manages an object in a preset invisible fence.
A technology that raises LOS (line of sight), which is a possible managing area, by using a bidirectional RF communication method capable of configuring a network in communication between a handheld master terminal and each object control unit and by adding an external power amp or the like to increase output power.
A technology that obtains a reference location by embedding a GPS module in the handheld master terminal
A technology that calculates an orientation angle, a distance or the like of each object control unit in the handheld master terminal by collecting GPS information by using a bidirectional RF modem method from each object control unit.
A technology that manages an object by operating an audio alarm, a vibration or stimulation in an object control unit when a piece of location/orientation information transmitted from the object control unit is out of a predefined boundary.
A technology that manages a plurality of object control units by one handheld master terminal using a bidirectional RF modem method capable of configuring a network.
A technology that develops a handheld master terminal based on a GPS module and a bidirectional RF modem method capable of configuring a network to have the above functions.
A technology that operates a vibration in an object control unit in certain conditions using a GPS module and a bidirectional RF modem method capable of configuring a network.
A technology that operates a beep sound in an object control unit in certain conditions using a GPS module and a bidirectional RF modem method capable of configuring a network.
A technology that operates stimulation in an object control unit in certain conditions using a GPS module and a bidirectional RF modem method capable of configuring a network.
A technology that operates a horn in an object control unit in certain conditions using a GPS module and a bidirectional RF modem method capable of configuring a network.
A technology for an object control unit which is called by a handheld master terminal to recognize itself and perform a given command (a sound, a vibration or an electric shock).
A technology that sends a recorded voice or a direct voice in a handheld master terminal using a GPS module and a bidirectional RF modem method capable of configuring a network.
A technology that operates a LED in an object control unit in certain conditions using a GPS module and a bidirectional RF modem method capable of configuring a network.

The present invention has the following characteristics:

Firstly, a wireless application solution can be realized, wherein the wireless application collects GPS information/status information of an object control unit to be monitored within miles of the width/the length, and has a certain communication range corresponding to the collected information.

Also, a handheld master terminal 100 comprises a CPU, a bidirectional RF modem capable of configuring a network, a GPS, a display LCD, etc., and its shape can be of a mobile handset.

Also, an object control unit 200 comprises a GPS receiver and a bidirectional RF modem capable of configuring a network.

Also, in an application solution, communication between the handheld master terminal 100 and the object control unit 200 can be performed using the bidirectional RF modem technology capable of configuring a network and a proper communication distance can be obtained by the bidirectional RF modem technology capable of configuring a network.

Also, a piece of location information can be collected by embedding GPS module in the handheld master terminal 100 and the object control unit 200.

Also, the handheld master terminal 100 may calculate an orientation angle, a distance, etc. of each object control unit 200 by collecting GPS information from the object control unit 200.

Also, if the location information of an object control unit 200 is out of a condition or a boundary predefined by the handheld master terminal 100, the electronic fence system may generate an audio alarm, a visible alarm, a vibration alarm or an electric shock, and the system may identify the location/status of the handheld master terminal 100 and the object control unit 200.

Also, a manual mode, which is a direct training mode, can transmit a signal directly to the object control unit 200.

Also, in order to manage a number of object control units 200, one handheld master terminal acting as a coordinator can construct a star network and manage a number of object control units 200 within a communication enabled managing area.

Also, its managing area and quantity scalability can construct a mesh/tree network to use a routing function, so that its managing area and managing quantity can increase further.

In addition, FIG. 2 is a block diagram of showing an object control unit of an electronic fence system that limits stimulation for a returning animal.

In FIG. 2, a transmitter 20 sends a RF signal having a plurality of control signals, wherein the plurality of control signals refers to a control signal of reacting (for example, giving a stimulus) when an animal approaches the boundary of a predefined limited area. Also, the transmitter 20 can generate a plurality of control signals to indicate desired functions.

An electronic fence includes one power switch, a transmitting level controller, an electric shock level controller 23 for selecting shock levels from ‘0’ to a possible maximum value, a function selecting switch, a loop antenna confirming lamp, a beep sound selection lamp, an electric shock selection lamp, an automatic selection lamp and a first loop antenna 29 and a second loop antenna 30.

The power switch 21 may supply an electric power for the transmitter 20. A power level controller 22 of the transmitter 20 may control the power level of the transmitter 20. The electric shock level controller 23 may set the level of an electric shock. The function selecting switch 24 may be used to select a desired function. The loop antenna confirming lamp 25 may indicate if any part of loop antennas causes a problem. The beep sound selection lamp 26 may confirm whether a high frequency beep sound has been selected. The electric shock selection lamp 27 and the automatic selection lamp 28, respectively, may confirm whether an electric shock has been selected and whether each of them has been selected automatically.

However, the foregoing prior art electronic fence may generate a certain level of an electronic shock when an animal departs from a limited area, but it is ineffective. Moreover, an electronic shock can occur when an escaped animal return to the limited area. At this time, the animal cannot enter the inside of the electronic fence due to the electric shock, and finally runs far away.

In an excited condition, an animal can run with a velocity of approximately 100 Km/hour (62 miles/hour). This means that the animal can extricate a limited area with this velocity before an electric shock is operating. Moreover, the animal tends to return at a very slow pace when he or she regains safety and comes back home. The prior art electronic fence cannot detect the direction of an animal, which is moving towards a limited area, but it can generate an electric shock when an animal enters the limited area. When an animal comes into the set limited area and thus an electric shock occurs, that animal may be disturbed from the prior art electronic fence and escape far away, and finally it may be caught in a traffic accident or lost. Additionally, the conventional electronic fence may be used only in a fixed region as fixed installments.

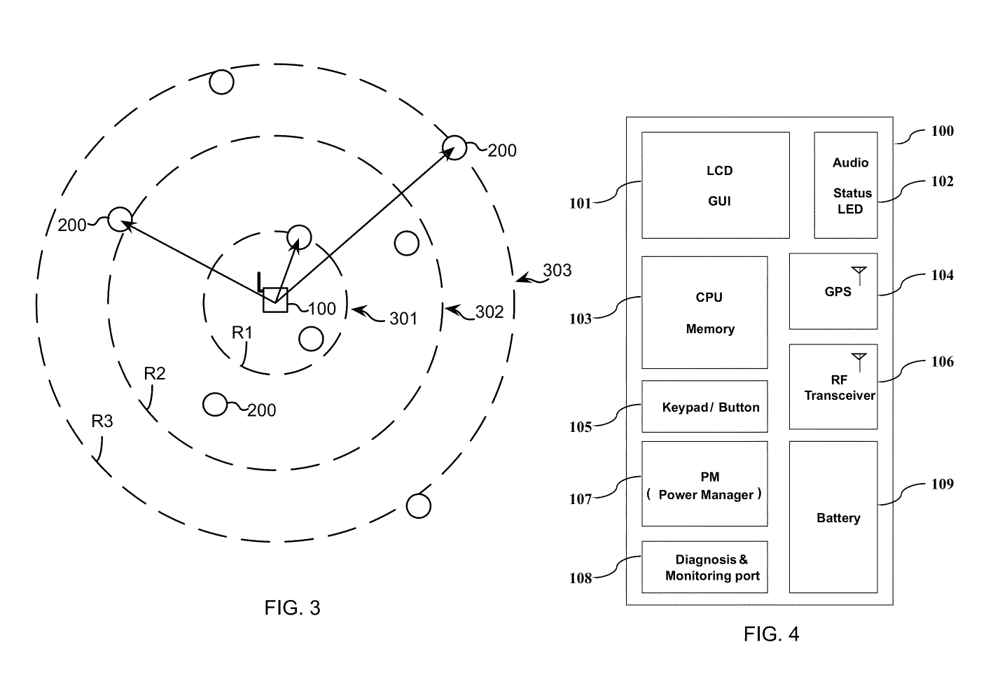

FIG. 3 is a conception view of an electronic fence system to which the present invention is applied. In FIG. 3, communication between a handheld master terminal 100 and each object control unit 200 can be performed using a Zigbee modem module in one embodiment of the invenntion. Also, using Zigbee solution+high-gain antenna enables communication within a radius of the minimum 1 mile around a handheld master terminal 100.

The handheld master terminal 100 may receive location information/status information of terminals within its coverage periodically for monitoring/managing.

Configuring a star network when initially configuring a network enables forming a managing group in one handheld master terminal 100.

Also, assigning an ID to each object control unit 200 enables setting and operating a managing group in each handheld master terminal 100.

Each object control unit 200 can be operated to send location information or status information periodically according to an operating mode or send location information or related alarm information when a predefined event occurs.

Also, the coverage can be divided into three areas: R1 area 301 refers to a first alarm area, wherein a beep sound may be operated; R2 area 302 refers to a second alarm area, wherein a vibration may be operated or a vibration & sound may be operated; R3 area refers to a third alarm area 303, wherein an electric shock may be operated.

FIG. 4 is a block diagram of one example of a handheld master terminal according to the present invention. The handheld master terminal 100 comprises a LCD GUI 101, an audio status LED 102, a CPU and memory 103, a GPS 104, a keypad and button 105, a RF transceiver 106, a PM (Power Manager) 107, a diagnosis and monitoring port 108 and a battery 109.

A RISC microprocessor can be used as a CPU, and NOR/SRAM or NAND or SDRAM can be used as a system memory for OS use and application use. As a LCD, a 2.4 inches or 2.8 inches of LCD (other size is available) and a graphic GUI can be used.

Also, the handheld master terminal includes a bidirectional RF modem module.

As a GPS module, a receiver module that can receive location information of a GPS satellite can be used. To ensure the resolution of the location information, an acceleration sensor and an electronic compass function may be added.

As a network, a star network configuring coordinator can be used, and a group management can be performed by assigning a group ID and an individual ID.

The CPU 103 can store and manage the location and the status LOG of the control unit 200, and an internal memory and an external (micro) SD-card interface can be used for storing/analyzing the LOG data.

As an audio unit, a buzzer or a speaker can be used.

As a visible alarm, a LCD or a LED blinking can be used or a vibration alarm or a horn can be used.

As electric power, a general AA battery ×2, a Li-ion battery or the like can be used.

The diagnosis and monitoring port can be used for upgrade and after-sales service.

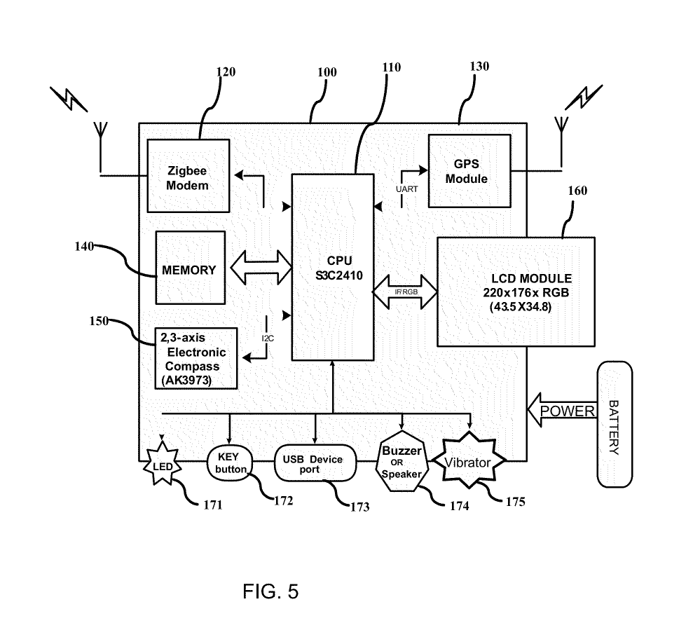

FIG. 5 is a block diagram of another example of a handheld master terminal according to the present invention.

In FIG. 5, a handheld master terminal 100 comprises a CPU 110, a bidirectional RF modem module 120, a GPS module 130, a memory 140, 2, 3-axis electronic compass 150, an LCD module 160, an LED 171, a key button 172, a USB port 173, a buzzer or a speaker 174 and a vibrator 175.

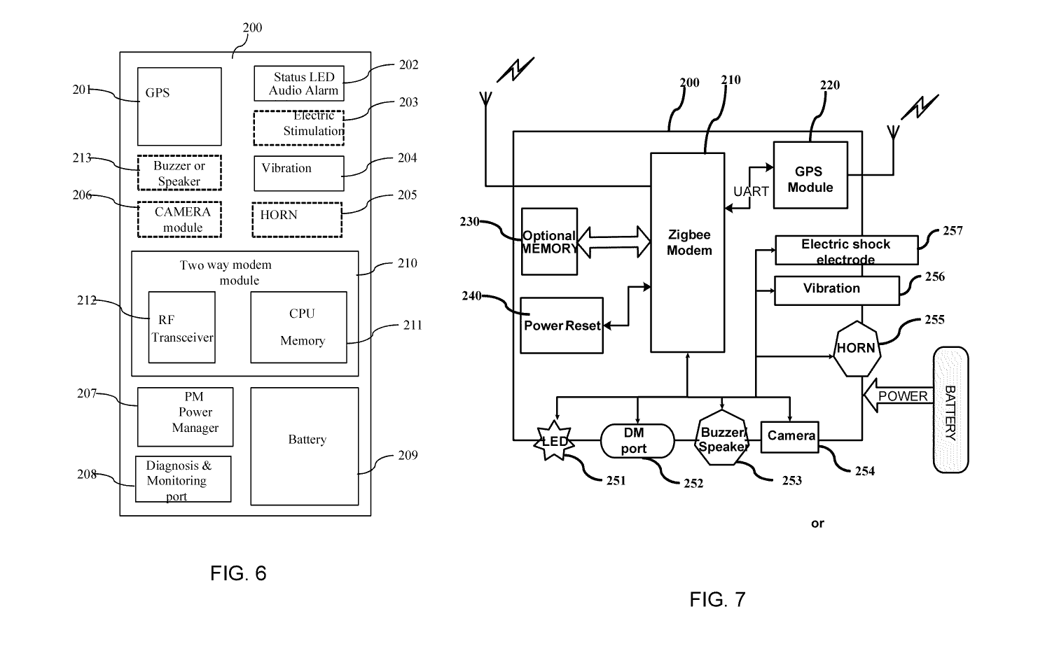

FIG. 6 is a block diagram of one example of an object control unit according to the present invention.

In FIG. 6, an object control unit 200 comprises a GPS 201, a status LED audio alarm 202, an electric stimulation 203, a vibration 204, a horn 205, a camera module 206, a PM (Power Manager) 207, a diagnosis & monitoring port 208, a battery 209, and a bidirectional RF modem module 210. Also, the bidirectional RF modem module 210 includes a CPU and memory 211 and a RF transceiver 212.

FIG. 7 is a block diagram of another example of an object control unit according to the present invention.

In FIG. 7, an object control unit 200 comprises a bidirectional RF modem module 210, a GPS module 220, an optional memory 230, an electric power and reset 240, an LED or an audio alarm 251, a DM (diagnosis and monitoring) port 252, a buzzer or a speaker 253, a camera module 254, a horn 255, a vibration 256 and an electric stimulus electrode 257.

As described above, the object control unit 200 employs a bidirectional RF modem module, and its basic function can be realized within a CPU of the bidirectional RF modem. Also, other CPUs can be added according to its function.

Also, an audio/visible alarm and an alarm/vibration may be available, and an electric stimulation electrode can be included.

Also, a GPS module can be employed for location information.

Also, a battery power can be included, and this can use a detachable AA battery or a rechargeable Li-ion battery. Also, a charging circuit can be embedded within the battery power.

Also, the diagnosis and monitoring port can be used for upgrade and after-sales service.

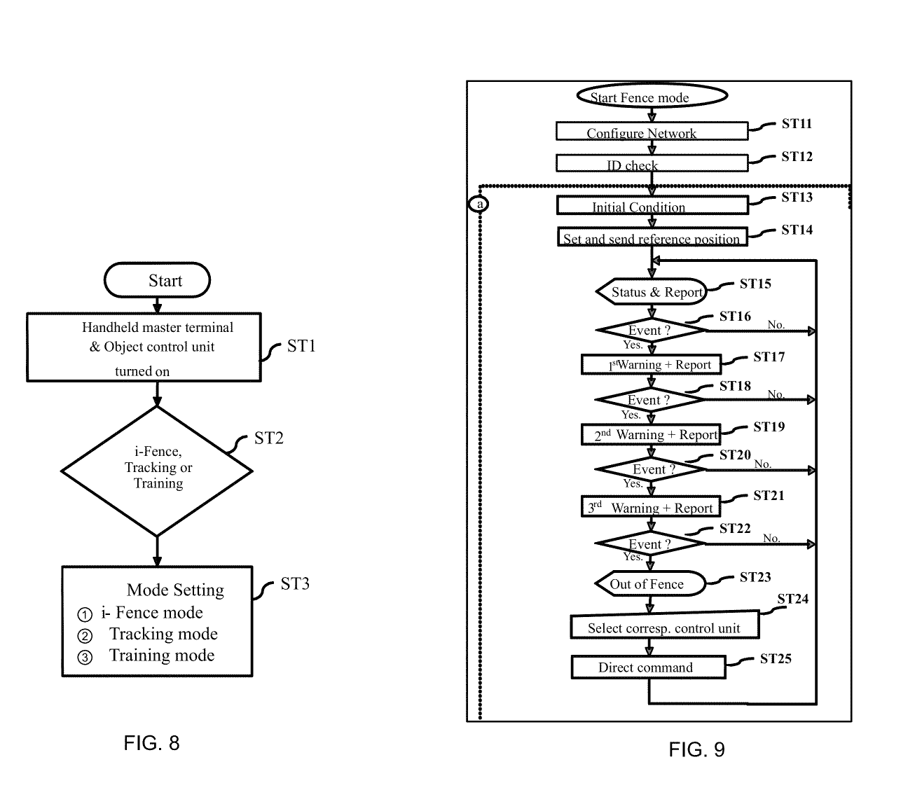

FIG. 8 is a flow chart showing a control method of an invisible electronic fence system according to an embodiment of the present invention.

Initially, when a system is started, the electric power of a handheld master terminal 100 and an object control unit 200 turns on (ST1).

Then, which mode is operated is determined (ST2).

Then, an invisible electronic fence system is operated according to a selected mode (ST3).

Here, an operation mode includes a fence mode, a tracking mode and a training mode.

FIG. 9 is a detailed flow chart showing an operation example of a fence mode in FIG. 8.

When a fence mode starts, a network between a handheld master terminal 100 and an object control unit 200 is constructed (ST11).

Then, the checking of a registered ID and the addition of an unregistered ID are performed. Here, the settings of a group ID and an object control unit ID are performed (ST12).

Then, an operation mode of each object control unit 200 is set. In this step, the set operation mode refers to an initial condition.

To do this, a reference position is initially stored. Then, the setting and store of an event occurring condition are performed. Here, an operation area and an action method of each area are determined (ST13˜ST14).

Also, GPS information and its report period are set and stored. In a fence mode, this is managed by a handheld master terminal 100, and it is set to be sent mainly when an event occurs. In a tracking mode, the report period is managed by a handheld master terminal 100, and herein, it is set to be a fast period.

Also, the kind of commands to be transmitted is set. Here, the kind of commands for each area is set. Each area includes a vibration, a recordable sound, a speaker or a beep sound, an electric stimulation, and the like (ST13).

Then, after identifying the location of the handheld master terminal through the transmission of a reference position, location information is provided to the object control unit 200 (ST14).

Then, through the sending of an event report, the object control unit 200 transmits its own information (location and status) to the handheld master terminal 100 (ST15).

Then, the handheld master terminal 100 determines if that information transmitted from the object control unit 200 satisfies a predefined condition (ST16).

If it is NO, a report is provided according to a set period and asks for departure again. If it is YES, a first command (a recordable sound or a beep sound with LED flash) set for the object control unit 200 is performed. Also, a status and warning message is provided to the handheld master terminal 100 (ST17).

Also, if the event is maintained or not is determined (ST18).

Then, if it is YES, a second warning command (a vibration) is transmitted. Here, a status and warning message is provided to the handheld master terminal 100 (ST19).

Again, if the event is maintained or not is determined (ST20).

Then, if it is YES, a third warning command (an electronic stimulation for dogs, and a voice and vibration for people) is transmitted. Here, as the object control unit 200 comes near to a limiting fence line, its intensity increases. At the same time, status information (location, state, departing route, time, etc.) is continuously provided to the handheld master terminal 100. Herein, a sound and stimulation (or a sound and vibration) can only be provided for 10 seconds. After 10 seconds, a sound, a LED, a vibration or an electric stimulation can be operated repeatedly at a certain interval. Also, a status and warning message is continuously provided to the handheld master terminal 100 (ST21).

Thereafter, it is determined if the event has occurred (e.g., a boundary has been crossed) (ST22).

In this step, if it is YES, it is conceived that an object crossed a final liming fence. Thus, a piece of information (location, distance, moving direction, time, etc.) of a corresponding object control unit 200 is shown on the screen of the terminal 100 and the corresponding object control unit 200 is directly selected (ST24), and a desired command is sent to the handheld master terminal 200 (ST25).

Herein, the event condition (or the event) indicates a case of satisfying a predefined condition, that is, a case of crossing an invisible fence (a set boundary parameter).

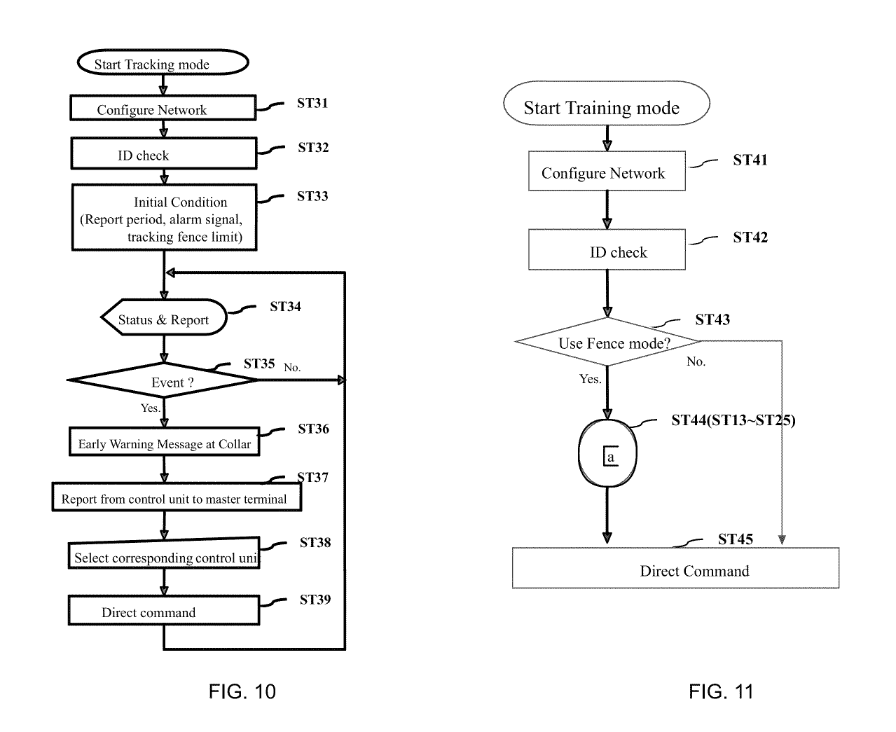

FIG. 10 is a detailed flow chart showing an operation example of a tracking mode in FIG. 8.

Initially, when a tracking mode starts, a network is configured using a WPAN modem (ST31).

Then, the checking of a registered ID and the addition of an unregistered ID are performed. Here, the settings of a group ID and an object control unit ID can be performed (ST32).

Then, an initial condition of each object control unit 200 is set, wherein a report period provided to a handheld master terminal 100, an alarm signal to be operated when an event occurs and a radius of a final limiting fence for defining the event can be set (ST33). Also, in this tracking mode, a reference position is moving and thus it is not set separately. Therefore, as the handheld master terminal 100 is moving, a visible area tracking an object control unit 200 is also moving (ST33).

Then, it is determined if the collar has departed from the limiting fence (ST35).

If it departed from the limiting fence, a corresponding object control unit 200 may operate an early warning message (a beep sound, a vibration, an electric stimulation or a recorded voice) in itself (ST36). At the same time, a piece of information (the current location, state, the departing time, the departing route, etc.) by tracking the corresponding object control unit 200 may be sent to the handheld master terminal 100, and the handheld master terminal 100 then shows the contents (ST37).

Then, the corresponding object control unit 200 may select an ID (ST38), and send a direct command (ST39). Herein, the direct command includes a recordable voice, a voice sending using a speaker, a vibration sending, a nick or continuous stimulation, a moving image or still image photographing command sending (ST39).

FIG. 11 is a detailed flow chart showing an operation example of a training mode in FIG. 8.

Initially, when a training mode starts, a network is configured by a WPAN modem (ST41).

Then, the checking of a registered ID and the addition of an unregistered ID are performed. Here, the settings of a group ID and an object control unit ID are included (ST42).

In the next step, it is determined if a fence mode is to be used or not (ST43). The fence mode includes from the step ST13 to the step ST25 (ST44), and can send a direct command to a corresponding object control unit 200. Also, the direct command can be sent to the corresponding object control unit 200 without using the fence mode (ST45).

All direct commands of the training mode are performed using “training mode control zone” of control keys of the handheld master terminal.

When the fence mode is used in the training mode, a corresponding object control unit 200 is tracked and the handheld master terminal 100 can identify and manage in real-time a piece of information (the current location, state, the departing time, the departing route, etc.) of all object control units 200 which exist within a fence or depart from the fence.

By checking status and location information of all object control units within a controlled area and selecting an ID of a specific object control unit 200 by the handheld master unit 100, a user of the handheld master terminal 100 can send a direct control command to the corresponding object control unit 200 (ST45).

Herein, the direct command includes a recordable voice, a voice sending using a speaker, a vibration sending, a nick electric stimulation sending, a continuous electric stimulation sending, etc. (ST45).

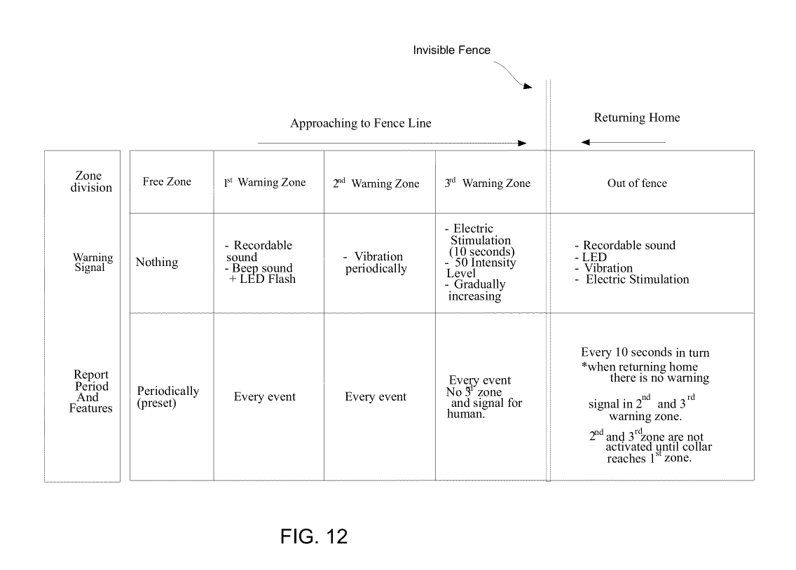

FIG. 12 is a conception view showing an example applied in each managing area of the present invention.

In the following, the main functions of an object control unit and a handheld master terminal 100 will be described:
a beep sound sending function.
a vibration sending function.
an electric stimulation sending function.
a horn sound sending function.
a recorded voice sending function.
a direct voice sending function.
a still image and moving image sending function.
a function that reports status information (the residual amount of a battery, the communication sensitivity, the location and state of an object control unit, etc.) of an object control unit 200 to the handheld master terminal 100 periodically or when an event occurs.
a function that indicates the status such as the residual amount of a battery and the communication sensitivity reported from the object control unit 200 on the handheld master terminal 100.
a function that indicates location information, moving velocity, moving direction, etc. of each object control unit 200 reported from the object control unit 200 on the handheld master terminal 100.
a function that indicates the current location and the operating status (run, scoring, sleep, stop, struggle) of an object control unit 200 on the handheld master terminal 100.
a run & point function wherein a horn is not blowing when an object control unit 200 is moving, but the horn is blowing when the object control unit is not moving but stops.
a function that indicates a warning message and the current location (the orientation, the departing distance and state) on the handheld master terminal 100 when an animal departs from an invisible fence.
a function of, when a handheld master terminal 100 calls the name of an object control unit, recognizing its own name in itself and performing the sent command by the called object control unit.

Also, an operation procedure divided into three cases will be described below:

1) When Entering from a Free Zone to an Invisible Fence,
a first warning: a recordable sound or a beep sound with LED flash.
a second warning: a periodic vibration sending.

Herein, the order of the first and second menu can be changed by a user's selection.

Ex) a first—a sound and a second—a vibration, or a setting by only a sound or a setting by only a vibration.
a third warning: an electric shock occurs (the shock level increases as nearer to a fence).

2) When Departing from the Invisible Fence,

The corresponding object control unit has departed out of the invisible fence. From here, considering an animal departed from the fence, a continuous electric stimulation is not sent but a sound, a vibration or an electric stimulation with a certain period is operated in turn. At the same time, a piece of information (a distance from a handheld master terminal, the travelling route, direction, time, etc.) of an object control unit is provided periodically to the handheld master terminal 100.

When a computer is connected or a warning board is installed, a warning message can be provided.

2) When Returning,

When passing an invisible fence and entering the third warning zone, an electric stimulation, that is a third warning message, turns ‘off’, and the moment entering the first warning zone, the third warning zone turns ‘on’. Also, the second warning zone turns ‘on’.

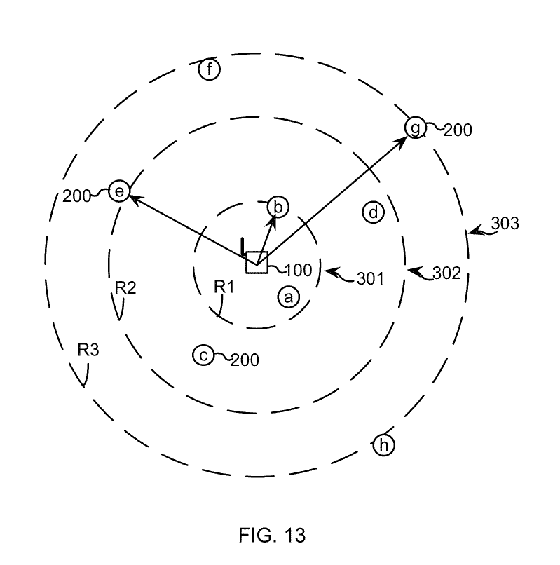

FIG. 13 is a conception view showing one operation example when FIG. 3 is applied to a fence mode.

At first, the setting of FIG. 13 will be described. A fence is installed (in a master terminal), wherein a fence area is divided into R1, R2 and R3 with respect to a handheld master terminal.

In the following, four functions within the set area will be described:

1) R1: Free Zone 1^{st} Warning Zone

Object control unit (a, b) transmit location information to a handheld master terminal intermittently. If an object departs from the free zone (R1), the control unit sends a message that it is out of the free zone to the handheld master terminal and sends the message to object control units (c, d, e) to operate a beep sound and a LED flash simultaneously.

2) R2: 2^{nd} Warning Message

In this region, ‘2nd warning zone departure’ information is transmitted on the display of a handheld master terminal. Also, the location of the departed object control units (f, g) may be sent.

Meanwhile, the departed object control units (f, g) periodically send a vibration using a predefined warning message when they depart from the free zone.

3) R3: Invisible Fence Limit Line Area

An electric stimulation can be sent to an object control unit (f, g) nearly approaching a limit line and the intensity becomes more increasing as it comes near to the limit line. Here, the electric stimulation may be provided for not more than 10 seconds. Thereafter, when it is considered that the object control unit 200 passes the fence, a sound, a vibration, an electronic stimulation, etc. with a certain period can be sent repeatedly.

Meanwhile, location information of the departed object control unit 200 and a message saying that it departed from ‘limit line’ are transmitted to the handheld master terminal 100.

Also, the corresponding object control unit 200 will be selected and then direct signal information (an electric stimulation or a vibration) can be sent. This should be used as needed.

Also, when the object departs from the corresponding area, a control command is cut off.

4) A Signal when the Departed Object Control Unit Returns

An object control unit (h) completely departs from a limit line, and a handheld master terminal can track the corresponding object control unit.

When an object control unit (h) returns, warning messages of R2 and R3 areas are released, and when it enters into R1 area, R2 and R3 areas return to an active mode.

In the following, the construction procedure of I-Fence system using a bidirectional RF modem capable of configuring a network will be described:

Basically, a star network is configured from one handheld master terminal to manage an object control unit.

One handheld master terminal acts as a coordinator in the configured network.

Also, a group management is possible by assigning network ID/group ID/device ID.

Also, a bidirectional communication is possible around the handheld master terminal Therefore, if an object control unit is located within a LOS (Line of Sight) range, location information periodically received from each object control unit and GPS location information of the present handheld master terminal are compared. As a comparison result, the distance and the orientation angle are calculated and thus the location and status of each object control unit can be monitored.

Also, if an event that GPS location/orientation information identified in an object control unit is out of a predefined condition occurs, the object control unit generates and transmits an alarm to the handheld master terminal according to a predefined scenario, and location information/status of each object control unit is transmitted to the handheld master terminal and then the handheld master terminal determines the transmitted data to cope with the response.

Also, the handheld master terminal periodically receives location information and status from each object control unit in a predefined specific period and generates an alarm according to the previously defined condition, and thus a user can cope with the corresponding response.

Also, several handheld master terminals are realized, and network construction architectures such as tree/mesh network are employed/configured. By operating the network and using a routing function, the coverage and the number of object control units to be monitored can be enlarged.

That is, when a coordinator function and a relay function are set in each handheld master terminal and communication between handheld master terminals or a bidirectional communication between each handheld master terminal and a headquarter is used, a headquarter terminal or a computer can manage the status and condition of terminals entirely.

Also, managing data of each handheld master terminal are transmitted to a headquarter master terminal, and then the headquarter master terminal can collect and manage them.

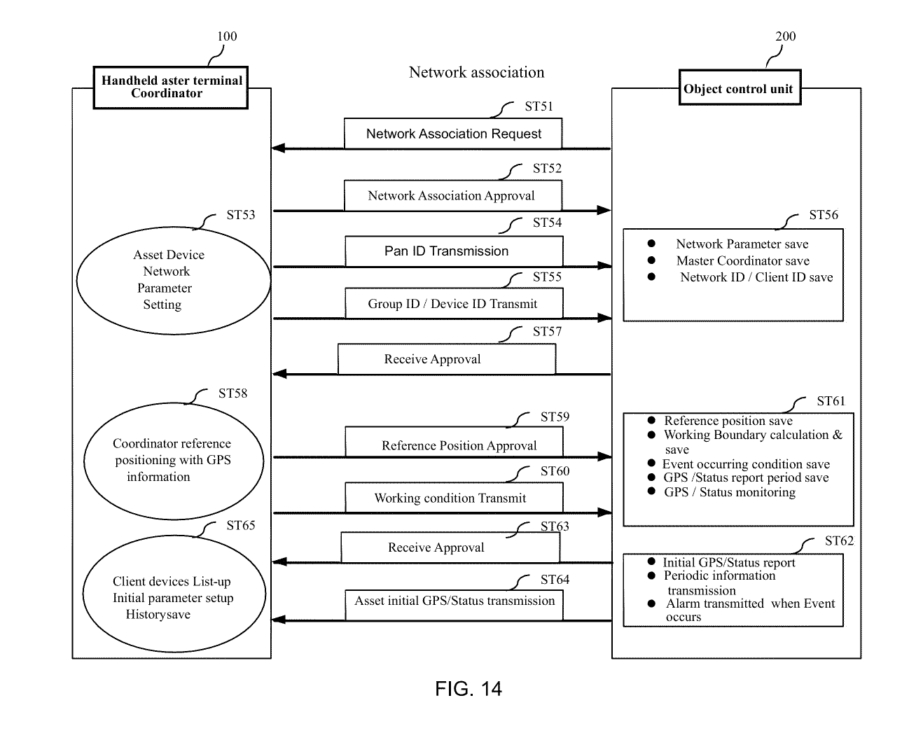

FIG. 14 is a flow chart showing an operation of the fence mode in FIG. 13.

A network between a handheld master terminal and an object control unit is configured consistent with a network construction protocol of the employed bidirectional RF communication method, and one bidirectional communication enabled group is constructed by forming a group through the construction of a network and assigning an device ID between the handheld master terminal and the object control unit.

Then, the handheld master terminal 100 performs the coordinator reference position assignment using its GPS information (ST58).

Then, the handheld master terminal 100 sends the reference position to the object control unit 200 (ST59), and it sends a working condition (ST60).

Also, the object control terminal 200 stores the reference position, and calculates and stores a working boundary, and stores an event occurring condition, and stores a GPS/status report period, and performs the GPS/status monitoring (ST61).

Also, the object control terminal 200 performs the initial GPS/status report, sends a piece of information periodically, and performs an alarm sending when an event occurs (ST62).

Then, the handheld master terminal 100 approves the reception from the object control unit 200 (ST63), and when it receives the initial GPS/status sending of the object control unit 200 (ST54), it performs a client devices list-up, performs an initial parameter setup and performs a history store (ST64).

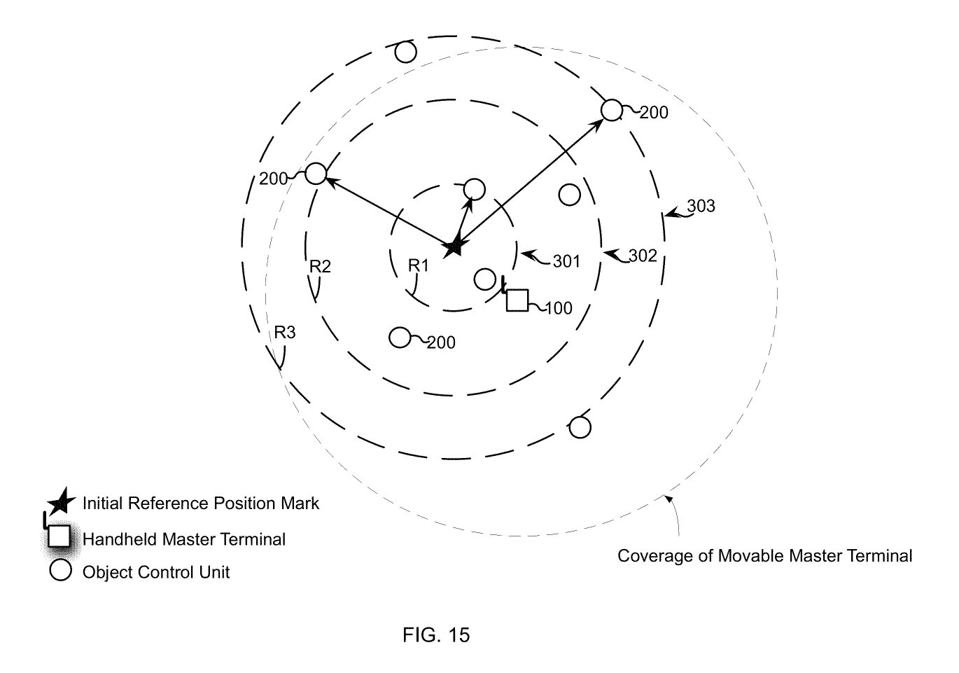

FIG. 15 is a conception view showing another operation example when FIG. 3 is applied to a fence mode.

At first, an initial reference position setting is performed.

Then, the initial reference position of the handheld master terminal is decided, and set values are transmitted to each object control unit. The transmission of set values will be described below:
An initial reference position
Setting of boundary limit rule value 1/2/3
Transmission of an event occurring condition [a boundary departing condition]
Setting of a location information report period of each object control unit

Also, the handheld master terminal sets an initial set position as a reference position, and it is arbitrarily movable within a communication enabled coverage. Herein, when object control units are out of a LOS communication enabled area, it is impossible to receive a piece of information regarding an object control unit external to the communication enabled region.

When each object control unit exists within a conditioned radius from the initial reference position independent of the location of the handheld master terminal, then the location/status is transmitted periodically.

Also, when an event according to a set condition occurs, an alarm signal is transmitted to the handheld master terminal independent of a period.

Also, the handheld master terminal can identify and monitor an object control unit which has generated an event in its current location.

Also, it is an event-based operation, and thus it can help an efficient electric power dissipation.

Also, the Handheld master terminal is movable everywhere, but when it departs from an area where a LOS communication with the object control unit is possible, it is impossible to collect information.

A scenario of the detail operation of such fence mode will be described below:

At first, a fence mode is proper for managing an object control unit in a place where the object control unit cannot move further over time, for example, a sheep pasture and a bull pasture.

The reference position of the handheld master terminal may be transmitted to each object control unit, and the object control unit may set an event condition of a possible moving boundary radius from the reference position of the handheld master terminal.

Also, each object control unit may check its GPS information periodically, and calculate a distance from the reference position, and only if an event regarding a set condition of the reference position occurs, it may transmit its location information and status.

Because each object control unit operates conditionally in a certain boundary condition with respect to an initial reference position independent of the current position of the handheld master terminal, it is unrelated to the position of the handheld master terminal when an event occurs.

Even if the handheld master terminal departs from its initial reference position for monitoring but it is located within a communication enabled range, it can compare location information received from each object control unit in which an event occurs and the current GPS location information of the terminal to calculate the distance and the orientation angel for location tracking.

When an object control unit does not depart from a boundary set regarding the initial reference, an event does not occur and thus any event may not be transmitted. Therefore, it can help an efficient electric power dissipation.

However, its location information may be sent periodically to the handheld master terminal for the general management. A user of the handheld master terminal can set a report period of location information and status information of each object control unit in consideration of behavior pattern of the object control unit. Therefore, the efficiency of electric power dissipation can be expected by setting to 30 seconds/1 minute/3 minutes/5 minutes and the like.

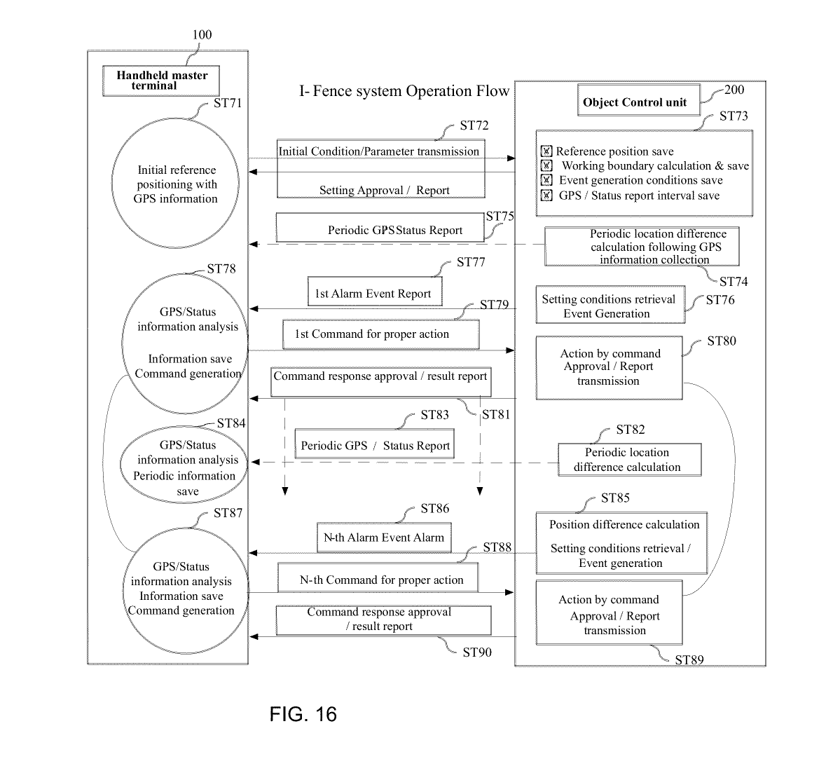

FIG. 16 is a flow chart showing an operation of the fence mode in FIG. 15.

Initially, a handheld master terminal 100 performs initial reference position assignment using GPS information (ST71). Then, the handheld master terminal 100 transmits an initial condition and a parameter to an object control unit 200 and receives a setting approval and report (ST72).

Also, the object control unit 200 stores a reference position, calculates and stores a working boundary, stores an event occurring condition, and stores a GPS and status report period (ST73).

Thus, the object control unit 200 collects GPS information and calculates a location difference periodically (ST74), and it transmits a periodic GPS and status report to the handheld master terminal 100.

Also, the object control unit 200 performs an event generation by retrieving a set condition (ST76), and it transmits 1^{st} alarm event report to the handheld master terminal 100.

Then, the handheld master terminal 100 analyzes GPS and status information, stores the information, and performs a command generation.

Then, the handheld master terminal 100 transmits 1^{st} command for proper action to the object control unit 200. Then, the object control unit 200 performs action by command, and transmits an approval and report (ST80). Therefore, the object control unit 200 transmits a command response approval and result report to the handheld master terminal 100 (ST81).

Then, the object control unit 200 calculates a location difference periodically (ST82), and transmits a periodic GPS and status report to the handheld master terminal 100 (ST83).

Then, the handheld master terminal 100 analyzes the GPS and status information, and stores periodic information (ST84).

Also, the object control unit 200 calculates a position difference, retrieves a set condition and performs an event generation (ST85).

Then, the object control unit 200 transmits N-th alarm event alarm to the handheld master terminal 100 (ST86).

Then, the handheld master terminal 100 analyzes GPS and status information, stores the information and performs a command generation (ST87).

Then, the handheld master terminal 100 transmits N-th command for proper action to the object control unit 200 (ST88), and the object control unit 200 performs action by command and transmits an approval and report information (ST89).

Also, the command response approval and result report of the object control unit 200 is transmitted to the handheld master terminal 100 (ST90).

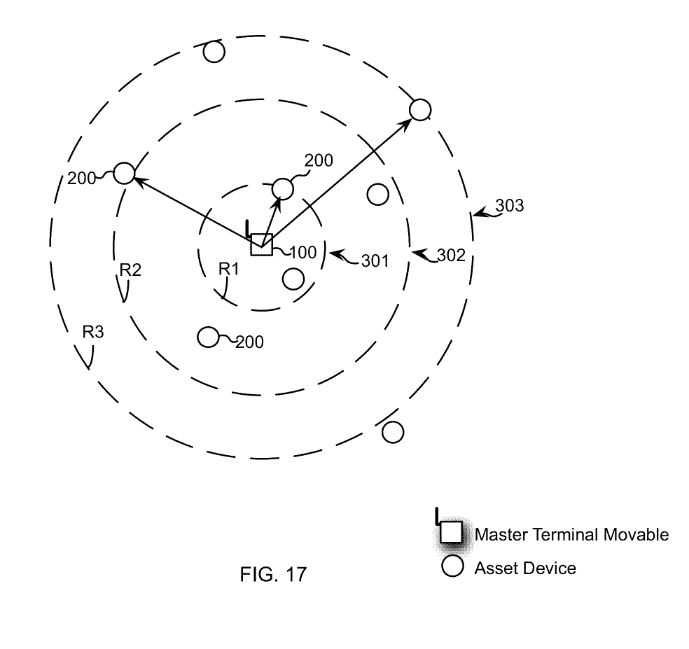

FIG. 17 is a conception view showing one operation example when FIG. 3 is applied to a tracking mode.

Initially, each object control unit transmits only location/status periodically.

Also, handheld master terminal analyzes the periodic location information and status information transmitted by each object control unit and determines if it corresponds to a set condition or not according to a scenario inside the handheld master terminal.

The handheld master terminal monitors and manages location and status of all the object control units, and informs a user of an event according a set condition as an alarm.

A user confirms the alarm and transmits the corresponding command to an object control unit, and when the object control unit receives the command from the handheld master terminal, it performs the corresponding action (a sound, a vibration, an electric stimulation, recording, etc.).

The object control unit transmits its location and status in a set period, and thus it can maintain a Modem and GPS ON state all the time. However, because a data transmission period is short, it causes much electric power dissipation.

The handheld master terminal determines whether to perform monitoring/managing and event generation for all the object control units, so it can increase the operation efficiency in terms of system management.

A communication enabled distance between a handheld master terminal and an object master unit equals a maximum boundary. This is because a motion radius of the handheld master terminal is a boundary.

It is possible to manage the movement of an object control unit when the handheld master terminal is moving.

A scenario of the detail operation of such tracking mode will be described below:

At first, this tracking mode is used for the management of an object control unit when the moving object control unit, such as a hunting dog, moves fast.

Initially, a handheld master terminal sets location information and a status report period of an object control unit.

Each object control unit checks its GPS information and transmits its location information and status periodically to the handheld master terminal.

The handheld master terminal receives a piece of information periodically from the object control unit and compares it with its own location information to confirm its location. Here, when a piece of information is not received for a period of time or when the same information is received, the handheld master terminal generates an alarm.

Also, the handheld master terminal sets any object control unit and requests it of information.

Periodically received location information of each object control unit is generally managed in the handheld master terminal.

When an object control unit departs from a boundary, the handheld master terminal calculates it and generates an alarm.

According to the state of a corresponding alarm, a user transmits various commands (a stimulation, a vibration and a sound) to a corresponding object control unit.

The object control unit makes a response to a command transmitted by the handheld master terminal.

A user of the handheld master terminal can set a report period for location information and status information of an object control unit considering an action pattern of each object control unit.

The handheld master terminal compares location information received from an object control unit with its own GPS location information reference and calculates the distance and the orientation angle for position tracking. Therefore, it can monitor or control the object control unit.

The entire monitoring coverage of the handheld master terminal equals a bidirectional RF communication enabled radius.

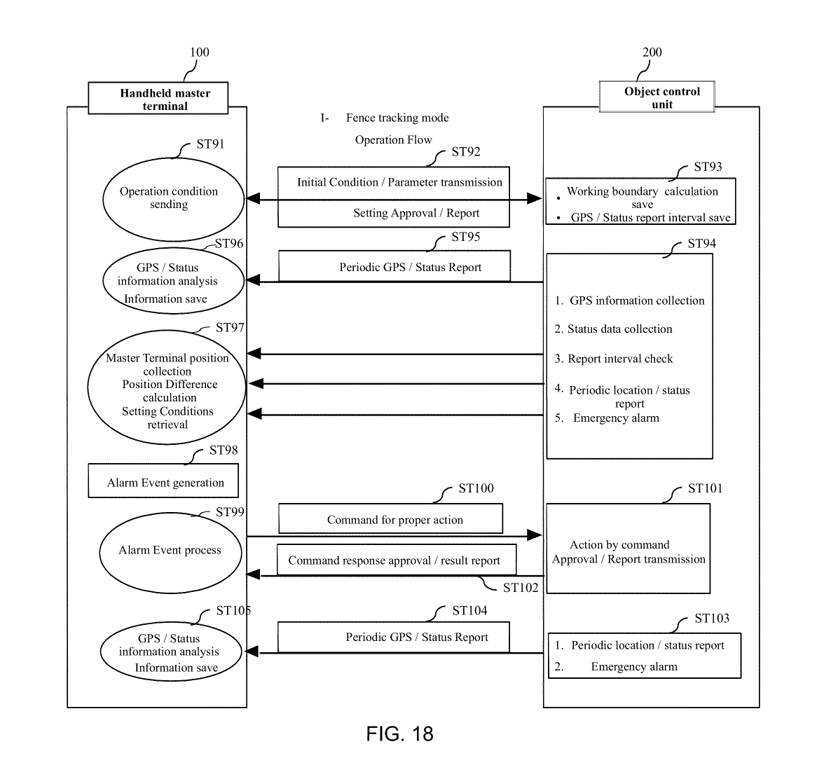

FIG. 18 is a flow chart showing an operation of the tracking mode in FIG. 17.

Initially, a handheld master terminal 100 performs an operation condition sending (ST91), and transmits an initial condition and a parameter to an object control unit 200 (ST92).

Then, the object control unit 200 calculates and stores a working boundary, stores a GPS and status report period (ST93), and transmits a setting approval and report to the handheld master terminal 100.

Also, the object control unit 200 collects GPS information, collects status data, checks a report period, draws a periodic location and status report and draws an emergency alarm (ST94).

Then, the object control unit 200 transmits a periodic GPS and status report to the handheld master terminal 100 (ST95).

The handheld master terminal 100 analyzes GPS and status information and performs an information store (ST96).

Also, the handheld master terminal 100 collects the location of the handheld master terminal, calculates a position difference, and retrieves a setting condition (ST97).

Then, when an alarm event occurs in the handheld master terminal 100 (ST98), the handheld master terminal 100 processes the alarm event (ST99).

Also, the handheld master terminal 100 transmits command for proper action to the object control unit 200, and the object control unit 200 performs action by command and transmits an approval and report (ST101). Then, a command response approval and result report is transmitted from the object control unit 200 to the handheld master terminal 100 (ST102).

Also, the object control unit 200 draws a periodic location and status report, and generates an emergency alarm (ST103).

Then, from the object control unit 200 to the handheld master terminal 100, a periodic GPS and status report is transmitted (ST104), and the handheld master terminal 100 analyzes the GPS and status information and performs an information store (ST105).

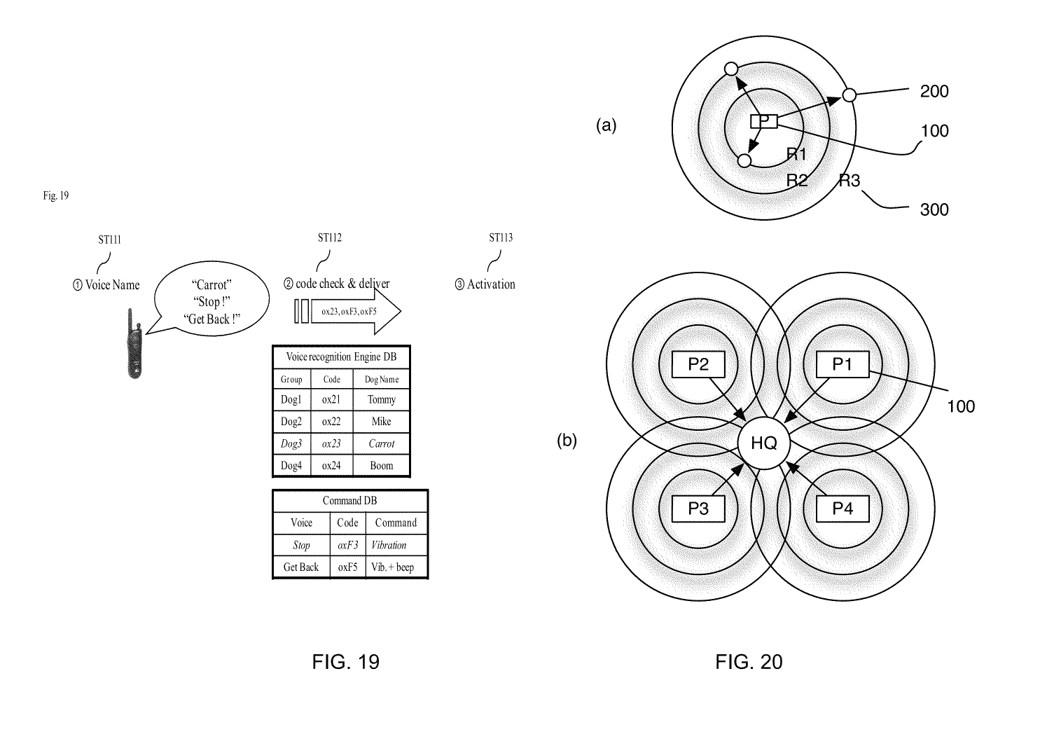

FIG. 19 is a conception view showing an example of performing a voice processing according to the present invention.

A person issues a voice command. The handheld master terminal converts a voice command, which is transmitted from a handheld master terminal to an object control unit and operates as a voice name command, into a physical command for a corresponding activation.

An object control unit exists within a communication radius. When the name and command of the object control unit, which are stored in a voice, are called (ST111), the corresponding code is transmitted (ST112). Then, a voice command (stop, come back, etc.) that is already stored in a corresponding object control unit as a code is transmitted to the corresponding object control unit to perform a corresponding command (ST113).

Also, the present invention can further mount a camera module.

That is, when an emergency situation occurs to an object (a hunting dog, a person, or other object) in a tracking mode which moves carrying an object control unit, the spot situation can be photographed by a camera installed in the object control unit as a moving image or a still image, transmitted to a handheld master terminal and displayed.

The installing method includes installation as an integrated type with the object control unit and installation as a separated type by a wired/a wireless.

As a basic function, the camera module can photograph a moving image and a still image and perform a voice recording.

Also, the handheld master terminal can include a memory that photographs a moving image or a still image in a predefined condition (the number of photographing and a period of photographing time) and stores it momentarily.

Here, the memory can be installed inside of the camera module or it is installed in the main body of the object control unit when installed as a separate type.

In the following, a processing by each device will be described:
Object control unit: when there is a request from a handheld master terminal, it photographs a moving image or a still image in a predefined condition (the number of photographing and a period of photographing time) and transmits the image to the handheld master terminal using a RF signal.
Handheld master terminal: it requests an object control unit of photographing and transmitting when a user considers it needs, displays the replied moving image or still image on a LCD, and it can also store it.

Also, an electronic compass and an acceleration sensor can be further mounted to enhance the reliability of location information and moving information of each handheld master terminal and control unit.

The acceleration sensor can obtain more precise location information by measuring moving acceleration of an object control unit and adding it to information received from GPS, and the electronic compass can obtain precise orientation information by using a compass sensor and using location information of a handheld master terminal and the received location information of an object control unit.

FIG. 20 is a conception view showing an example of expanding a fence range according to the present invention. FIG. 20 (a) shows an example applied to a small area where one handheld master terminal is used, and FIG. 20 (b) shows an example applied to a wide area whereby a fence range is expanded using a bidirectional RF modem solution.

Thus, a RF communication operation range can be expanded by using several handheld master terminals for ensuring a communication distance and adding a router function to each handheld master terminal.

To do this, an ID is assigned to each handheld master terminal and a managing group is set in each handheld master terminal.

By configuring a star network basically in a handheld master terminal, realizing a relay function and realizing a tree/mesh network, a monitoring enabled structure is implemented. In this structure, one HQ (headquarter) master terminal can collect information of several handheld master terminal for monitoring.

The handheld master terminal can be realized to have a function of control/monitoring a terminal within its coverage and a function of transmitting managing information and status to one HQ (headquarter) master terminal.

The HQ (headquarter) master terminal manages status of terminals within the entire coverage.

A monitoring program of HQ (headquarter) can be programmed according to an operation scenario.

The operation in the realization/operation structure of one master post as shown in FIG. 20 (a) will be described below:

As shown in FIG. 20 (a), when a star network is basically configured around one handheld master terminal and object control units are located, location information received from each object control unit and its GPS position information reference are compared to calculate the distance and the orientation angle.

When location/orientation information sent from an object control unit is out of a predefined boundary, the handheld master terminal performs a remote control (action by a separately defined function) to operate an audio alarm or a stimulus electrode in the object control unit according to a preset scenario in the handheld master terminal.

The control coverage of the handheld master terminal is determined according to the output power of a modem and LOS, and it includes a circular coverage or a coverage of any shape.

The operation in the realization/operation structure of several master posts as shown in FIG. 20 (b) will be described below:

First, when several handheld master terminals employing a RF modem and a GPS module are set as shown FIG. 20 (b) and a Tree/Mesh network is configured, the coverage can increase numerically and the overlap part is processed by an algorithm according to an operation scenario.

Also, the control boundary of each handheld master terminal is the same as action of one handheld master terminal as shown in FIG. 20 (a), and this structure is managed by each handheld master terminal according to location information, such as the orientation angle, the distance, etc., from each object control unit.

When management data of each handheld master terminal is transmitted to a headquarter (HQ) master terminal, the master terminal can collect and manage them.

If a relay function is set in each handheld master terminal, the entire state and condition of terminals can be managed using communication between handheld master terminals and communication between a handheld master terminal and a headquarter.

When a handheld master terminal is realized to have directivity, a coverage/range of any shape can be obtained.

If 4 through 6 handheld master terminals are operated to ensure a coverage, a control/monitoring for each boundary is possible, and if a relay function is also realized in each handheld master terminal and a Tree/Mesh network is configured, management by one head quarter terminal is possible.

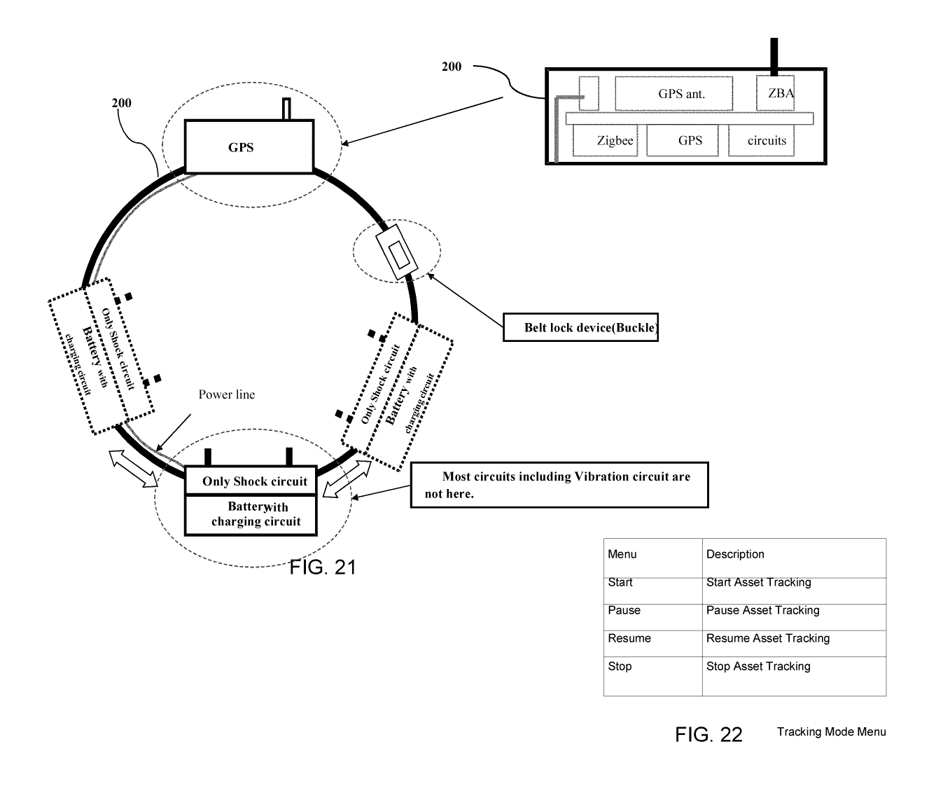

FIG. 21 is a conception view showing a construction example of an object control unit according to the present invention.

The basic concept of an object control unit will be described below:

That is, an object control unit of I-Fence includes a bidirectional RF modem module and a GPS module, and also includes a circuit for driving these and a battery used for a main battery.

Also, in the case of GPS, the direction of an antenna should indicate a satellite to facilitate transmission/reception, and thus when it indicates a sky direction, the reception sensitivity greatly increases.

An object control unit is light when it is installed in the neck of a dog in its characteristic, and because it must not turn around for a smooth satellite communication, its center of gravity needs to be properly maintained.

To realize a smooth communication environment, a battery with a charging circuit is mounted in the lower part as counter weight, and all circuits including the antenna are arranged separately in the upper part.

The construction of the upper part and the lower part in FIG. 21 will be described below:
Upper part: a GPS modem module, a RF modem, a GPS patch antenna, a RF antenna, the whole circuits
Lower part: a rechargeable battery, a battery charging circuit, an electrode & electric shock circuit

The GUI mode and the key assignment of a handheld master terminal 100 are performed.

First, a fence mode, a tracking mode and a training mode are provided for user's convenience.

After it is set as a basic mode, it always acts as the set mode when a power-on, and the mode can be changed through a menu or a key.

In the following, the construction of the menu will be described:
mode menu: it provides a menu corresponding to each mode.
asset: it provides a menu for managing an asset, which is an object control unit.
setup: it provides a menu for setting a system.
group: it provides a menu for managing a group.
mark: it provides a menu for marking and managing GPS position.

Also, the assignment of the key will be described below:
mode: it can select a fence mode, a tracking mode and a training mode.
arrow key (Left, Right, Up and Down): it is used at a menu operation and at a keypad as a direction key.
menu: it indicates a menu for a corresponding mode.
enter (select) key: it inputs a selected Mode, a selected Menu and a selected Key.
stimulation key: it performs a stimulation.
vibration key: it performs a vibration.
sound key: it performs a sound.
compass key: it turns into a compass mode.
make key: it stores the present GPS information, and manages the stored information.

The training mode is used for restraining a specific object control unit in no time. An object control unit is used within a visible distance in principle, and the only selected object control unit can be managed.

If an object control unit is assigned, the assigned object control unit can be automatically selected when Power On/Off.

The assigned object control unit is easily designated a stimulation, a vibration and a sound by a menu or a key.

A tracking mode (this means a hunting mode) can manage a swiftly moving object control unit.

This can manage a number of selected object control units. That is, a Master requests information one after the other.

If an object control unit stays at one place for a certain time or there is no anticipated report for a while, it transmits an alarm to a handheld master terminal.

If an object control unit is assigned, the assigned object control unit can be automatically selected when Power On/Off.

The assigned object control unit is designated a stimulation, a vibration and a sound by a menu or a key with ease.

Also, a bird position can be marked and managed using GPS information.

FIG. 22 is a table showing a menu example of a tracking mode of a handheld master terminal.

This can be constructed as Start, Pause, Resume and Stop.

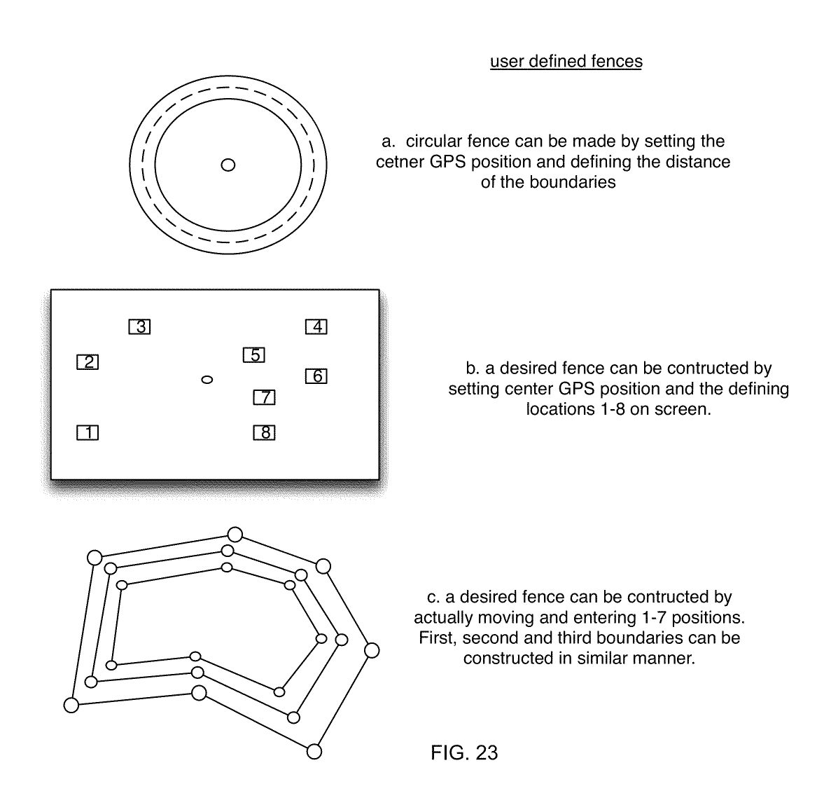

FIG. 23 is a conception view showing a method of setting a fence area in a fence mode of a handheld master terminal.

A fence mode manages a number of slowly moving object control units as a group.

Also, an object control unit is assigned to restrain a stimulation, a vibration and a sound.

Also, there are three kinds of a fence: a circle fence, a user drawn fence and a GPS input fence. Both of the user drawn fence and the GPS based fence may be determined through use of a touchscreen display of a smart phone in one embodiment of the invention.

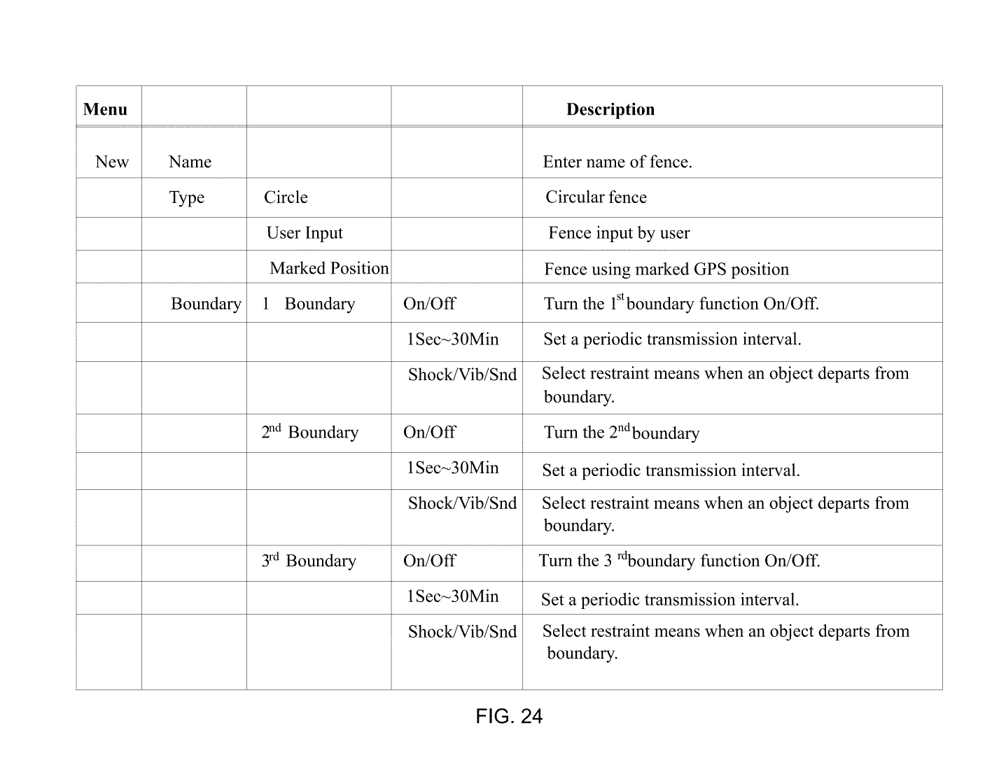

FIG. 24 is a table showing one menu example of a fence mode of a handheld master terminal.

First, a menu is composed of Name, Type and Boundary when newly selected. Also,

Type is comprised of Circle, User Input, and Marked Position. Also, Boundary is composed of 1^{st} Boundary, 2^{nd} Boundary and 3^{th} Boundary, and each boundary is comprised of On/Odd, 1 Sec˜30 Min, and Shock/Vib/Snd.

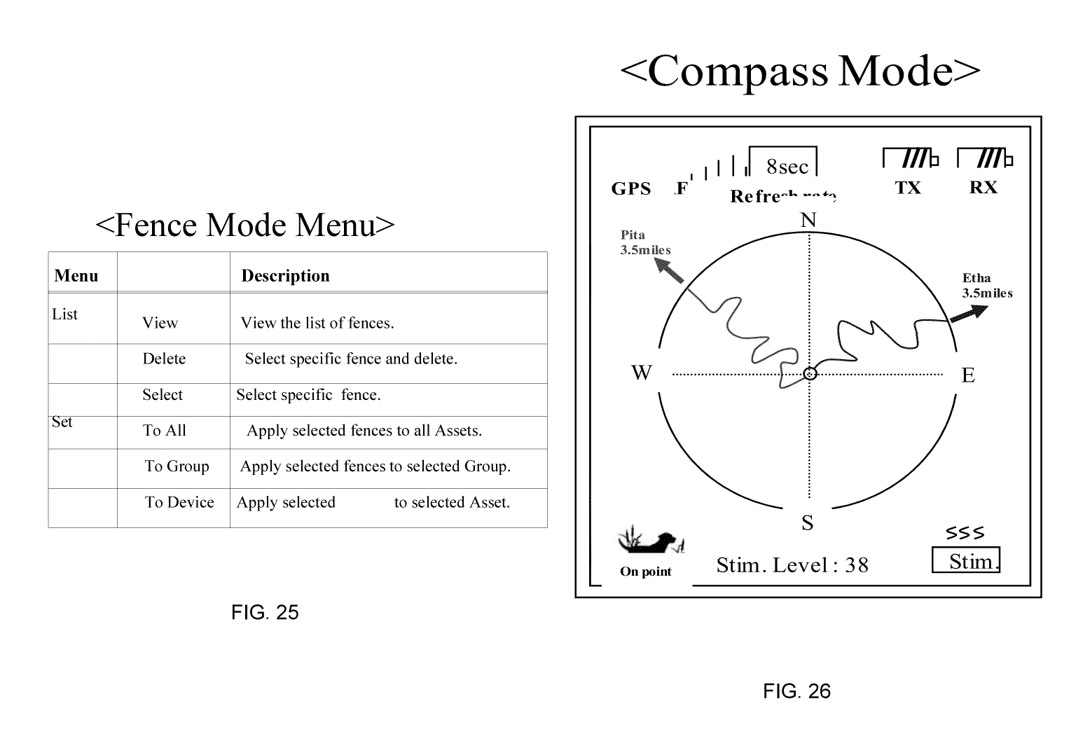

FIG. 25 is a table showing another menu example of a fence mode of a handheld master terminal.

Here, a menu is comprised of List and Set, List is comprised of submenus such as View, Delete and Select, and Set is comprised of submenus such as To All, To Group and To Device.

FIG. 26 is a conception view showing a construction example of a basic screen in a compass mode of a handheld master terminal.

The coverage of a fence is indicated on one screen, the distribution state and situation of an object control unit 200 can be monitored within the coverage, and the absolute coordinates and the relative distance can be displayed with respect to a basic compass function.

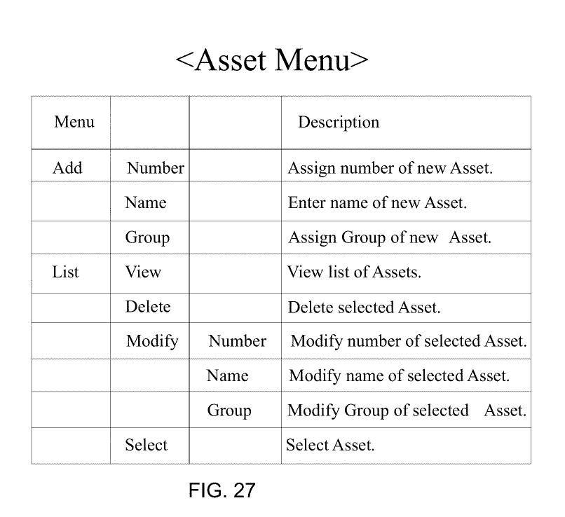

FIG. 27 is a table showing an example of an object control unit menu for managing an object control unit of a handheld master terminal.

This is a menu for managing an object control unit.

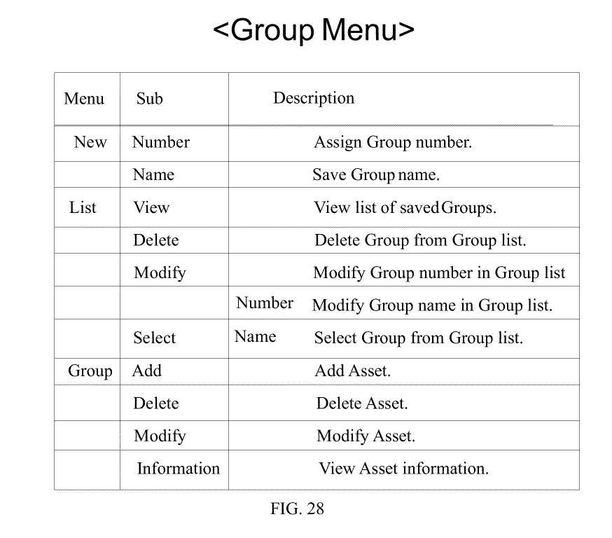

FIG. 28 is a table showing an example of a group menu for managing a group of a handheld master terminal.

This is a menu for managing a group.

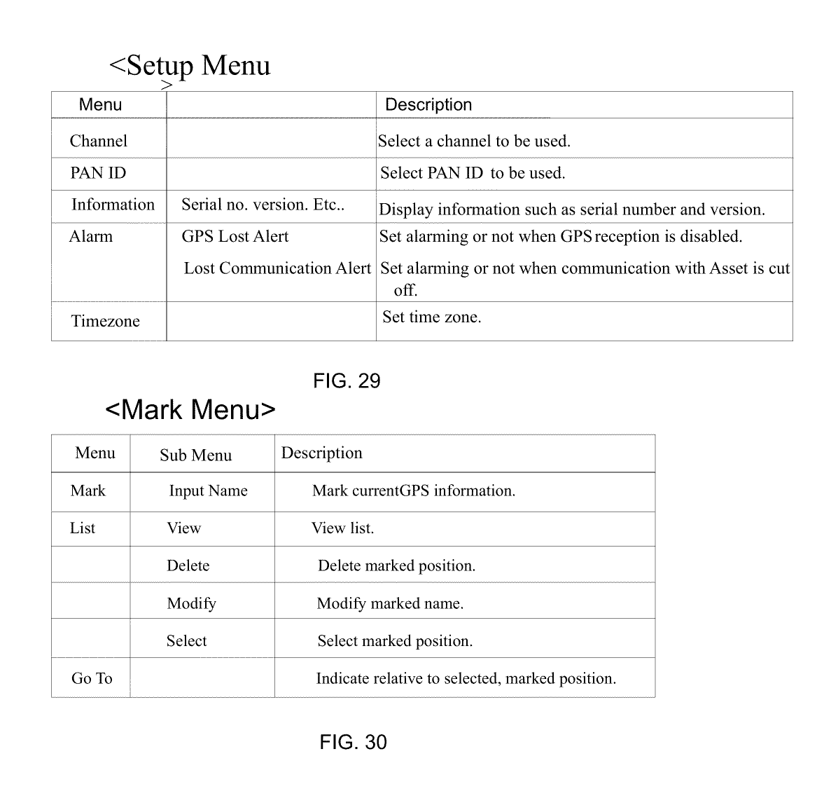

FIG. 29 is a table showing an example of a setup menu for managing a system of a handheld master terminal.

This is a menu for managing a system.

FIG. 30 is a table showing an example of a mark menu of a handheld master terminal.

This is a menu for marking GPS information of the present position and managing an already marked list.

As such, the present invention realized the following functions:
The realization of an invisible fence using a bidirectional RF communication solution capable of configuring a network.
The realization for an invisible fence function, for an object tracking function and for a function of possibly using a dog training commonly. Here, a training mode button can be directly installed in the construction of a menu to transmit an invisible fence mode, a tracking mode and a direct mode.
A technology that transmits a recorded voice command or one way voice communication (for example, ‘stop’ and ‘get back’) through a speaker to an object (a person, an animal or other moving objects) according to a scenario set in a handheld master terminal
A method that transmits a vibration, an electric stimulation, a horn sound, a beep sound, and a LED flash to a corresponding object control unit and a technology that modifies each action as the control unit approaches nearer to an invisible fence.
A technology in a fence mode that performs a command by an object control unit itself according to a set condition when an event occurs in the object control unit and at the same time provides a report about this to a handheld master terminal, and a technology in a fence mode that requests the object control unit of information and receives a corresponding information by a handheld master terminal.
A technology in a tracking mode that set and use a tracking mode under a fence mode, a technology in a tracking mode that transmits only object control unit's own information to a handheld master terminal by the object control unit and a technology in a tracking mode that requests the object control unit of information and receives a corresponding information by the handheld master terminal.
A technology in a tracking mode that photographs a current situation as a moving image or a still image through a camera installed in an object control unit and transmits it to a handheld master terminal for displaying.
A technology that converts a voice command which is transmitted from a handheld master terminal to an object master terminal into a physical command, the voice command operating as a voice command name.
A technology that when object control units are located around a handheld master terminal, compares location information the handheld master terminal and each object control unit possess and GPS location information references, calculates the distance and the orientation angle and transmits and performs a command according to a set condition.
A technology that realizes an invisible fence only by a RF modem (in this case, the orientation and the distance are provided).
A technology that operates a handheld master terminal and an object control unit through a GPS technology in an object control unit and a bidirectional RF modem module when an object departs from an invisible fence and returns there.
An invisible fence setting technology and its stream
The internal H/W construction of an invisible fence and a driving solution
A data managing technology in a handheld master terminal
A technology that assigns an invisible fence area as not a circle but a free area and constructs it.
A technology that operates more than 2 handheld master terminal as a star network concept and expands and manages the control/monitoring range to expand a coverage.
A technology that analyzes the characteristic (the number of departure, tracking of the departure direction, timing, the departure position, etc.) of an object in a computer using a memory within a handheld master terminal and confirms visibly the current status (existing in a fence or not, departure information, etc.) of the entire object control units to be managed (for example, the electric situation board of an object control unit) in order to manage an object to be managed collectively.

In the meantime, another embodiment of the present invention will be described below:

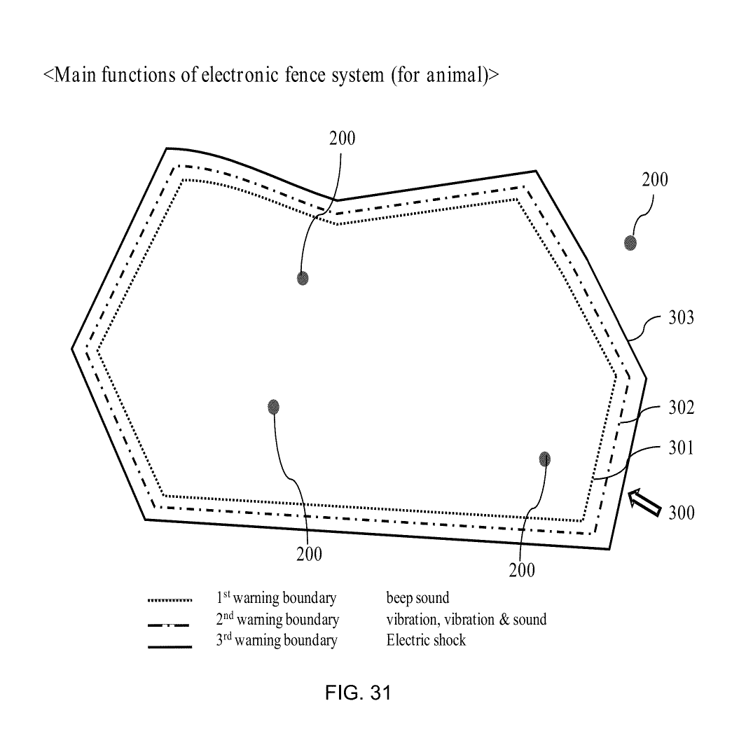

FIG. 31 is a conception view showing main functions of an electronic fence system wherein the present invention is applied in the case of an animal. Here, a coverage is divided into three areas. R1 area 301 is a first warning area, in which a beep sound is operated. R2 area 302 is a second warning area, in which a vibration, or a vibration & sound is operated. R3 area 303 is a third warning area, in which an electric shock is operated.

In the following, main functions will be described.
a vibration sending function
a vibration and LED flash
an electric shock sending function
a beep sound sending function
a recorded voice sending function and a direct voice sending function
a function of photographing, transmitting and displaying a still image or a moving image
Indicating the current location and status (Run, Scoring, sleep, stop and struggle) of an object control unit on a handheld master terminal
a run & point function wherein a horn is not blowing when an object control unit is moving, but the horn is blowing when the object control unit is not moving but stops.
Indicating a warning message and the current location (the orientation, the departure distance, the state indication) on a handheld master terminal when an object departs from an invisible fence.

Also, the operation procedure will be described below:
When approaching to an invisible fence from a free zone (inside of 1^{st} warning zone)
   1^{st} warning: a beep sound or a LED flash
   2^{nd} warning: a vibration, a vibration+sound
      The order of 1^{st} Menu and 2^{nd} Menu can be changed by the selection of a user. Ex) These changes are possible: the first −a vibration, a vibration+sound, and the second −a sound.
3^{rd} warning: an electric shock is generated. (As it comes near to a fence, the shock level increases.)
The distance can be changed and the voltage can be changed (after an initial setting, they increase)
When departing from the invisible fence
   A corresponding object control unit exists outside of the invisible fence (outside of 3^{rd} warning zone)
   At the outside of the invisible fence, the electric shock of the object control unit turns “OFF” and a LED attached to the object control unit is operated.
   At the same time, a horn is operated, and a warning to the object (optional) and a warning to a user are indicated.
   If a computer is connected or a warning board is installed, a warning message is provided.
When homecoming
   The moment it enters 2^{nd} warning zone, 3^{rd} warning zone is activated. Thus, an electric shock is delivered when it is trying to extricate again.
   When it returns there completely, warning boundaries of all the zones are activated.
Manually photographing and displaying a still image is possible all the time.

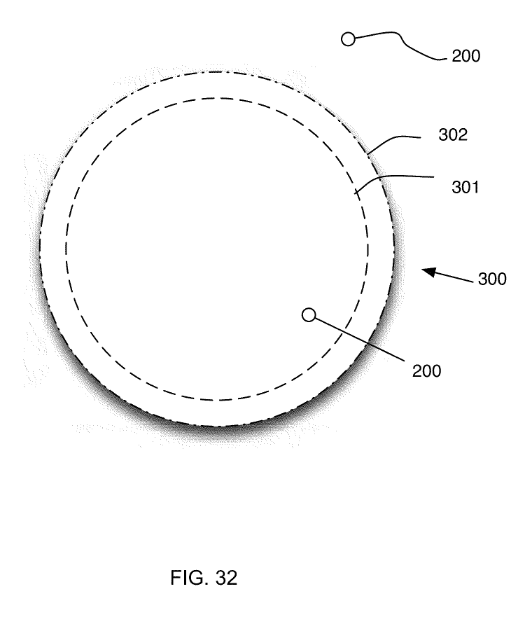

FIG. 32 is a conception view showing main functions of an electronic fence system. Here, a coverage is divided into two areas: R1 area 301 is a first warning area, in which a beep sound or a LED flash is operated. R2 area 302 is a second warning area, in which a vibration, or a vibration & sound is operated.

In the following, main functions will be described.
a vibration sending function
a vibration and LED flash
a beep sound sending function
a recorded voice sending function and a direct voice sending function
a function of photographing, transmitting and displaying a still image or a moving image
Indicating a warning message and the current location (the orientation, the departure distance, the state indication) on a handheld master terminal when an object departs from an invisible fence.

Also, the operation procedure will be described below:
When approaching to 1^{st} warning zone from a free zone
   1^{st} warning: a beep sound or a LED flash
   2^{nd} warning: a vibration or a vibration+sound, a recorded voice message
      The order of 1^{st} Menu and 2^{nd} Menu can be changed by the selection of a user. Ex) These changes are possible: the first −a vibration, a vibration+sound, and the second −a sound.
Manually photographing and displaying a still image is possible.
When departing from 2^{nd} warning zone
   It currently exists out of the invisible fence.
   At this time, a warning message and the current location are indicated on the handheld master terminal
When homecoming and entering in the invisible fence
   The existing signal is received as is (a message “It entered in the area” is provided and transmitted).
   Manually photographing and displaying a still image is possible.

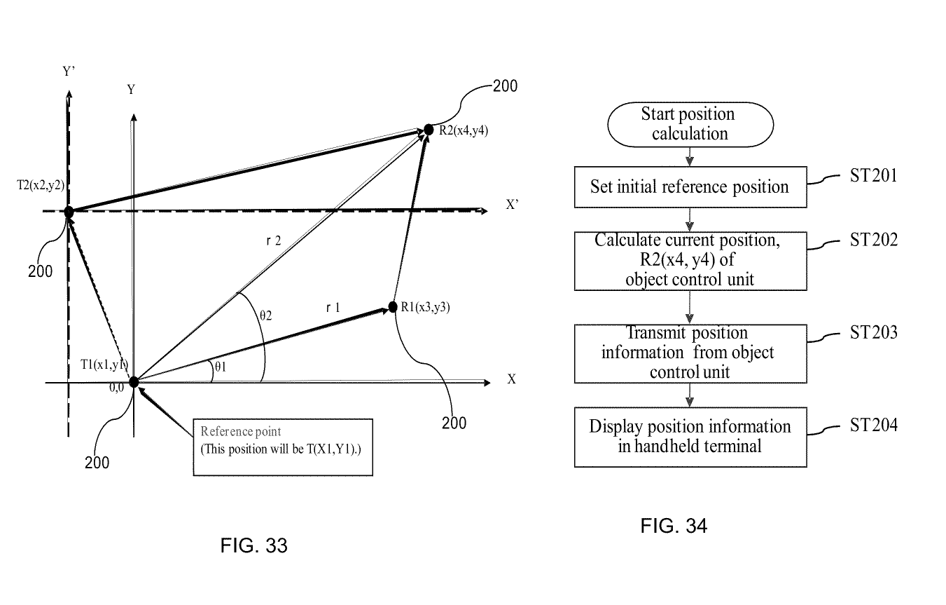

FIG. 33 is a conception view showing an example of calculating locations in an electronic fence system of the present invention.

A basic concept will be described below:
1) A reference point is set as the calculation reference of all the positions.
2) The initially set reference point becomes a base for calculating the current location of an object control unit and a handheld master terminal
3) The object control unit transmits its location from the reference point to the handheld master terminal, wherein the object control unit transmits its location in the form of its coordinates, the displacement from the initial position (ΔX, ΔY) or θ, r.
4) The handheld master terminal can display a relative position and the distance of the object control unit with respect to its current position.

The meaning of each item in FIG. 33 will be described below:
A. An initial reference point: T1 (x1, y1)
B. An initial position of a handheld master terminal (it can be the same as the initial reference point): T1 (x1, y1)
C. An initial position of an object control unit (it can be the same as the initial reference point): R1 (x3, y3)
D. An original coordinate axis being the center of all coordinates around the reference point: X-Y
E. The current position of the handheld master terminal: T2 (x2, y2)
F. The current position of the object control unit: R2 (x4, y4)
G. An imaginary coordinate axis for showing positions on the screen of the handheld master terminal: X′-Y′
H. θ1, r1: An initial position angle and distance between the reference point and the object control unit
I. θ2, r2: The current position angle and distance between the reference point and the object control unit

FIG. 34 is a flow chart of a location calculation method of an electronic fence system according to an embodiment of the present invention.

A procedure of calculating the current position of an object control unit 200 will be performed as described below:
A. Step 1: an initial reference position is set (it can be the same as an initial position of a handheld master terminal and a object control unit): T1 (x1, y1)
i. The handheld master terminal receives GPS data from a satellite, and stores its latitude and longitude data as T1 (x1, y1). Basically, the coordinates of T1 (x1, y1) is set as (0, 0), and it is defined as an initial reference point. This point exists as a base coordinates for calculating the position of the handheld master terminal and the object control unit.
ii. The handheld master terminal, which set the initial reference point, transmits the corresponding point data to the object control unit located in the point R1 (x3, y3).
   The meaning of an initial stage: GPS data being received from a satellite can cause a measuring error according to the reception sensitivity. If the handheld master terminal and the object control unit are simultaneously located within a tolerable error range (about 15 m), the handheld master terminal and the object control unit are considered to be in the same position. To eliminate the error, an initial stage for the handheld master terminal and the object control unit to share their latitude and longitude is needed, and this initialization can be preformed by setting and sharing a reference point.
iii. Next, the object control unit, which received the corresponding reference data from the handheld master terminal, transmits a message saying it received the data to the handheld master terminal.
iv. In the conclusion, the handheld master terminal and the object control unit confirms that they have the same reference position and sets that position as (0, 0), and all the future locations will be calculated with respect to this position.
B. Step 2: a conversion method of the current position R2 (x4, y4) of an object control unit
i. When the object control unit has moved from an initial position R3 (x3, y3) to the current position R4 (x4, y4), this can be expressed by using a vector. That is, an initial position of a receiver can be expressed a distance r1 and an orientation angle θ from a reference point, and the current position can be expressed a distance r2 and an orientation angle θ2 from a reference point. Here, a distance from the reference point to the object control unit can be expressed as r2=r1+Δr(Δr: an increased value from r1 to r2) or (R2−T1)=(R1−T1+(R2−R1). Also, altitude information can be received at each transmission/reception device, and therefore it may not be transmitted/received separately to reduce the amount of transmission/reception data.
ii. Also, the handheld master terminal moves form T1 (x1, y1) set as a reference point to the current position, T2 (x2, y2). Here, when T1 (x1, y1) is defined the reference point, it can have the coordinates of (0, 0) as described above, and it becomes a base coordinates for calculating the position of the handheld master terminal. Also, the handheld master terminal recognizes its position T2 (x2, y2) with respect to the reference point, and can indicate the position of the object control unit on an imaginary coordinates X′-Y′ with respect to this point.
iii. When the object control unit receives GPS position information data continuously from a satellite, compares the received current position information and the initially set reference point T1 (x1, y1) to convert it to location information (a distance and an angle) regarding to what extent it is far away, and then it stores the value.
C. Step 3: the transmission of position information of an object control unit
i. The position information of the object control unit (xN, yN) converted by the correlation between the GPS position information data received at the object control unit and the initially set reference point T1 (x1, y1) is transmitted periodically to the handheld master terminal according to a predefined condition.
ii. Here, the object control unit calculates its position with the GPS position information received by itself from the satellite, and it converts a relative position from the reference position rather than recognizing its own position.
D. Step 4: showing position information on a handheld master terminal
i. A handheld master terminal, which received position information of the corresponding control unit from an object control unit, constructs an imaginary coordinates (x′-y′) with respect to its current position T2 (x2, y2), and indicates the location of the object control unit on the imaginary coordinates (x′-y′).
ii. Also, altitude information can be received at each Transmission/reception device, and therefore it may not be transmitted/received separately to reduce the amount of transmission/reception data.
iii. The location of the handheld master terminal and the object control unit can be indicated with respect to the reference point. (That is, a motion path of the receiver can be tracked with respect to a starting point, and a total motion distance can be calculated)

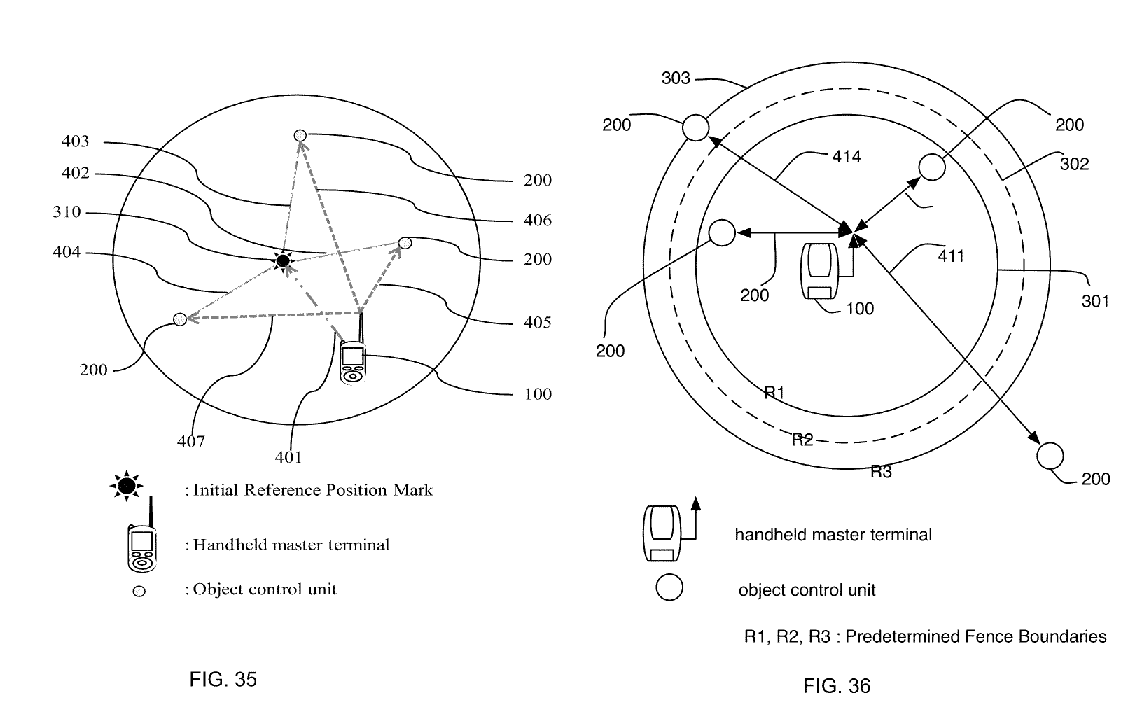

FIG. 35 is a conception view showing the first operation method of an electronic system according to the present invention. Here, a handheld master terminal 100 and a reference position 310 form a communication linkage network 401. Also, a plurality of object control units 200 and a reference position 310 form communication linkage networks 402 through 404. Also, the handheld master terminal 100 and a plurality of object control units 200 form communication linkage networks 405 through 407.

Thus, a reference position setting will be performed as described below:
1) A handheld master terminal determines an initial reference position and transmits a set value to each object control unit.
   An initial reference position
   Setting a location information report period of each object control unit
2) the handheld master terminal sets an initial setting position as a reference position.
3) each object control unit stores the initially received reference position and calculates its relative position from its own GPS information with respect to the reference position.
4) each object control unit periodically transmits a relative position from the initial reference position, that is (X, Y) coordinates, and its status independent of the current location of the handheld master terminal
5) the handheld master terminal calculates its current relative position from the initial position.
6) from a relative position information against the reference position, that is (X, Y) coordinates, transmitted from the object control unit, a distance, an orientation and the like against the relative position of the handheld master terminal are calculated.

FIG. 36 is a conception view showing the second operation method of an electronic system according to the present invention. Here, a boundary 300 is comprised of three areas 301 through 303. Also, a handheld master terminal 100 is comprised of a plurality of object control units 200 and communication linkage networks 411 through 415.

Thus, the construction of I-Fence system will be described below:
communication between a handheld master terminal and each object control unit is possible using a Zigbee modem module
communication within a radius LOS of the minimum 1 mile is possible using Zigbee solution+high gain antenna
a handheld master terminal periodically receives a coordinates and status information report of an object control unit within a coverage, and calculates a distance from the current position of the handheld master terminal and a relative position for monitoring and managing
one handheld master terminal forms a managing group by configuring a star network in an initial network construction
a managing group in each handheld master terminal is set and operated by assigning each object control unit an ID
each object control unit periodically transmits location information and status information according to an operation mode, or when a preset event occurs, it transmits its distance and coordinates from a reference point to the handheld master terminal and performs a preset, corresponding command

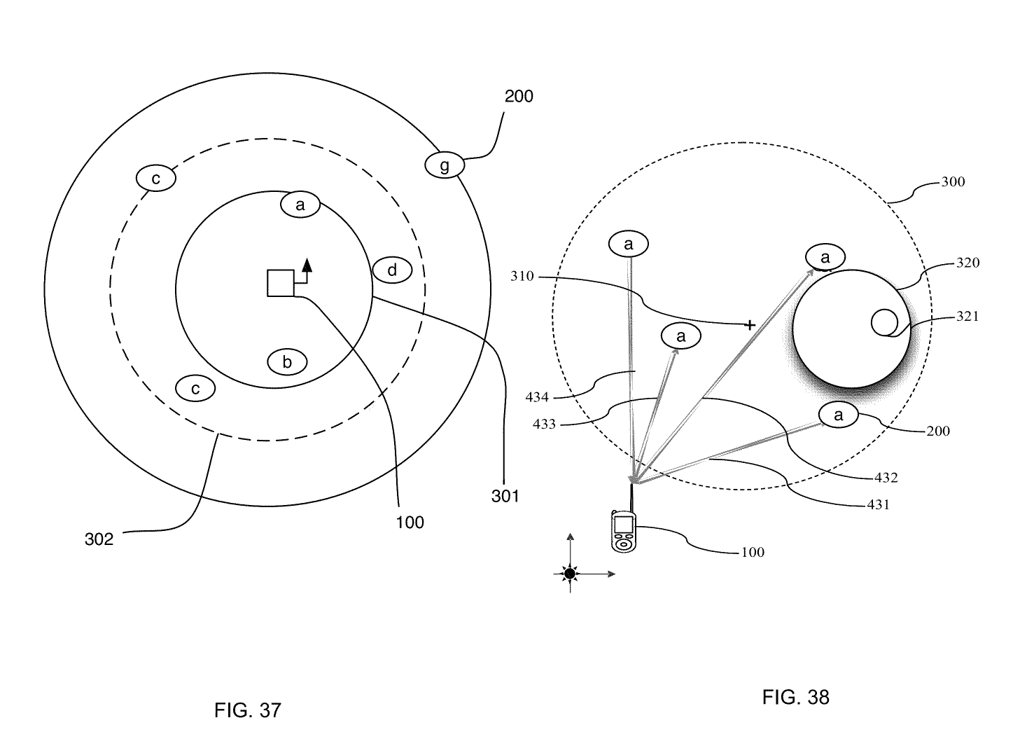

FIG. 37 is a conception view showing an operation example of a fence mode of an electronic fence system according to the present invention.

Here, the setting is described. That is, a fence area is divided into R1, R2 and R3 with respect to a handheld master terminal, and a fence is installed in the handheld master terminal.

Also, the functions in the set area will be described below:
1) R1: a safety area
an object control unit intermittently transmits location information to a handheld master terminal

2) R2: a warning area
when an object control unit departs from the safety zone R1, it transmits a safety area departing message to the handheld master terminal (‘the safety area departure’ on a LCD display) and the relative position of the out-of-range control unit (c, d and e) is sent
meanwhile, the out-of-range object control unit (c, d and e) transmits a sound+LED signal as a predefined warning message when it departs from the safety area

3) R3: an invisible fence limit line area
a sound and shock (or a sound and vibration) is provided to object control unit (f, g) approaching a limit line for ten seconds (then, a sound for 10 seconds and an electric shock or a vibration for 10 seconds are provided repeatedly)
meanwhile, location information of the out-of-range object control unit and a message saying that the control unit departed from ‘limit line’ are transmitted to the handheld master terminal
also, a direct signal information (a shock or a vibration) can be transmitted to the corresponding control unit (it is used only when necessary)
4) when the object control unit departs from the corresponding area, a control command is cut off
5) a signal when the out-of-range control unit returns
in a state that a control unit (h) completely departed from the limit line, the handheld master terminal can track the corresponding object control unit
when the control unit (h) returns, R3 area will be released, and when it enters in R2 area, R3 area will turn into an active mode again

FIG. 38 is a conception view showing an operation example of a lock-down mode of an electronic fence system according to the present invention. Here, a reference position 310 is set within a boundary 300. Also, an electric fence 320 which is operating as a lock-down mode is formed, and a reference operation position 321 is set within the lock-down mode electric fence 320. Also, a handheld master terminal 100 and a plurality of object control units 200 form communication linkage networks 431 through 434.

This means of setting an additional fence in a region where a managed object is unwanted or of confining an object separately in a certain area, in a procedure that an initial reference position and then a fence are defined according to the present invention.

A handheld master terminal sets a reference position, transmits this value to an object control unit, and the object control unit, which received this value, stores the value, and periodically transmits coordinates values from the reference point to the handheld master terminal, wherein the coordinates values from the reference point are obtained considering GPS position information received from a satellite. During this procedure, the handheld master terminal transmits a boundary condition that the object control unit must perform, the boundary condition for setting a sub-fence for a lock-down mode. Herein, the sub-fence means another fence set in a fence.

A boundary between two fences is used in a normal operation mode. An embodiment of the present invention supports a lock-down mode of an electronic fence system, and this mode has a small fence area which has any given radius from an object control unit, and is operated in time that the lock-down mode is initiated and activated.

The lock-down mode may be activated as soon as the object control unit receives a control command from the handheld master terminal, or if a given condition is satisfied (for example, if the control unit approaches a given area or position), or if the object control unit departs from a field of view and thus the communication with the handheld master terminal is cut off, or if it approaches a given battery condition (for example, if the battery residual amount of the object control unit is 20%).

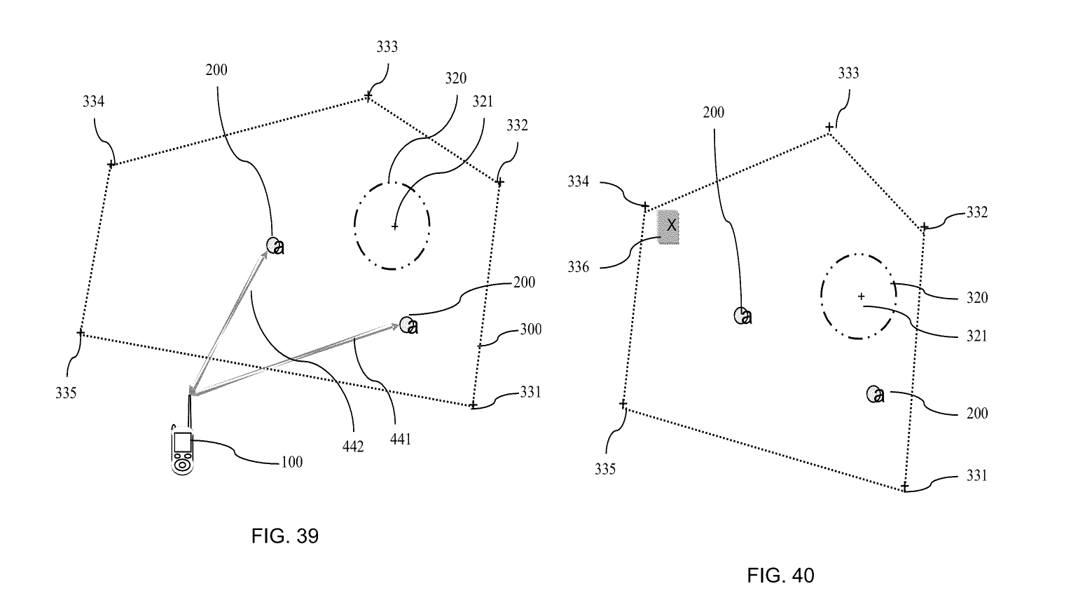

FIG. 39 is a conception view showing the first setting method of an electronic fence in an electronic fence system according to the present invention. Here, a plurality of assigned points 331 through 335 exist within a boundary 300. Also, an electronic fence 320 acting in a lock-down mode is formed, and a reference operation position 321 is set within the lock-down mode electric fence 320. Also, a handheld master terminal 100 and a plurality of object control units 200 form communication linkage networks 441 and 442.

Thus, a fence boundary 300, which has an irregular form, of the electronic fence incorporates object control units 200. These object control unit 200 is operated according to a predefined condition, and the fence boundary 300 includes another electronic fence 320 for a lock-down mode. In the figure, the boundary 300 of the electronic fence is defined by connecting a plurality of assigned points 331 through 335. In accordance with an embodiment of the present invention, the points defining the fence boundary 300 are created by a user moving to the corresponding position 331 through 335 in person and pressing a corresponding button on a handheld master terminal 100 or the object control unit 200.

Also, a fence connecting method using connection points will be described below:

That is, a user can draw a picture on the screen of a device (for example, a computer or a handheld master terminal 100) to indicate a point on the screen. A related device, that is a handheld master terminal 100, determines real coordinates for the indicated position and transmits the indicated coordinates to an object control unit 200 to activate an electronic fence 300 with respect to assigned positions 331 through 335 defining the boundary of the electronic fence 300. In the described embodiment, these position coordinates are transferred from the handheld master terminal 100 to the object control unit 200 via the communication linkage networks 441 and 442.

FIG. 40 is a conception view showing the second setting method of an electronic fence in an electronic fence system according to the present invention. Here, a plurality of assigned points 331 through 335 exist within a boundary 300. Also, an electronic fence 320 acting in a lock-down mode is formed, and a reference operation position 321 is set within the lock-down mode electric fence 320. Also, a cursor 336 can be placed at a part of the assigned points 334.

This shows a method of determining a corresponding point and connecting a fence on the screen through the cursor's movement.

Thus, the screen of a handheld master terminal shows the boundary of a fence 300, which is formed with assigned points 331 through 335. As shown in the figure, the cursor (336, indicated as “X”) is placed at one point 334. This represents one aspect of the present invention, and a user can move a cursor to a desired position and select a specified button (a hard button or a soft button, a selectable display option) to select the corresponding point 334. As shown here, the fence 300 and assigned positions are defined in relation to the location of an object control unit rather than a handheld master terminal In another aspect of various embodiments of the present invention, a fence area is defined related to the position of the object control unit on behalf of the handheld master terminal

In the meantime, the present invention constructs an electronic fence system using a WPAN (Wireless Personal Area Network) modem.

This will be described below:
Basically, the present invention can construct a star network from one handheld master terminal to manage an object control unit
One handheld master terminal acts as a coordinator on the WPAN
The present invention can assign PAN ID/Group ID/Device ID for a group management
When an object control unit is located in a communication enabled LOS (Line of Sight) range around a handheld master terminal, the object control unit, which initially received reference data being a base for position calculation, recognizes its coordinates from the reference data based on GPS position information accepted from a satellite, and transmits it to the handheld master terminal, and the handheld master terminal can compare it with its own GPS position information, calculate a distance and an orientation (latitude, longitude, etc.), and thus monitor the location and status of each object control unit.
   The object control unit generates and transfers an alarm to the handheld master terminal according to a predefined scenario when GPS location/orientation information of the object control unit is out of a preset condition and thus an event occurs, and transfers the coordinates and status of each object control unit to the handheld master terminal, and the handheld master terminal determines the transferred data to cope with the corresponding response.
   The handheld master terminal periodically receives location information and status of each object control unit in a preset period and generates an alarm according to its own set condition, and a user can cope with the corresponding response.
Several handheld master terminals are realized, and WPAN tree/mesh network are employed/configured. By operating the network and using a routing function, the coverage and the number of object control units to be monitored can be enlarged.
   Managing data of each handheld master terminal are transmitted to a headquarter master terminal, and then the headquarter master terminal can collect and manage them.
   When a coordinator function and a relay function are set in each handheld master terminal, the status and condition of terminals can be managed entirely using the communication between handheld master terminals or the communication between each handheld master terminal and a headquarter.

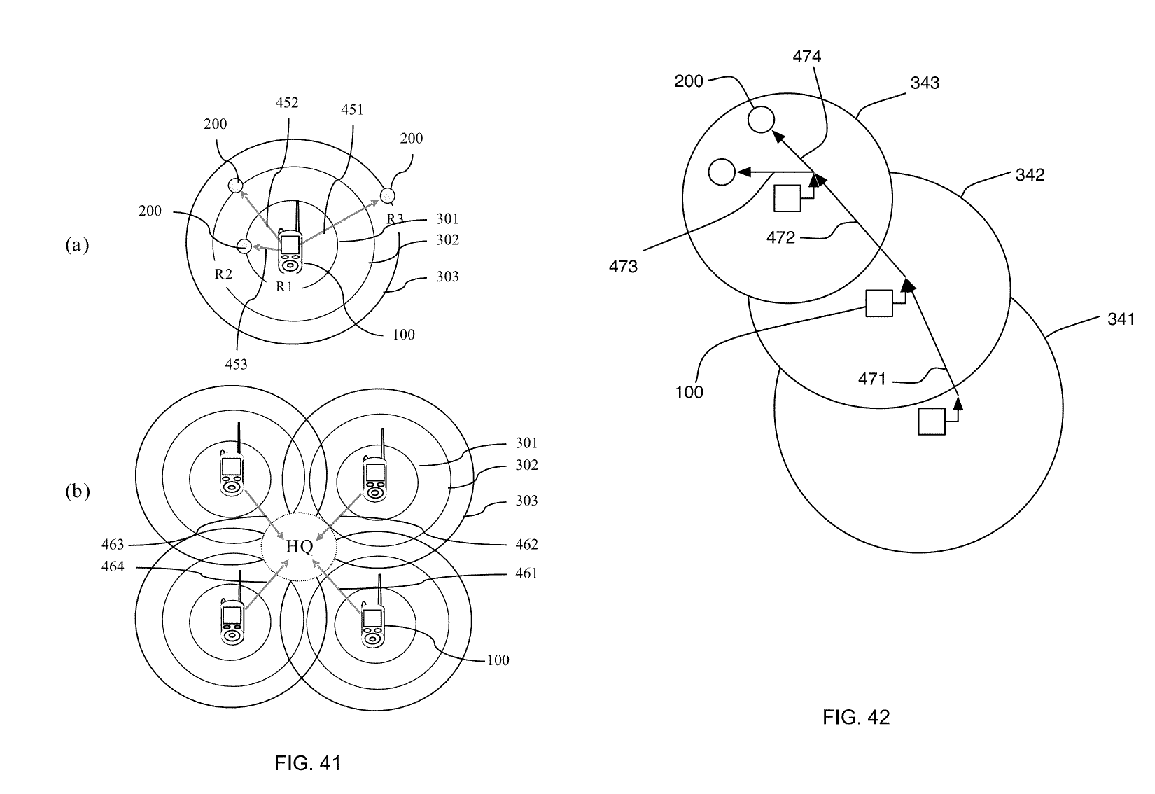

FIGS. 41 (a) and (b) are conception views showing the first range expanding method in an electronic fence system according to the present invention. Here, an electronic fence 300 is divided into three areas 301 through 303 in its action. Also, a handheld master terminal 100 and a plurality of object control units 200 form communication linkage networks 451 through 453. Also, a plurality of handheld master terminal 100 and a HQ post form communication linkage networks 461 through 464.

This will be described below:
the communication between a handheld master terminal and each object control unit is possible using Zigbee solution.
when using Zigbee solution with a bandwidth of 2.4 GHz and having a Class-I output of 16˜20 dBm, communication within a radius LOS of 1 mile is possible.
a handheld master terminal checks status of terminals within a coverage and transmits a control signal.
a communication range can be expanded by operating several Zigbee handheld master terminals for ensuring a communication distance.
a managing group can be set and operated within each handheld master terminal by assigning each terminal an ID.
if a relay function is realized in a handheld master terminal post, a structure that a piece of information of several handheld master terminal posts is collected for monitoring at one HQ(Headquarter) handheld master terminal post is realized.
the handheld master terminal is realized to have a function of controlling/monitoring terminals within a coverage and a function of transferring status to the HQ handheld master terminal post.
the HQ handheld master terminal post can manage the status of terminals within the entire coverage.
a monitoring program of HQ (Headquarter) can be developed according to an operation scenario.

FIG. 41 (a) shows a structure of realizing/operating one handheld master terminal post.
as shown in FIG. 41 (a), when object control units are located around one handheld master terminal, the handheld master terminal compares location information received from each object control unit with its own GPS location information reference to calculate a distance and an orientation angle.
when a coordinates value transferred from an object control unit is out of a preset boundary, a handheld master terminal performs a remote control (it is operated by a separately defined function) to operate an audio alarm and a stimulus electrode in Dog object control unit according to a scenario predefined in the handheld master terminal.
a control range of the handheld master terminal is determined according to output power and LOS of a modem, and an omni-directional antenna is used to realize a circular coverage.
communication of a radius of more than 1 mile is possible.

Also, FIG. 41 (b) shows a structure of realizing/operating several handheld master terminal posts.
when several handheld master terminals employing an omni-directional antenna are set as shown in FIG. 41 (b), the coverage can increase numerically and the overlap portion can be processed according to an algorithm of the operation scenario.
a control area of each handheld master terminal is the same as the operation of one handheld master terminal post as shown in FIG. 41 (a), and it is managed by each handheld master terminal according to location information, such as a distance, an orientation angle, etc., from each object control unit.
when management data of each handheld master terminal is transmitted to a headquarter (HQ) master terminal, the master terminal can collect and manage them. If a relay function is set in each handheld master terminal, the entire state and condition of terminals can be managed using communication between handheld master terminals and communication between a handheld master terminal and a headquarter.
when a RF antenna of a handheld master terminal is realized to have directivity, a coverage/range of any shape can be obtained.
if 4 through 6 Zigbee handheld master terminal posts are operated to ensure a coverage, it is possible to expand a control/monitoring range, and if a relay function is also realized in each handheld master terminal, management by one head quarter terminal post is possible.

FIG. 42 is a conception view showing the second range expanding method in an electronic fence system according to the present invention. Here, a plurality of handheld master terminal 100 has its own coverage 341 through 343. Also, a plurality of handheld master terminal 100, another handheld master terminal 100, and an object control unit 200 form communication linkage networks 471 through 474.

As shown in the figure, in an embodiment of the present invention, a handheld master terminal within an effective communication area communicates with other handheld master terminals via a communication linkage network. In an analogous way, a handheld master terminal is realized to communicate with another handheld master terminal via a communication linkage network. A handheld master terminal can communicate with an object control unit via a communication linkage network.

Also, in an operation by the addition of Mesh network, a control command heading for an object control unit can be transferred through a handheld master terminal to the object control unit. In particular, when an object cont control unit is out of an effective communication range of a handheld master terminal, the handheld master terminal transmits an indication that a message is being transferred as well as a control command by being connected to another reception enabled handheld master terminal. Such indication can be of any form, and normally it would be the same as the heading of a message. For example, if the kind of a message is determined as “broadcast”, a transmitter which receives “broadcast” message will repeat the transmission. In such an example, a handheld master terminal receives a message in a broadcast form, then forwards the message. A handheld master terminal receives a message in the form of broadcast which is transferred by another handheld master terminal, and then forwards that message to an object control unit intended to receive that message.

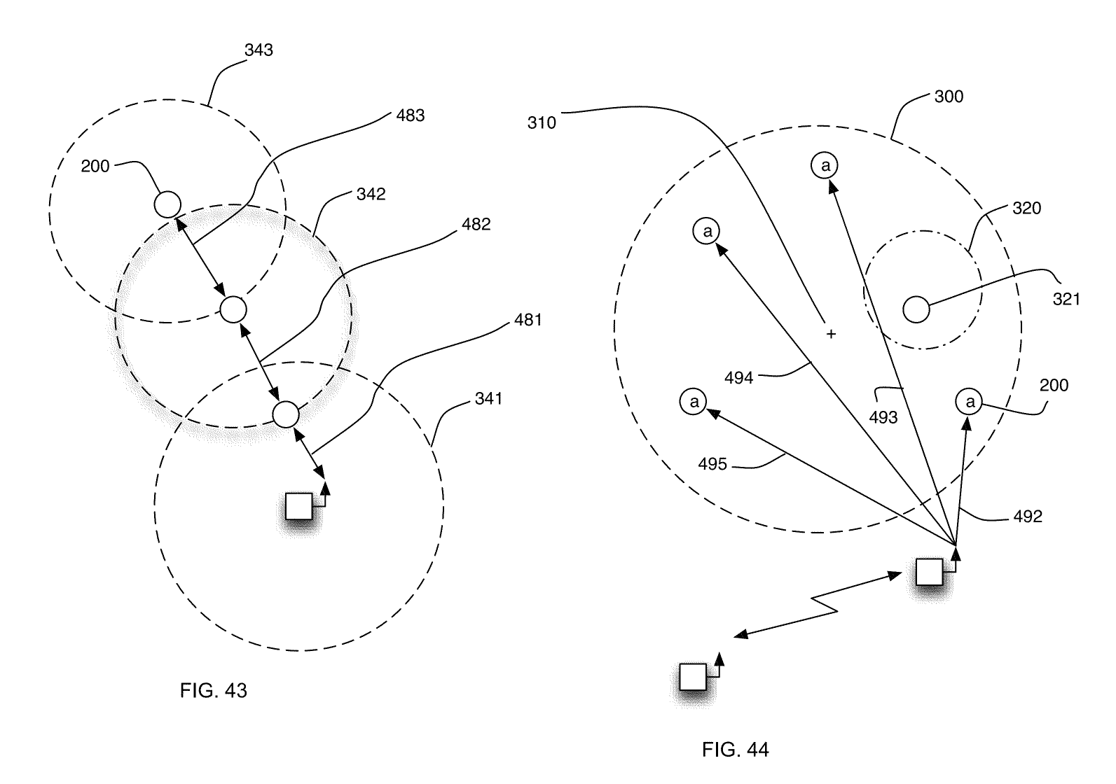

FIG. 43 is a conception view showing the third range expanding method in an electronic fence system according to the present invention. Here, a handheld master terminal 100 and an object control unit, respectively, has the coverage 341 through 343. Also, a handheld master terminal 100 and a plurality of object control units 200 form communication linkage networks 481 through 483.

Thus, a command can be transferred from a handheld master terminal to an object control unit.

As shown in the figure, in an embodiment of the present invention, an object control unit within an effective communication area communicates with other object control units via a communication linkage network. In an analogous way, an object control unit is realized to communicate with another object control unit via a communication linkage network. Another object control unit which received a control signal can communicate with other object control units via a communication linkage network.

Also, in an operation by the addition of Mesh network, a control command heading for an object control unit can be transferred through a handheld master terminal to the object control unit. In particular, when an object cont control unit is out of an effective communication range of a handheld master terminal, the handheld master terminal transmits an indication that a message is being transferred as well as a control command by being connected to another reception enabled object control unit. Such indication can be of any form, and normally it would be the same as the heading of a message. For example, if the kind of a message is determined as “broadcast,” a transmitter which receives “broadcast” message will repeat the transmission. In such an example, an object control unit receives a message in a broadcast form, then forwards the message. An object control unit receives a message in the form of broadcast which is transferred by another control unit, and then forwards that message to an object control unit intended to receive that message.

FIG. 44 is a conception view showing an operation method of a cellular network and a SMS in an electronic fence system according to the present invention. Here, a handheld master terminal 100 and a base station 350 form a communication linkage network 491. Also, the base station 350 has its own coverage 300. Here, the base station 350 can use other kinds of repeater, and it can be replaced with a cellular phone. Also, an electronic fence acting in a lock-down mode is formed, and a reference operation position 321 is set within a lock-mode electronic fence 320. Also, a handheld master terminal 100 forms communication linkage networks 492 through 495 with a plurality of object control units 200 through a base station 350.

In an embodiment of the present invention, a transmitter and/or a receiver communicates with each other. Thus, the present invention includes a logic for relaying the communication between a handheld master terminal and an object control unit or another handheld master terminal that are placed significantly far away.

In order to connect the communication between a handheld master and an object control unit or another handheld master terminal, the present invention uses a cellular network element for the communication between two devices. In an example of an embodiment, an object control unit can transmit a SMS message to a handheld master terminal so that the handheld master terminal can recognize the time, location and ID of the object control unit. In another specified embodiment, when an object control unit exceeds a set distance from the final location of a handheld master terminal, it may generate a SMS message.

Also, an embodiment of the present invention can use a cellular network element (an antenna similar shape) to support the communication between a handheld master and an object control unit and between a handheld master terminal and another handheld master terminal. As shown in the figure, one electronic fence can communicate to a cellular network using a cellular network element. Here, a handheld master terminal transmits a RF signal through a communication linkage network (this is indicated as straight line arrows) to a cellular network element, and the cellular network element retransmits a control command to a cellular network object (herein, an object control unit or a handheld master terminal). In a similar way, an object control unit transmits a report or other transmission contents, which is to be transferred to a handheld master terminal, to a cellular network element object via a communication linkage network, and the cellular network element retransmits it to the handheld master terminal In another specific embodiment, an object control unit transfers a SMS message to a handheld master terminal via the cellular network.

The SMS message includes at least one of the ID, location (GPS information representing the position) and time of a receiver. The communication using a cellular network element can be performed continuously or in a given condition. For example, if a certain handheld master terminal is located farther than a given distance from a finally known object control unit or another handheld master terminal, the handheld master terminal and the object control unit performs communication via a cellular network. However, in general, a cellular based protocol and message or data includes any type of formats. The SMS message is one example of an embodiment.

(FIG. 44 shows a linkage relation between a terminal, a cellular network element and a far away placed object control unit.)

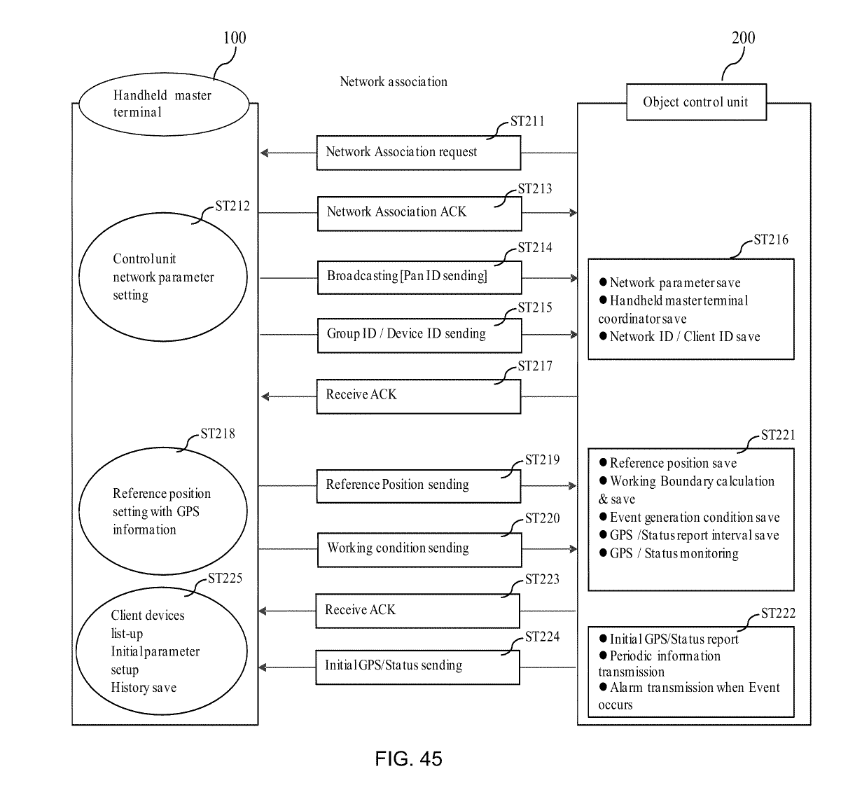

FIG. 45 is a conception view showing the first base location setting method in an electronic fence system according to the present invention.

A network between a handheld master terminal and an object control unit is configured in conformity with a network construction protocol of an applied bidirectional RF communication method, and one bidirectional communication enabled group is also constructed by forming a group and assigning an ID through the network construction between the handheld master terminal and the object control unit (ST211˜ST217).

Then, a handheld master terminal 100 performs a coordinator reference position assignment using its GPS information (ST218).

Then, the handheld master terminal 100 transmits a reference position to an object control unit 200 (ST219), and transmits a working condition (ST220).

Then, the object control unit 200 stores the reference position, calculates and stores a working boundary, stores an event occurring condition, stores GPS/status report period, and performs GPS/status monitoring (ST221).

Also, the object control unit performs initial GPS/status report, transmits information periodically, and performs an alarm sending when an event occurs (ST222).

Then, the handheld master terminal 100 receives a Receive approval from the object control unit 200 (ST223) and an initial GPS/status sending of the object control unit (ST224), performs Client devices List-up, performs initial parameter setup, and performs History store (ST225).

In the following Table 1, main activities of each mode of I-Fence will be provided:

TABLE 1

| Scenario | Fence mode | Tracking mode | Training mode |
|---|---|---|---|
| Operation | Portable control unit | Coordinates and | According to an |
| | is operated when an | status of portable | event, a operation |
| | event occurs. | control unit are | setting is released. |
| | Also, a portable | provided to a | |
| | control unit is | handheld master | |
| | selected in a manual | terminal | |
| | mode and a control | continuously. | |
| | command is | | |
| | transferred. | | |
| Target portable | Used for a slowly | Used for too swiftly | All the moving |
| control unit | moving object | moving object | objects are included. |
| | (domestic animals, | (hunting dogs, etc.) | |
| | dogs and persons | | |
| | that are not too | | |
| | swiftly moving) | | |
| GPS/status report | A longer time is set | It is moving fast, so | The setting is |
| period | among Event | it has a relatively | released. |
| | occurring conditions | short report period (5 | |
| | (10 sec/1 min/5 | sec/10 sec). | |
| | min). | A handheld master | |
| | | terminal can request | |
| | | a report. | |
| Operation rule | The setting of the | It reports | A trainer transmits a |
| | initial position of a | coordinates/status | command as needed |
| | handheld master | periodically (from | by a request. |
| | terminal is needed. | portable control unit | |
| | It has a periodic | to handheld master | |
| | Report cycle time. | terminal). | |
| | It operates according | It sets a condition | |
| | to a preset condition | which will act when | |
| | when an event (a | an event occurs. | |
| | fence departure, etc.) | It can transfer a | |
| | occurs. | command directly to | |
| | | the portable control | |
| | | unit. | |
| The subjective of | Operated according | Coordinates is | The setting is |
| data analysis | to a set condition by | constructed with | released. |
| | a portable control | respect to a reference | |
| | unit. | point. | |
| | In location | Performed by a | |
| | information, a | handheld master | |
| | reference point is | terminal | |
| | received from a | (with respect to | |
| | handheld master | coordinates and | |
| | terminal and the | status information | |
| | portable control unit | received periodically | |
| | operates according | from the portable | |
| | to this. | control unit). | |
| The occurrence of | By a portable control | By a handheld | One portable control |
| alarm, sound and | unit | master terminal | unit is selected to |
| stimulation | (according to a | (according to an | send a shock, a |
| | preset condition). | analyzed data). | vibration or a sound |
| | | | directly. |
| When alarm occurs | An alarm is provided | An alarm is provided | The setting is |
| | to a user of a | to a user of a | released. |
| | terminal, and a | terminal, and a | |
| | operation command | command is sent to a | |
| | is performed | portable control unit. | |
| | according to a preset | | |
| | condition. | | |

[above is continuation of Table 1]

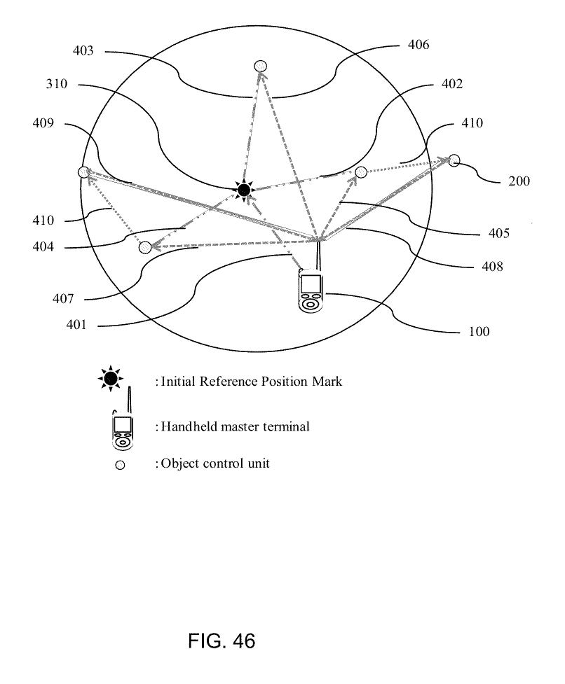

FIG. 46 is a conception view showing the system construction of a fence mode in an electronic fence system according to the present invention. Here, a handheld master terminal 100 and a reference position 310 form a communication linkage network 401. Also, a plurality of object control units 200 and a reference position 310 form communication linkage networks 402 through 404. Also, a handheld master terminal 100 and a plurality of object control units 200 form communication linkage networks 405 through 407. Also, even if an object control unit 200 moves out of a coverage 300, the handheld master terminal 100 and the object control unit which is out of the coverage can form communication linkage networks 408 through 410.

The operation of this system will be described below:
setting an initial reference position
a handheld master terminal confirms this reference position and transmits the set value to each object control unit
   An initial reference position
   A boundary limit rule value of 1/2/3 is set
   An event occurring condition [an out-of-boundary condition] is transmitted
   A location information report period of each object control unit is set
A handheld master terminal initially sets a reference position and it can move arbitrarily within a communication enabled range (if the handheld master terminal is out of the communication range, it cannot receive information of an object control unit external to the communication range)
when each object control unit exists within a communication distance irrespective of the position of a handheld master terminal, it transmits periodically the status information and the coordinates from its reference point to the handheld master terminal
it performs a command by itself according to a given condition when an event according to a set condition occurs, and periodically transmits status information to a handheld master terminal
a handheld master terminal can check and monitor an object control unit which generated an event in its current position.
it is an event-based operation, enabling the efficient electric power dissipation.
a handheld master terminal can move everywhere, but when it is out of a communication enabled area with an object control unit, it cannot collect information.

Also, the detail operation scenario of a fence mode will be described below:
it is useful in managing a plurality of object control units that would not move greatly over time
a reference position of a handheld master terminal is transmitted to each object control unit, and an object control unit receives and stores the reference position of the handheld master terminal and sets its coordinates with respect to this
also, a handheld master terminal transmits conditions for a command that an object control unit needs to perform to the object control unit
each object control unit confirms its coordinates with respect to a reference position received from a handheld master terminal and receives and stores a set condition, and it transmits its status information and its moving coordinates from the reference position with reference to GPS information received from a satellite to the handheld master terminal in a preset condition.
each object control unit operates conditionally in a certain boundary condition with respect to an initial reference position irrespective of the current position of a handheld master terminal, so it is unrelated to the location of the handheld master terminal when an event occurs
when a handheld master terminal is within a communication enabled range, it compares location information of an object control unit, which generated an event, with the current GPS location information of the terminal and calculates a distance and an orientation angle for position tracking
when it isn't out of a predefined fence range, an event has not occurred, so it will keep a transmission period longer to minimize electric power dissipation
but, its location information is periodically transmitted to a handheld master terminal for a general management. A user of an object control unit can set a report period of location information and status information of an object control unit considering behavior pattern of each object control unit. By setting as 30 seconds/1 minute/3 minutes/5 minutes, the efficient electric power dissipation is expected.

One example: if a communication enabled distance between a handheld master terminal and an object control unit is LOS 3 miles, for communication even in a worst case, a distance from an edge to another edge in an opposite angle must be within 3 miles. Therefore, a possible boundary and an effective movable distance of a terminal is a radius of 1.5 mile from an initial reference and a possible managing range is 1.5 mile regarding the reference position. When a motion distance of a handheld master terminal is small, the managing range can be increased.

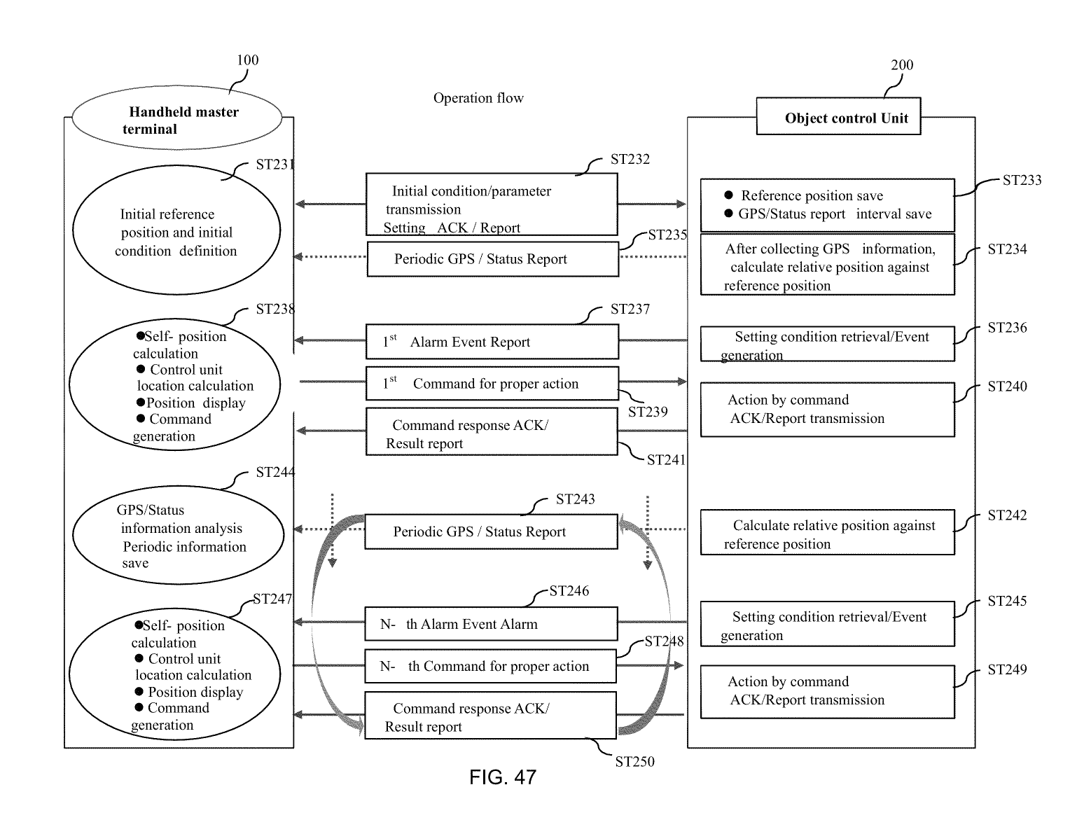

FIG. 47 is a flow chart showing the operation of a fence mode and a tracking mode in an electronic fence system according to the present invention.

Initially, a handheld master terminal 100 performs initial reference position assignment using GPS information (ST231). Then, the handheld master terminal 100 and the object control unit 200 transfers an initial condition and a parameter through information transmission/reception and receives a setting approval and a report (ST232).

Also, the object control unit 200 stores a reference position, and stores a GPS and status report period (ST233).

Thus, the object control unit 200 collects GPS information and calculates a relative position regarding the reference position (ST234), and transmits a periodic GPS and status report to the handheld master terminal 100 (ST235).

Also, an object control unit 200 retrieves a setting condition and performs an event generation (ST236), and transmits 1^{st} alarm event report to a handheld master report 100 (ST237).

Then, the handheld master terminal 100 calculates its own position, calculates the location of the object control unit 200, displays the location, and performs a command generation (ST238).

Then, the handheld master terminal 100 transmits 1^{st} command for proper action to the object control unit 200 (ST239). Then, the object control unit 200 performs action by command and transmits an approval and report (ST240). Also, the object control unit transmits a command response approval and result report to the handheld master terminal 100 (ST241).

Also, an object control unit 200 calculates a relative position regarding the reference position (ST242), and transmits a periodic GPS and status report to a handheld master terminal 100 (ST243).

Then, the handheld master terminal 100 analyzes the GPS and status information and stores the periodic information (ST244).

Also, the object control unit 200 retrieves a setting condition, and performs an event generation (ST245).

Then, N-th alarm event alarm is transferred from the object control unit 200 to the handheld master terminal 100 (ST246).

Then, the handheld master terminal 100 calculates its own position, calculates the location of the object control unit 200, displays the location, and performs a command generation (ST247).

Then, the handheld master terminal 100 transmits N-th command for proper action to the object control unit 200 (ST248), and the object control unit 200 performs action by command and transmits an approval and report (ST249).

Also, the object control unit 200 transmits a command response approval and result report to the handheld master terminal 100 (ST250).

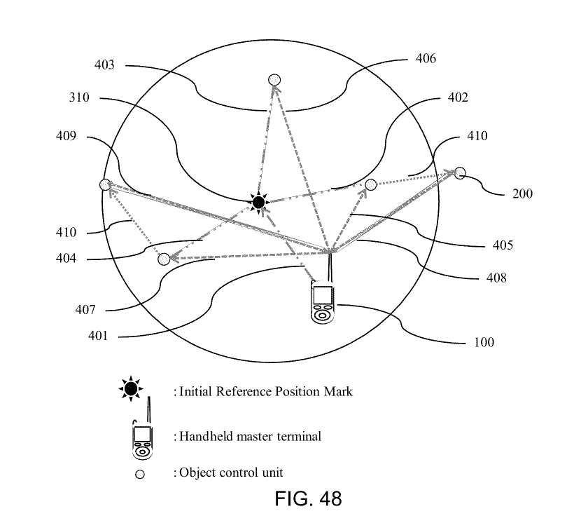

FIG. 48 is a conception view showing an operation example of a tracking mode in an electronic fence system according to the present invention. Here, a handheld master terminal 100 and a reference point 310 form a communication linkage network 401. Also, a plurality of object control units 200 and the reference position 310 form communication linkage networks 402 through 404. Also, the handheld master terminal 100 and a plurality of object control units 200 form communication linkage networks 405 through 407. Also, even if an object control unit 200 moves out of a coverage 300, the handheld master terminal 100 and the object control unit which is out of the coverage form communication linkage networks 408 through 410.

Thus, a basic concept of a tracking mode will be described below:
setting an initial reference position
a handheld master terminal confirms this reference position and transmits the set value to each object control unit
   An initial reference position
   A boundary condition (whether to use a fence or not is optional)
   An event occurring condition is transmitted
   A location information report period of each object control unit is set
A handheld master terminal initially sets a reference position and it can move arbitrarily within a communication enabled range (if the handheld master terminal is out of the communication range, it cannot receive information of an object control unit external to the communication range)
when each object control unit exists within a communication distance irrespective of the position of a handheld master terminal, it transmits periodically the status information and the coordinates from its reference point to the handheld master terminal
the object control unit transmits its location and status in a set period, so it keeps a modem and GPS ON all the time
a handheld master terminal and an object control unit can determine the monitoring/management of all object control units and whether to generate an event or not, and optionally the object control unit can determine them to minimize an electric power dissipation.
the handheld master terminal compares location information received from the object control unit with its location, calculates the position of the object control unit and then shows the position on the screen.
a communication enabled distance between a handheld master terminal and an object control unit means an effective communication distance where communication is feasible.

Also, the detailed operation scenario of a tracking mode will be described below:
it is useful in managing an object control units that would move fast
initially, a reference position of a handheld master terminal is transmitted to each object control unit
each object control unit receives and stores the reference position of the handheld master terminal, and it receives and stores an operation condition and transmits a corresponding response to the handheld master terminal
each object control unit checks its GPS information and transmits its location information and status periodically to the handheld master terminal
a handheld master terminal receives information from a moving object control unit periodically and then compares it with its location information to check where the control unit is located (if information is not received for a certain time or it is the information from the same position, an alarm occurs)
a terminal can set an object control unit of its own accord and request information
periodically received location information of each object control unit is generally managed by a handheld master terminal
if an object control unit departs from a set boundary, a handheld master terminal calculates about this and generates an alarm
according to the state of a corresponding alarm, a user can transmit various commands (a shock, a vibration and a sound) to the corresponding object control unit
an object control unit makes a response to a command transferred by the handheld master terminal
   A user of a handheld master terminal can set a report period of location information and status information of an object control unit considering behavior pattern of each object control unit.
a handheld master terminal compares location information received from an object control unit with its GPS location information reference, calculates a distance and an orientation angle, and tracks the location for monitoring and management
the entire monitoring coverage of a handheld master terminal equals a communication radius of a WPAN modem

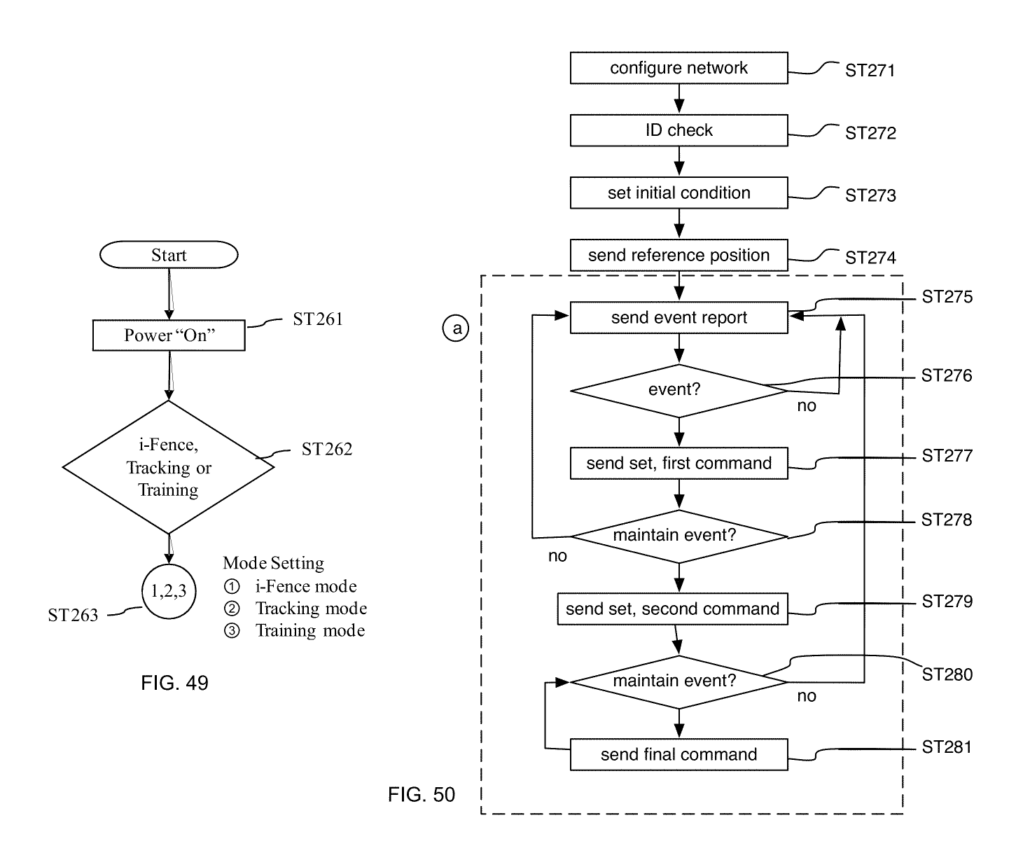

FIG. 49 is a flow chart showing an operation example in an electronic fence system according to the present invention.

When a system is started, the electric power of a handheld master terminal and an object control unit turns on (ST261).

Then, whether mode is to be set is determined (ST262).

Here, the mode includes an i-fence mode, a tracking mode and a training mode.

FIG. 50 is a flow chart of operating in a fence mode in FIG. 49.

When a fence mode is started, a network is configured with a WPAN modem (ST271).

Then, a registered ID check and an unregistered ID addition (a Group ID and an object control unit ID) are performed (ST272).

Also, according to an initial condition setting, an operation mode (initial condition) of each object control unit is set. At this time, the following operation is performed (ST273).
Reference position store
Event occurring conditions setting and store (an operation area and an action method for each area are determined)
GPS information and report period setting and store:
   Fence mode: an intermittent sending
   Tracking mode: a frequent sending
the setting of the kind of a sending command: setting the kind of a command for each area (a vibration, a recordable sound, a speaker or a beep sound, and an electric shock)

Also, through a reference position transmission, a reference location information transmission to an object control unit to be managed is performed (ST274).

Then, by an event report transmission, an object control unit transmits its information (the position and status) to a handheld master terminal (ST275).

Also, by an event determination, if information of an object control unit satisfies a previously set condition is determined (ST276).
If it is NO, then a report is provided according to a set period, asks again if it departs from there or not.
If it is YES, then 1^{st} command (a recordable sound or a beep sound)+flash that is set for an object control unit is transmitted (ST277).

Also, the status and warning is provided to a terminal, and then 2^{nd} warning command (a vibration and a vibration & beep sound) is transmitted (ST279).

Also, 3^{rd} final command (an electric shock for dogs and a voice and vibration for man) sending is performed. At the same time, status information (location, status, departure path, time) is continuously provided to a handheld master terminal. But a sound and shock (or a sound and vibration) is provided for 10 seconds. (Then, a sound for 10 seconds and an electric shock or a vibration for 10 seconds operates repeatedly) Also, a status and warning is provided to a terminal (ST281).

Here, an event condition means whether to satisfy a preset condition.

Also, the defined ‘a’ means a part of a loop defined in a fence mode.

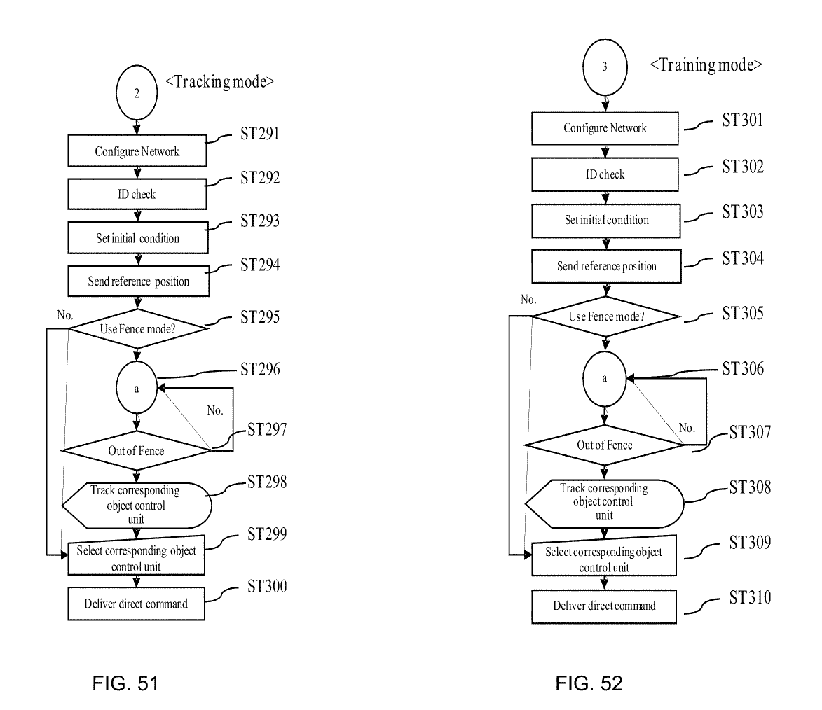

FIG. 51 is a flow chart of operating in a tracking mode in FIG. 49.

When a tracking mode is started, a network is configured with a WPAN modem (ST291).

Then, a registered ID check and an unregistered ID addition (a Group ID and an object control unit ID) are performed (ST292).

Also, according to an initial condition setting, an operation mode (initial condition) of each object control unit is set. At this time, the following operation is performed (ST293).
Reference position store
Operation condition setting (a command, a report period, the kind of a command, etc.)

Also, reference position information is transmitted to an object control unit to be managed through the reference position information transmission. Also, each object control unit receives and stores the reference position (ST294).

Then, whether to use a fence mode is determined (ST295). By this, the fence mode can be used selectively. The fence mode is used identically, and a boundary condition for performing a command can be varied.

Also, the defined ‘a’ means a part of a loop defined in a fence mode.
a: it means a loop of a fence mode, and when using a fence mode, a loop of the fence mode is used (ST296).

Then, whether it departed from a fence or not is determined (ST297).

If an object control unit departed from the fence, a piece of information (the current position, status, the departure time, the departure path, etc.) of the object control unit, which departed from the fence, is shown (ST298).

Also, optionally an ID of an object control unit is selected to transfer a direct command (ST299, ST300). Herein, a direct command includes a recordable voice, a voice sending using a speaker, a vibration sending, a nick electric shock sending, a continuous electric shock sending and the like.

FIG. 52 is a flow chart of operating in a training mode in FIG. 49.

This training mode is operated in the same way as the tracking mode.

When a training mode is started, a network is configured with a WPAN modem (ST301).

Then, a registered ID check and an unregistered ID addition (a Group ID and an object control unit ID) are performed (ST302).

Also, according to an initial condition setting, an operation mode (initial condition) of each object control unit is set. At this time, the following operation is performed (ST303):
Reference position store
Operation condition setting (a command, a report period, the kind of a command, etc.)

Also, reference position information is transmitted to an object control unit to be managed through the reference position information transmission. Also, each object control unit receives and stores the reference position (ST304).

Then, whether to use a fence mode is determined (ST305). By this, the fence mode can be used selectively. The fence mode is used identically, and a boundary condition for performing a command can be varied.

Also, the defined ‘a’ means a part of a loop defined in a fence mode.
a: it means a loop of a fence mode, and when using a fence mode, a loop of the fence mode is used (ST306).

Then, whether it departed from a fence or not is determined (ST307).

If an object control unit departed from the fence, a piece of information (the current position, status, the departure time, the departure path, etc.) of the object control unit, which departed from the fence, is shown (ST308).

Also, optionally an ID of an object control unit is selected to transfer a direct command (ST309, ST310). Herein, a direct command includes a recordable voice, a voice sending using a speaker, a vibration sending, a nick electric shock sending, a continuous electric shock sending and the like.

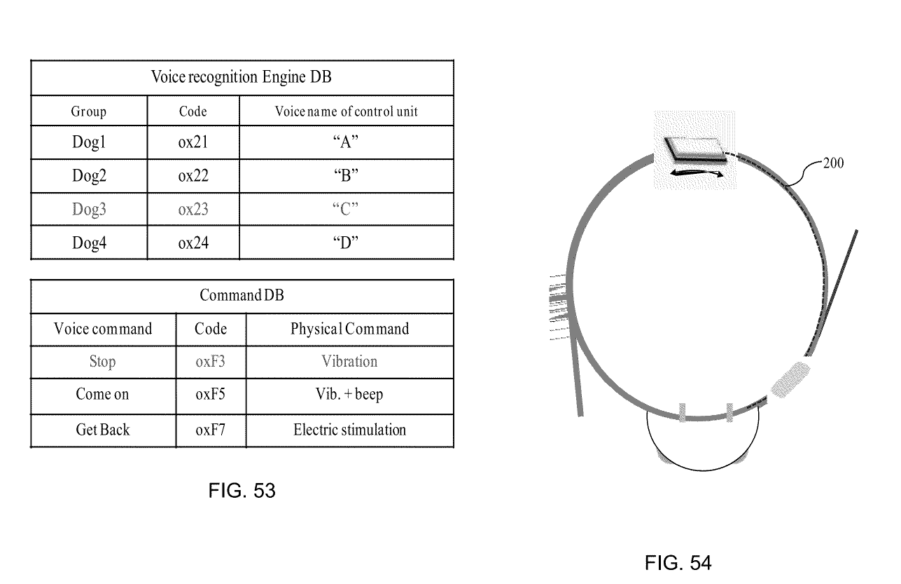

FIG. 53 is a conception view showing an example of a call command in the present invention.

Herein, a call command refers to a voice command transmitted by a handheld master terminal and thus an object control unit performs a wanted command.

A handheld master terminal according to the present invention has a voice recognition engine and stores a voice command corresponding to a control target to be controlled and a command to be performed in a code. For example, as shown in FIG. 53, we suppose that a control target “C” of Dog3 group is coded and stored as a voice code of “ox23.” Then, when “C” is called in a handheld master terminal, the handheld master terminal determines a control unit corresponding to “C” and performs the sending preparation. Next, a voice command, which is ‘stop’, is ordered in the handheld master terminal as shown in FIG. 53, the handheld master terminal transmits ‘ox23’, which is a voice recognition ID code of the corresponding object control unit, and ‘oxF3’, which is a code corresponding to ‘stop’ to the object control unit sequentially or simultaneously. Thus, the corresponding object control unit, which received these codes, performs ‘vibration’, a physical command previously set in the object control unit, regarding the voice command of ‘stop’. Here, the above voice command and physical command can be set in various formats.

FIG. 54 is a conception view showing the structure of a GPS reception antenna, which is movable, according to the present invention.

FIG. 54 illustrates an object control unit intended to be worn by an animal. Also, the present invention has a RF antenna for bidirectional communication, and a GPS antenna for receiving GPS information from a satellite. As shown in the figure, it has an electrode for transferring a training of an animal and a control command, and particularly the GPS antenna in the figure is worn at the neck of an animal, and its movement can be controlled freely according to the size of the neck when it is worn at the neck.

Also, when the size of a belt is adjusted according to the size of an animal, the GPS antenna of the object control unit is moved in a way that the position of the GPS antenna faces upward all the time.

Also, in the case of an object control unit used for a person, a GPS antenna and an object control unit in the lower side can be integrated not to have a great volume. Also, when a person uses this, a GPS signal from a satellite can be poor, and therefore to make up for this problem, it can be a harness structure such as a pack type or a pocket type attached/detached in the outside.

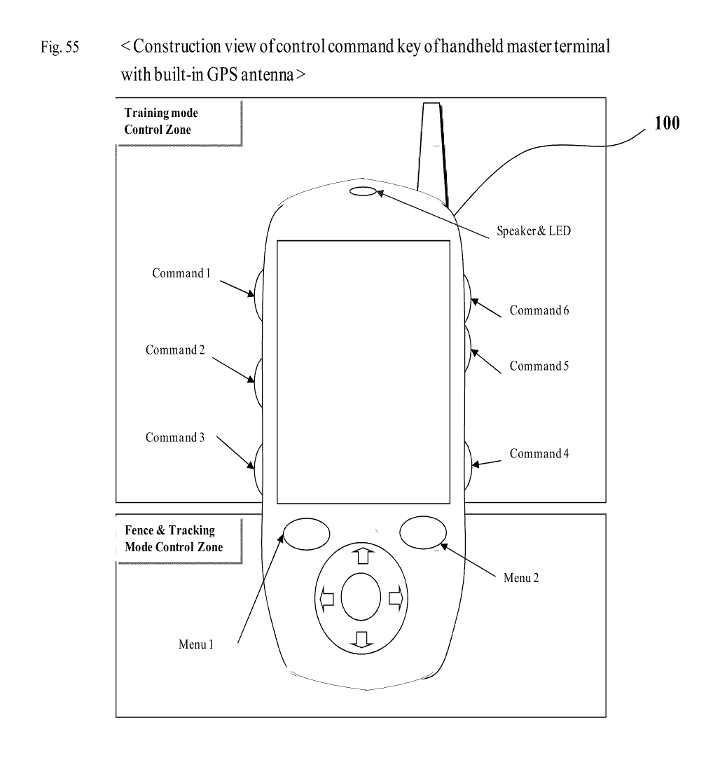

FIG. 55 is a conception view showing the construction of control command keys of a handheld master terminal having a built-in GPS antenna according to the present invention.

This consists of a direct command key used for a training mode and a control key used for a fence mode or a tracking mode, and performs controlling in all the modes.

As described above, the present invention can monitor activities of an object through using radio communication and restrict the same within a certain range of area via data communication, as a suitable guide, in order to return the animal to the limited area.

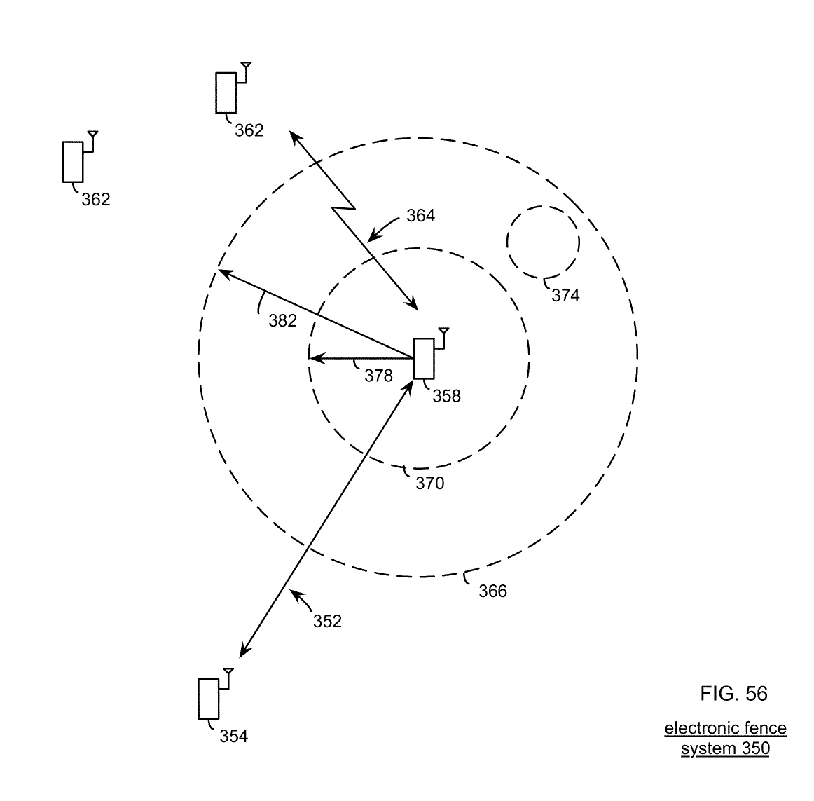

FIG. 56 is a functional block diagram of an electronic fence system according to one embodiment of the invention. Referring to FIG. 56, an electronic fence system 350 capable containing animals within an electronic fence and of guiding animals to return to a control area is shown. The electronic fence system 350 includes a transmitter unit 354 for generating radio frequency (RF) signals wherein the transmitter unit is operable to select between at least one of a plurality of functions and to generate a control command over a communication link 352 specifying at least one of vibration, high-frequency beep, vibration with high frequency beep, shock and shock intensity. The electronic fence system further includes a receiver unit 354 for receiving the transmitted RF signals and the control command wherein the receiver 358 initiates a stimulation based upon the control command. Receiver unit 358, in one embodiment, further includes a plurality of antennas structurally arranged in relation to a collar worn by an animal to receive radio frequency communication signals from a plurality of devices. In one embodiment, receiver unit 358 includes one antenna for receiving control commands from transmitter unit 354 and one antenna for receiving global positioning system (GPS) signals from which a receiver unit location may be determined by receiver unit 358. In one particular embodiment, at least one of the antennas is disposed within a collar that is attached to receiver unit 358.

Receiver unit 358 further includes a first receiver unit module for receiving control commands from the transmitter unit and a second receiver unit module for receiving satellite information from a plurality of GPS satellite transceivers 362. Such satellite information may be used to perform triangulation calculations to determine a location. Receiver unit 358 is operable to define an electronic fence based upon a specified location in relation to the a determined location based on satellite information 364 received through the second receiver unit module and further wherein the specified location is based upon one of a receiver unit location or a coordinate defined in a control command received from transmitter unit 354.

As may be seen here in FIG. 56, three electronic fences are shown. A fence 366 defines an area that encompasses a fence 370. Thus, fence 370 is concentric in relation to fence 366. Additionally, a fence 374 is shown to illustrate a lock-down mode of operation. In the example of FIG. 56, a user defines a fence boundary by defining at least one of a specified location and a distance from the specified location. For example, based on a received control command from transmitter unit 354, receiver unit 358 is operable to designate its current location as a fence center. Accordingly, a boundary of fence 370 is a function of a distance 378 (e.g., a radius 378) from the designated location while a boundary of fence 366 is a function of a distance 337 (e.g., a radius 337) from the designated location. In operation, for example, in one embodiment, the designated location is a location of receiver unit 358 at a time a specified control command is received from transmitter unit 354.

In an alternate embodiment, a user defines a fence boundary by defining GPS identified location designations on the transmitter unit 354 and then transmits fence boundary information in a control signal to receiver unit 358. In one particular embodiment, the user draws a fence boundary pattern on a display of transmitter unit 354 to identify the fence boundary. The fence boundary for fences 366 and 370 are for use in a normal mode of operation.

In one embodiment of the invention, the fence system supports a lock-down mode of operation in which a small defined fence area is activated having a specified radius from a receiver location at the time the lock-down mode is initialized or activated. The lock-down mode may be activated upon receiving a control command from transmitter unit 354, upon satisfying a specified condition (e.g, approaching a specified area or location, upon losing radio contact with transmitter unit 354, or upon reaching a specified battery condition (e.g., only twenty percent charge remaining for the receiver unit 358 battery). Thus, a specified level of depletion of charge may trigger the lock-down mode to facilitate the animal wearing receiver unit 358 being found more readily. As may be seen, fence 374 is concentric in relation to fence 316 but not in relation 370.

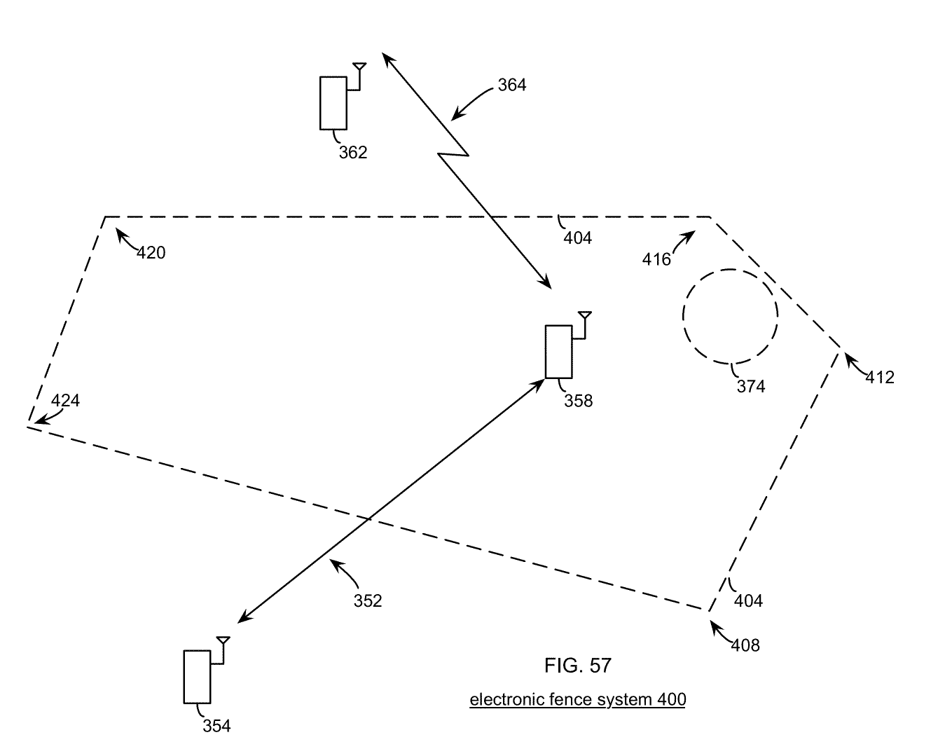

FIG. 57 is a functional illustration of an electronic fence system 400 according to one embodiment of the invention. As may be seen, an irregular shaped fence boundary for an electronic fence 404 encompasses receiver unit 358. Devices having previously defined reference numerals are the same as before. Thus, the fence boundary of electronic fence 404 encompasses lock-down electronic fence 374. One aspect to the embodiment of FIG. 57 is that the fence boundary of fence 404 is defined by straight lines between each of a plurality of designated points 408-424. In one embodiment, designated points for defining the boundary of fence 404 may be made by the user physically going to the designated points 408-424 and then hitting a designation button on one of the transmitter unit 354 or receiver unit 358.

Alternatively, the user may draw a figure on a display of a device (e.g., a computer or transmitter unit 354) wherein the user designates the points on the display. The associated device, e.g., transmitter unit 354, then determines actual coordinates of the designated locations and then transmits the designated location coordinates to receiver unit 358 to enable receiver unit 358 to activate electronic fence 404 to correspond with the designation locations 408-424 that define the boundary of fence 404. In the described embodiment, these location coordinates are transmitted from transmitter 354 to receiver 358 in communication link 352.

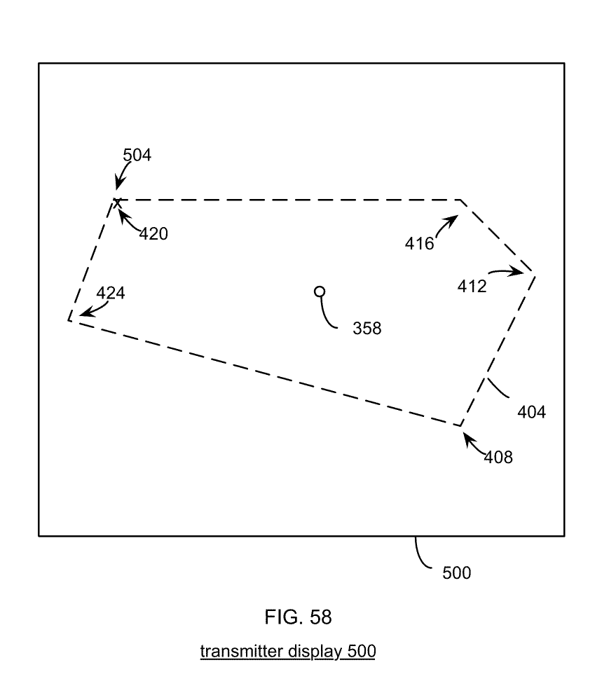

FIG. 58 is a functional illustration of a transmitter unit display for defining fence boundaries for an electronic fence system 500 according to one embodiment of the invention. Referring now to FIG. 58, a transmitter display 500 is shown displaying the boundary of fence 404 with designation locations 408-424. As may also be seen, a curser 504 (shown as an “X”) is located on the display at designation location 420. This represents one aspect of the invention wherein a user moves the curser to a desired designation location and then hits a designation button (hard button or soft button (selectable display option) to designate location 420 as a designation location. As may also be seen, fence 404 and designation locations are defined in relation to a location of receiver unit 358 and not transmitter unit 354. One aspect of many embodiments of the invention is that the fence areas are defined in relation to a location a receiver unit instead of a transmitter unit.

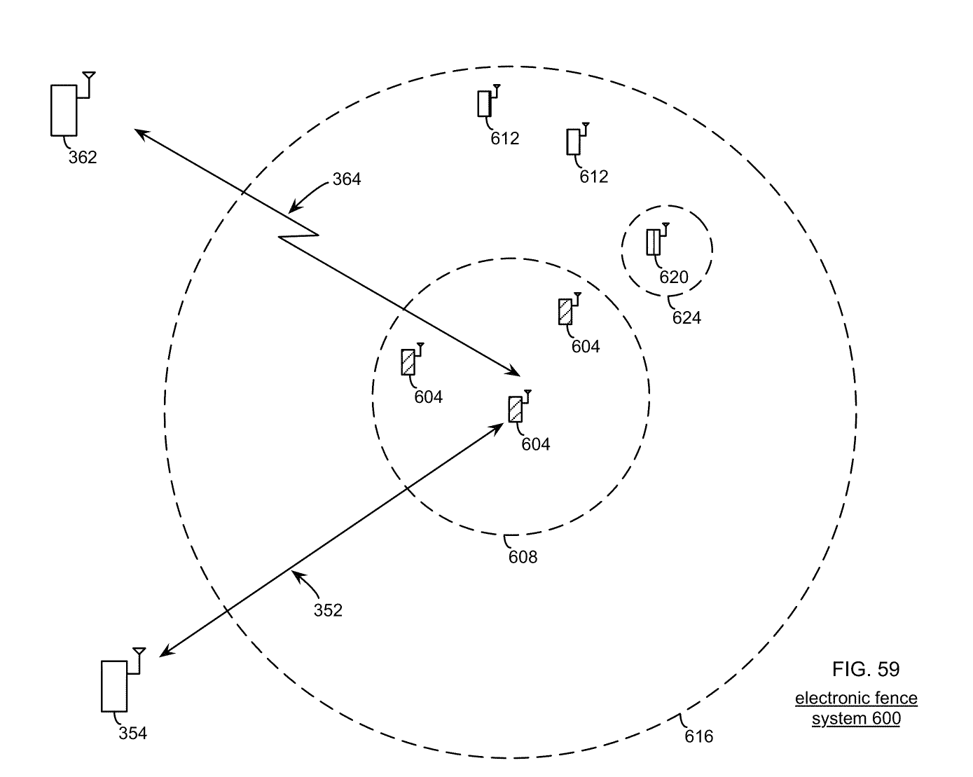

FIG. 59 is a functional block diagram that illustrates an additional aspect of the embodiments of the invention. Namely, an electronic fence system 600 is operable to define a plurality of electronic fences for a plurality of groups of receiver units. For example, a first plurality of receiver units having a group ID 604, as indicated by the diagonal shading, are within an electronic fence 608. These receiver units correspond to a common group ID. Thus, fence 608 is used to contain all animals having this common group ID 604. Pluralities of receiver units have a common group ID of 608 that correspond to electronic fence 616. These receiver units are illustrated with the horizontal shading.

Finally, a receiver unit 620 is within electronic fence 624 that is a lock-down mode fence. Thus, for example, receiver unit 620 may originally had the ability to wander within electronic fence 616 (assuming it had a group ID 612) but for one of a plurality of reasons, the lock-down mode was triggered for receiver unit 620 thereby creating electronic fence 624.

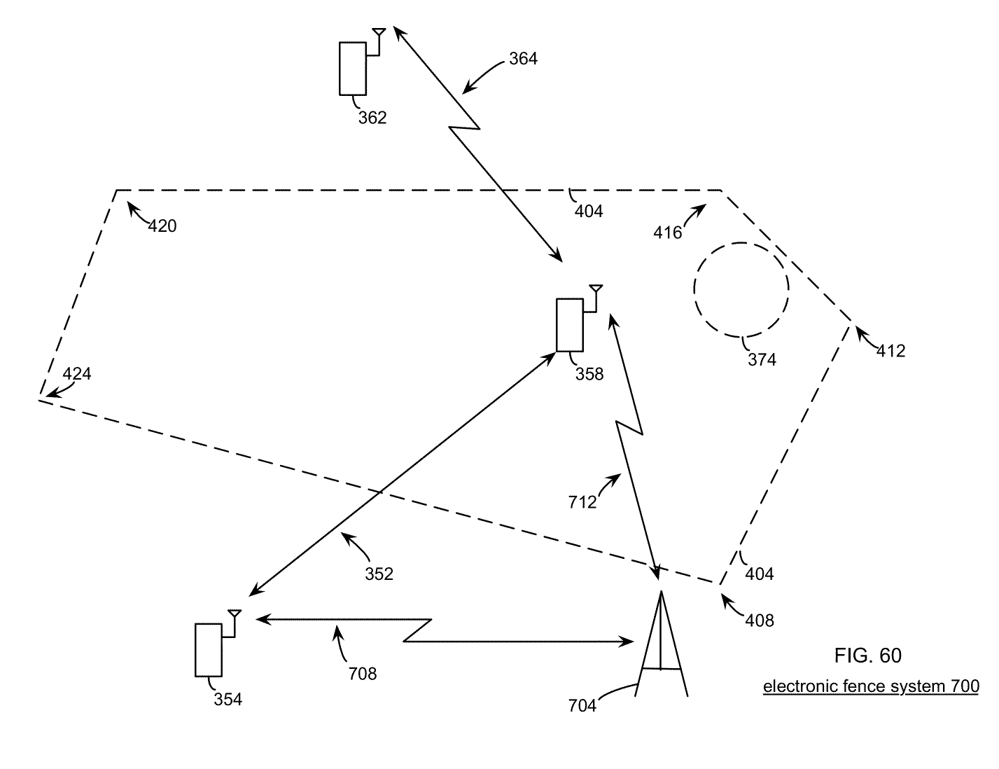

FIG. 60 is a functional block diagram that illustrates an electronic fence system that utilizes a cellular network element to support communications between transmitter units and receiver units according to an embodiment of the invention. Referring now to FIG. 60, an electronic fence system 700 is operable to communicate over a cellular network through a cellular network element 704 (shown as a cellular tower for simplicity). As may be seen, transmitter unit 354 transmits control commands over a communication link 708 to cellular network element 704. Cellular network element 704 then transmits the control commands through communication link 712 to receiver unit 358. Alternatively, receiver unit 358 transmits communication signals over communication links 712 and 708 by way of network element 704 to transmitter unit 354. In one particular embodiment, receiver unit transmits short message service (SMS) messages to transmitter unit 354 through network element 704. The SMS messages include at least one of a receiver ID, a receiver location (a GPS determined location), and a time. Such communications through network element 704 may be continuous or upon a specified condition. For example, if a location of receiver 358 is one that is more than a specified distance from a last known location of transmitter 354, the cellular network is utilized to relay communications between transmitter unit 354 and receiver unit 358. Generally, however, any form of cellular based protocols and message or data formats may be used. The example of SMS messages is for one of many embodiments.

Another aspect of the embodiment of FIG. 60 and other embodiments is that receiver 358 is operable to generate reports for uploading either to transmitter 354 or to another device. For example, receiver 354 is operable to generate stimulation reports that detail stimulation in relation to a fence boundary. Receiver unit 358 is further operable to generate stimulation reports that detail stimulation in relation to time of a stimulation. It should be clear that the receiver units include at least one module for transmitting data and/or communication signals to another device such as transmitter unit 354.

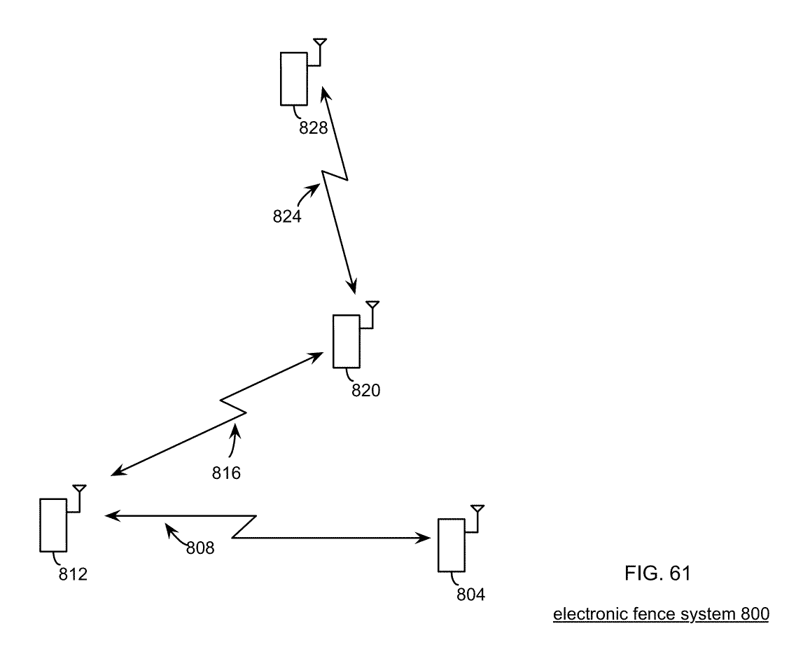

FIG. 61 is a functional network diagram of a mesh network of electronic fence components according to one embodiment of the invention. As may be seen, transmitter unit 804 is operable to communicate over a communication link 808 with a transmitter unit 812. Similarly, transmitter unit 812 is operable to communicate over a communication link 816 with a transmitter unit 820. Transmitter unit 820 is operable to communicate over a communication link 824 with a receiver unit 828.

In operation, control commands intended for receiver unit 828 may be transmitted to receiver unit 828 by way of transmitter units 812 and 820. In one particular embodiment, when receiver unit 828 is out of range for transmissions from transmitter unit 804, transmitter unit transmits control commands with an indication that the message is to be relayed onward by any transmitter device that receives the message. This indication may be in any form or format and will typically be defined as such in a message header. For example, if a message type is defined as “broadcast”, any transmitter unit that receives a broadcast message repeats the transmission. Thus, in this example, transmitter unit 812 receives a broadcast type message and forwards the message. Transmitter unit 820 receives the broadcast type message transmitted by transmitter 812 and subsequently forwards the message that is then received by the originally intended recipient receiver unit 828.

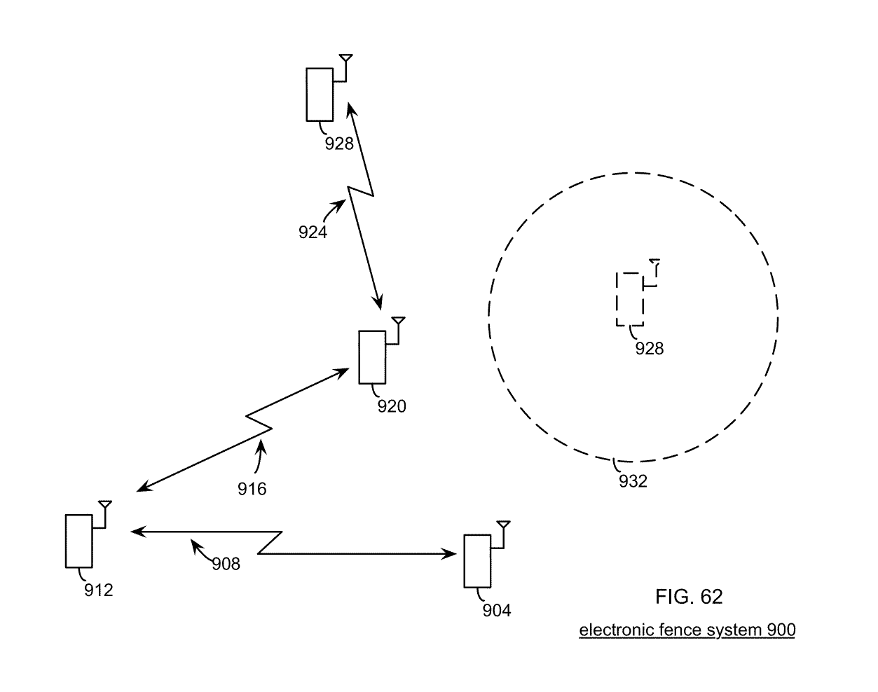

FIG. 62 is a functional network diagram of a mesh network of electronic fence components according to one embodiment of the invention. As may be seen, transmitter unit 904 is operable to communicate over a communication link 908 with a receiver unit 912. Similarly, receiver unit 912 is operable to communicate over a communication link 916 with a receiver unit 920. Receiver unit 920 is operable to communicate over a communication link 924 with a receiver unit 928. As may be seen, an electronic fence 932 includes encompasses a receiver unit 928 shown in a dashed line to represent a location close enough to support direct communications between transmitter unit 904 and receiver unit 928. If, however, receiver unit 928 migrates to the location shown (i.e., one that is too far to be within communication range with transmitter unit 904), then a mesh network as shown in FIG. 9 is operable to deliver control commands and to support communications between receiver unit 928 and transmitter unit 904.

In operation, control commands intended for receiver unit 928 may be transmitted to receiver unit 920 by way of receiver units 912 and 920. In one particular embodiment, when receiver unit 928 is out of range for transmissions from transmitter unit 904, transmitter unit 904 transmits control commands with an indication that the message is to be relayed onward by any receiver device that receives the message. This indication may be in any form or format and will typically be defined as such in a message header. For example, if a message type is defined as “broadcast”, any receiver unit that receives a broadcast message repeats the transmission. Thus, in this example, receiver unit 912 receives a broadcast type message and forwards the message. Receiver unit 920 receives the broadcast type message transmitted by receiver unit 912 and subsequently forwards the message that is then received by the originally intended recipient receiver unit 928.

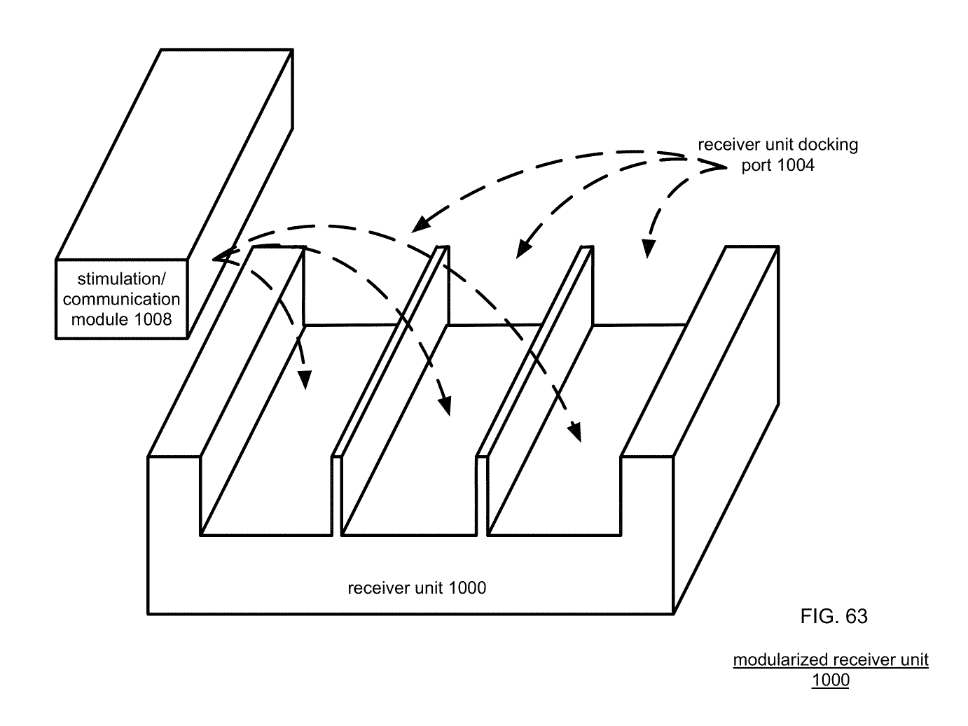

FIG. 63 is a functional block diagram of a modularized receiver unit 1000 according to one embodiment of the invention. As may be seen, a receiver unit 1000 includes at least one receiver unit docking port 1004 that receives at least one stimulation/communication module 1008. Stimulation/communication module 1008 is one that performs any type of previously described stimulation including shock, vibration, sound (beeps, tones, bells, buzzers, user voice), etc. Alternatively, stimulation/communication module 1008 may be one that supports any type of wireless radio frequency communication or operational task. For example, one module 1008 may be one that supports cellular based wireless communications including the SMS text messaging, mesh networking to relay communications, ordinary peer-to-peer communications (e.g., walkie talkie type communications directly between transmitter and receiver units. Additionally, one module may comprise a GPS radio receiver and one module may comprise a module that provides programmable reporting functions. Generally, any function described herein this specification may be disposed within a module 1008 that may be coupled to receiver unit 1000 through a receiver unit docking port 1004. The specific features of any one module 1008 are not shown here as such features may readily be modified by design implementation.

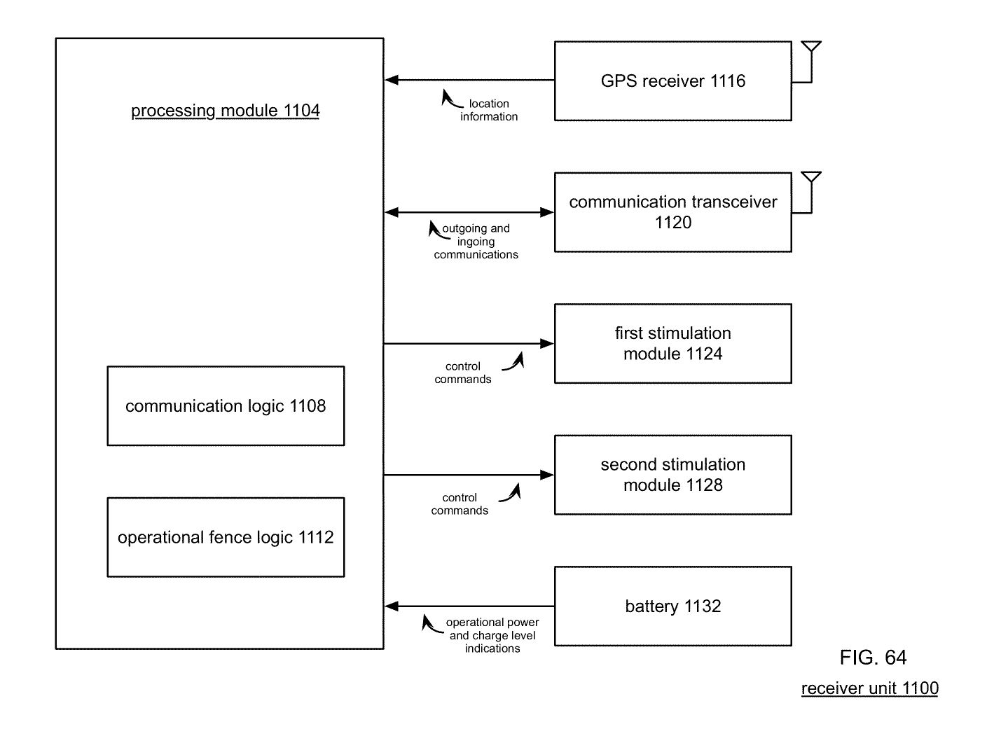

FIG. 64 is a functional block diagram of a receiver unit according to one embodiment of the present invention. A receiver unit 1100 includes a processing module 1104 that executes operational logic to implement the various operational aspects according to the various embodiments of the invention. Processing module 1104 includes communication logic 1108 and operational fence logic 1112 in support of such embodiments. Receiver unit 1100 includes a GPS receiver unit 1116 that produces location information, a communication transceiver 1120 that processes outgoing communications and ingoing communications, first and second stimulation modules 1124 and 1128 and a battery 1132. Processing module 1104 produces control commands to modules 1124 and 1128 and receives power and battery charge indications from batter 1132.

In operation, processing module receives control commands through communication receiver 1120 and location information from GPS receiver 1116 and implements corresponding electronic fences as described elsewhere in this specification. Operational logic 1112 can include any operational logic described herein including the reporting logic to support reporting as described herein. It should be understood that other circuit elements or modules might be included though they are not shown here.

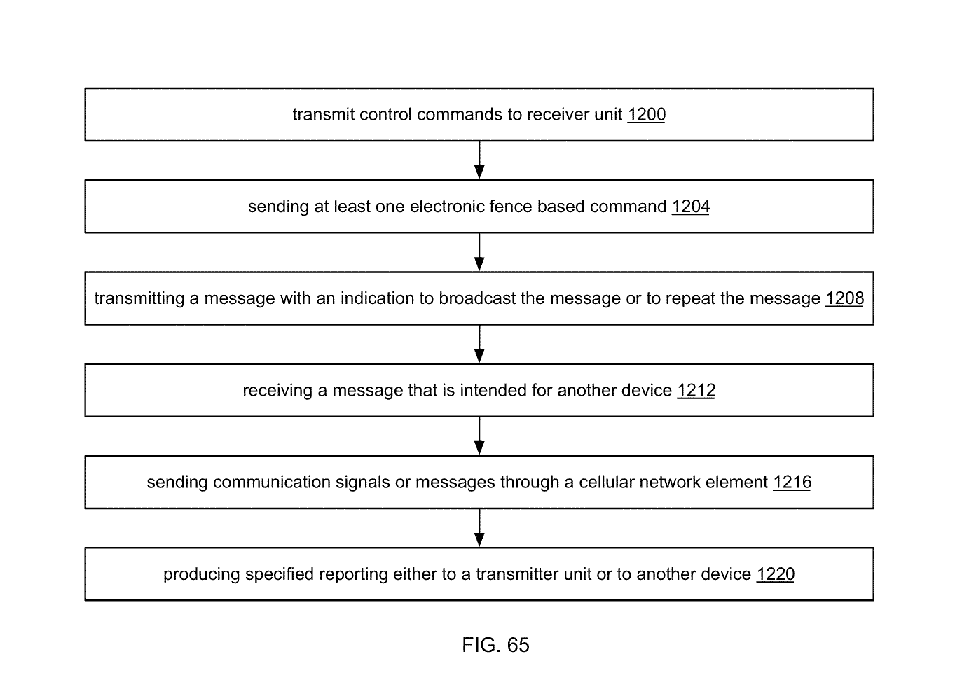

FIG. 65 is a flow chart that illustrates operation according to one embodiment of the invention. Referring now to FIG. 12, a method begins with a transmitter unit transmitting control commands to a receiver unit to specify operational characteristics (step 1200). These characteristics include stimulation parameters include, for example, at least one of a shock level or intensity, a sound clip (could be one of a plurality of stored sound clips), a vibration level, and/or a duration of any of these or other stimulations. If a GPS receiver and associated logic is present in the fence system, the method includes sending at least one electronic fence based command (step 1204). Such a command could include, for example, to specify at least one fence boundary related parameter, a location parameter, a designation command (e.g., to specify a present receiver location as a center of a fenced in area or, alternatively, a fence boundary point or coordinate. The command could also include a command to enter a specified mode such as a lock-down mode as described elsewhere herein. The method may also include, for either a transmitter or a receiver unit, transmitting a message with an indication to broadcast the message or to repeat the message (step 1208). Alternatively, for a transmitter or a receiver, the method can include receiving a message that is intended for another device (e.g., another receiver unit) and rebroadcasting the received message (step 1212). As such, transmitter and receiver units are operable to create mesh network to deliver messages (e.g., control commands) that are intended for a specified receiver that are out of range for a transmitter unit that initiated the message). The method also includes optionally sending communication signals or messages through a cellular network element to create a communication link between a transmitter unit and a receiver unit (step 1216). Finally, the method includes the receiver unit producing specified reporting either to a transmitter unit or to another device (step 1220). This reporting may be produced and transmitted over airwaves as RF signals or through a connected cable.

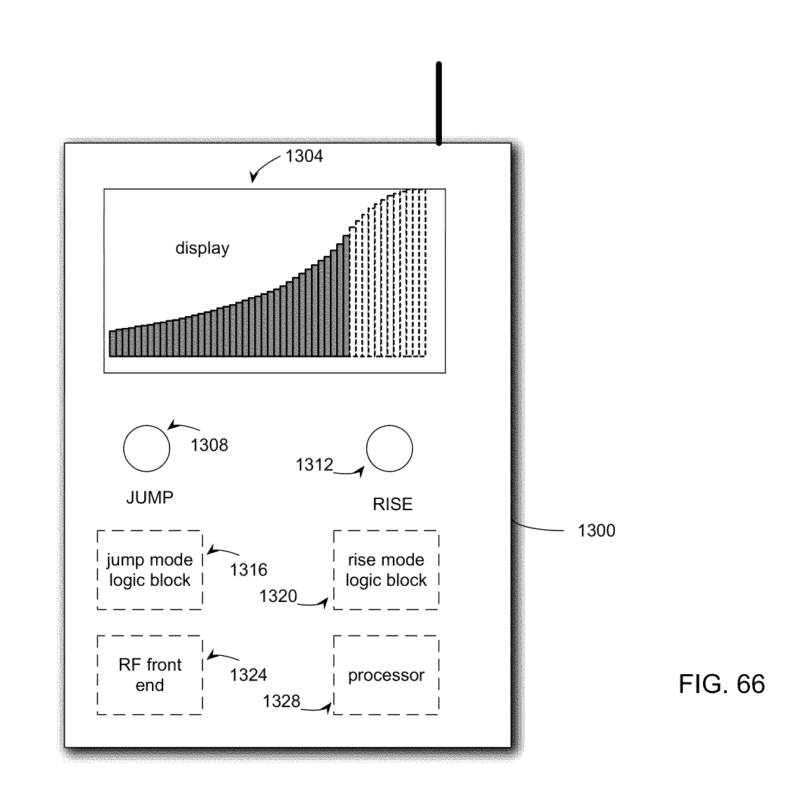

FIG. 66 is a functional block diagram of a hand held transmitter unit for an animal training system according to one embodiment of the invention. As may be seen, the transmitter unit 1300 includes a display 1304 for indicating current stimulation level, a Jump mode button 1308 for selecting the Jump mode of operation, a Rise mode button 1312 for selecting a Rise mode of operation, as well as a plurality of circuit blocks 1316-1328 shown in dashed lines to indicate internal device elements that control the operation of the transmitter unit. Each of the circuit blocks may be formed as discrete state logic or circuit elements or by computer instructions stored in memory and executed by a processor. Thus, the circuit blocks 1316-1328 include logic blocks for the Jump mode of operation, the Rise mode of operation, and RF front end for upconverting an outgoing signal produced by the logic blocks or the processor to a radio frequency for wireless transmission and, of course, a processor block which control and defines operation of the transmitter unit.

If the any of the logic blocks or the processor block produces an output signal in a digital form, analog-to-digital conversion circuitry is included to enable the RF front end to up-convert an outgoing signal from a low frequency (either baseband or an intermediate frequency) to a radio frequency for wireless transmission. The RF front end may implement either a two-step process or a single step process for up-converting to RF. One of average skill in the art may readily determine particular RF front designs appropriate for the present application.

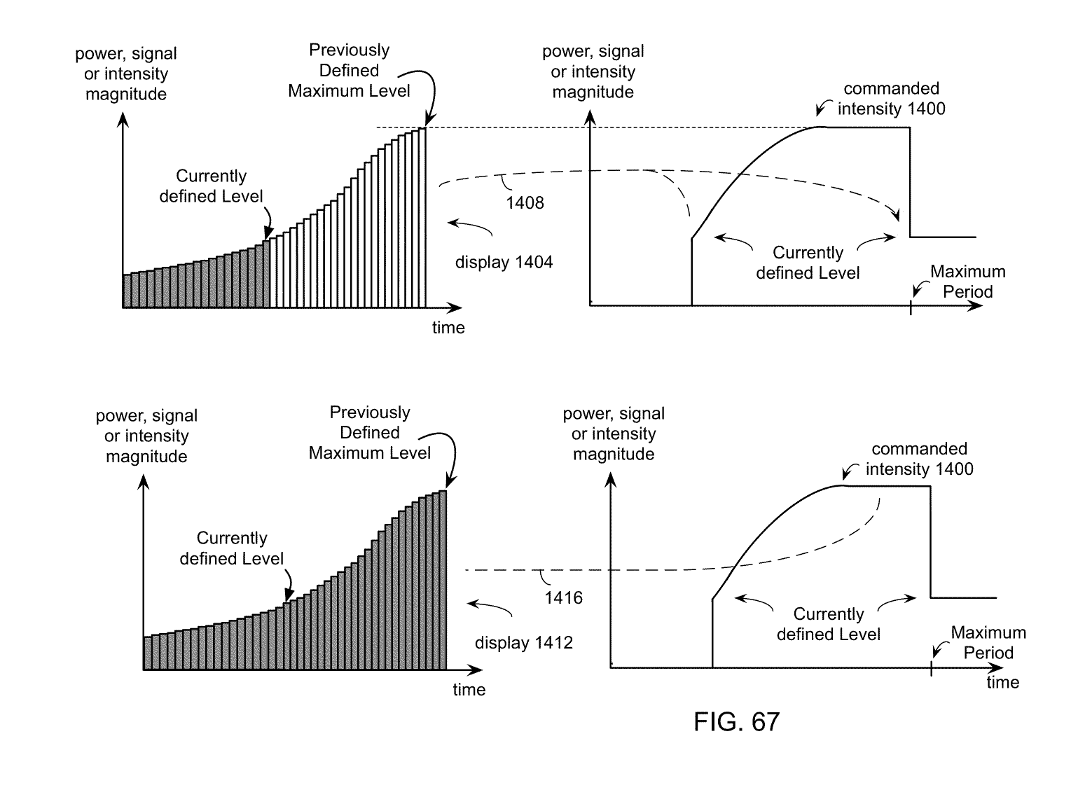

FIG. 67 is a plurality of diagrams that illustrate hand held controller displays in relation to transmitter commanded intensity curves that reflect operation of a controller according to one embodiment of the invention for the Rise mode of operation. Referring to FIG. 67, it may be seen that, upon depression of the Rise mode button, that the commanded intensity 1400 of the stimulation increases from a currently defined level to a previously defined maximum level. The intensity may be commanded in any one of a plurality of different methods as will be described in greater detail in reference to at least one figure that follows. The left hand side of FIG. 18 illustrates the display, according to one embodiment of the invention, of the controller in relation to the commanded intensity shown on the right hand side of the Figure at the points identified by the dashed arrows. Upon an initial depression of the Rise Mode button, the commanded intensity is the currently defined level (for normal operation). This level of intensity and the corresponding display 1404 is as shown by the dashed line 1408. The commanded intensity then increases until the Rise Mode button is released or, as shown on the bottom left and bottom right diagrams, when the maximum level is reached. The display 1412 illustrates a display when the commanded intensity 600 has reached the maximum level as indicated by dashed line 1416.

The maximum level may be predefined by the user or within internal controller logic. In the described embodiment, the predefined maximum level defined by the user cannot exceed the maximum level defined with the internal controller logic and can only be set to a value that is less than or equal to the maximum level defined within the controller logic.

After a specified period of the stimulation being at the maximum level, the intensity drops down immediately at a single point to the currently defined level as is indicated by the two commanded intensity curves. This may be seen on the time line at “Maximum Period”. Thus, when the Rise mode button is initially depressed, the display shows an intensity level that begins at the currently defined level. Thereafter, the displayed intensity level increases until a maximum intensity is reached. The display for the maximum intensity is the lower of the display graphs on the left hand side of the Figure (display 1412). Once a maximum period has been reached for the commanded intensity, the intensity level drops to the currently defined level and the display of the upper left hand side of the Figure is displayed again.

Thus, the display gradually increases from the top display 1404 to the bottom display 1412 on the left hand side of the Figure from initial depression of the Rise mode button until the maximum commanded intensity is reached. From that point forward until a maximum period is reached, display 1412 is seen. After the maximum period is reached, though, for the commanded intensity, the display instantly reverts from the bottom left hand display to the upper left hand display since, as shown on the right hand side, the commanded intensity drops instantly.

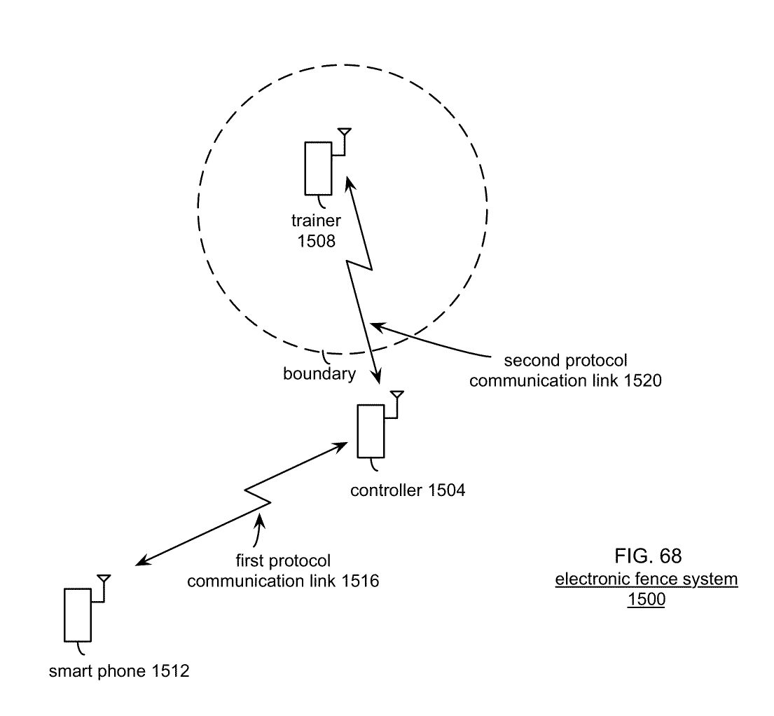

In an alternative embodiment of the invention, as shown in FIG. 68, an electronic fence system 1500 includes a controller 1504 that communicates with a trainer 1508 (ie., an electronic collar or control object) and also communicates with a smart phone 1512. The controller 1504 and the smart phone 1512 communicate over a first protocol communication link 1516. The controller 1504 and the trainer 1508 communicate over a second protocol communication link 1520.

In this embodiment, controller 1504 generates display and/or audio signals that are transmitted to the smart phone 1512 associated with the training system. These signals are transmitted according to a first communication protocol. The first communication protocol is anyone of a wireless IEEE 802.11 based communication protocol, a Bluetooth or other personal area network protocol or even a wired communication protocol. In one embodiment, a tether couples controller 1504 to smart phone 1512. In another embodiment, smart phone is received by a cradle or dock that includes or is coupled to the controller 1504. In either embodiment, a smart phone port is used to carry communications between the controller 1504 and the smart phone 1512. The second communication protocol may be a standard communication protocol or a proprietary protocol. In the described embodiments of the invention, the second communication protocol is one that has a carrier frequency of approximately 27 MHz, 150 MHz, 400 MHz, 900 MHz, 2.4 GHz or 5.8 GHz.

In this embodiment, the electronic fence operational logic resides primarily in the controller. The smart phone includes at least one software module that defines display and audio logic as well as communication logic to support the training related communications with the controller 1504.

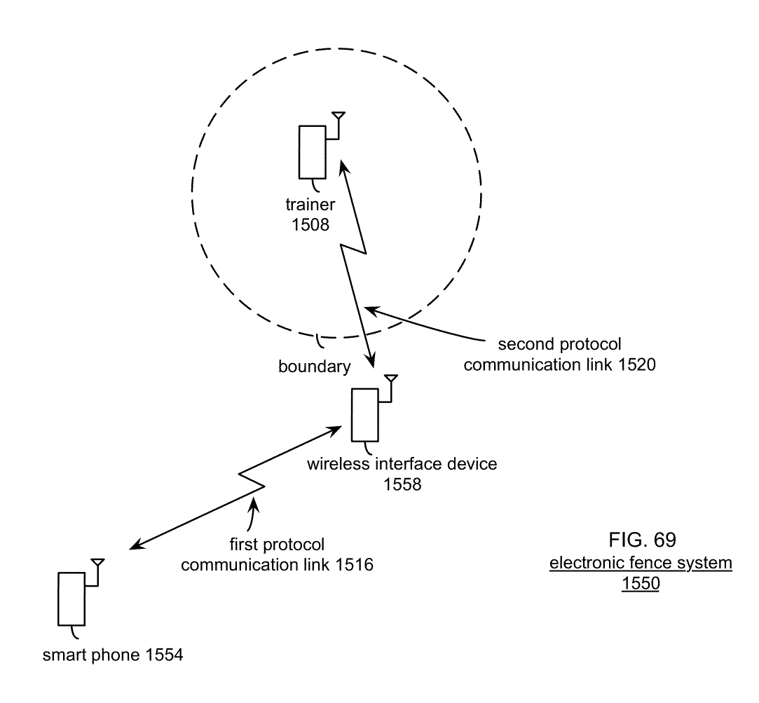

In an alternative embodiment of the invention, as shown in FIG. 69, an electronic fence system 1550 includes a smart phone 1554 that communicates with a wireless interface device 1558 which, in turn, communicates with a trainer 1508 (ie., an electronic collar or control object). The smart phone 1554 and the wireless interface device communicate over a first protocol communication link 1516. The interface device 1558 and the trainer 1508 communicate over a second protocol communication link 1520.

In this embodiment, smart phone 1554 generates display and/or audio signals that are presented to a user associated with the training system. The user response, if any, is then processed by smart phone 1554 to support the various training modes and operations described herein. Associated control commands and other signals intended for trainer 1508 are then according to the first communication protocol to the wireless interface device 1558. The first communication protocol is anyone of a wireless IEEE 802.11 based communication protocol, a Bluetooth or other personal area network protocol or even a wired communication protocol. In one embodiment, a tether couples controller 1504 to smart phone 1512. In another embodiment, smart phone is received by a cradle or dock that includes or is coupled to the controller 1504. In either embodiment, a smart phone port is used to carry communications between the controller 1504 and the smart phone 1512. The second communication protocol may be a standard communication protocol or a proprietary protocol. In the described embodiments of the invention, the second communication protocol is one that has a carrier frequency of approximately 27 MHz, 150 MHz, 400 MHz, 900 MHz, 2.4 GHz or 5.8 GHz.

In this embodiment, the electronic fence operational logic resides primarily in the smart phone. The smart phone includes at least one software module that defines display and audio logic as well as communication logic to support the training related communications with the controller 1504. Additionally, the smart phone includes at least one software module that defines training associated logic as described herein. The wireless interface device 1558 primarily converts training related communications between the first and second protocols for transmission over the first and second protocol communication links.

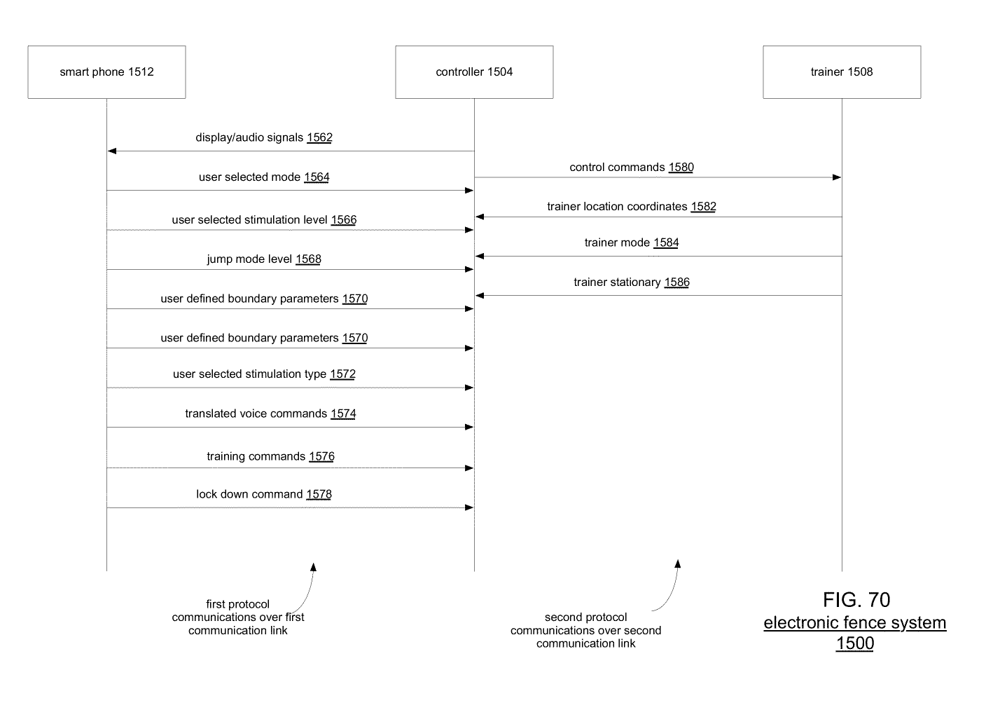

FIG. 70 is a signal sequence diagram that illustrates first and second protocol communications for electronic fence system 1500. The signal flow diagram of FIG. 70 includes controller 1504 transmitting at least one of display and audio signals to smart phone 1512 (1562). In one embodiment, these signals are part of providing a list of selectable options to a user of smart phone 1512. The method also includes smart phone 1512 sending an indication of a user selected mode of operation (1564), a user selected stimulation level (1566), a jump mode level (1568) in one embodiment of the invention. The method further includes smart phone 1512 sending user defined boundary parameters to establish an electronic fence (1570).

As described elsewhere, there are many embodiments of the characteristics and shape of an electronic fence. In one embodiment, the parameters may include a central GPS coordinate and one or more radii that define a corresponding one or more circular fence areas. Accordingly, as shown, one or more signals may be transmitted from smart phone 1512 to controller 1504 to deliver boundary parameters. The boundary parameters may also includes a plurality of GPS coordinates or coordinates relative to a single GPS coordinate. For the various embodiments, a user may also specify a user selected stimulation type (1572) such as vibration, shock, a tone or series of tones, voice, etc. These stimulation types may also be selected in relation to a particular boundary. If, for example, a plurality of boundaries are defined, the different boundaries may have different types and/or levels of stimulation.

One aspect of the embodiments of the present invention is that smart phone 1512 is configured to receive user voice commands and to send translated voice commands to controller 1504 (1574). In one particular embodiment, a received voice command is translated to text (digital data) which is then compared to a list of electronic fence system related commands. A matching related commands is then sent to controller 1504 as a translated voice command. Additionally, other training commands may be sent (1576) by smart phone 1512. Finally, in one embodiment, smart phone 1512 may send a lock down command may be sent (1578) to controller 1504 which lock down commands may be selected either by voice or by selection of a soft switch or a button on the smart phone.

Controller 1504 also communicates with trainer 1508. Based on any one or more of the described signals received from smart phone 1512, controller 1504 transmits one or more associated control commands (1580) to trainer 1508 that are in a standard or protocol that is recognized by trainer 1508. Trainer 1508 transmits trainer location coordinates to controller 1504 (1582). Trainer 1508 also transmits a trainer mode indication to controller 1504 (1584). Finally, in one embodiment, trainer 1508 transmits an indication that the trainer is stationary (1586).

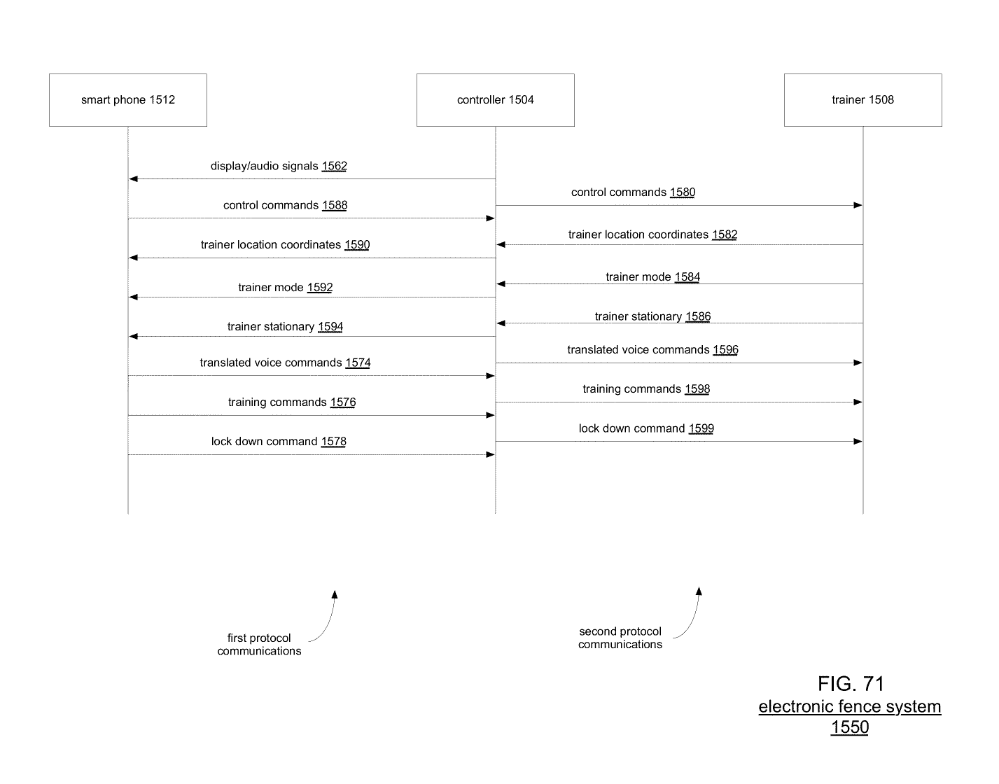

FIG. 71 is a signal sequence diagram that illustrates first and second protocol communications for electronic fence system 1550. As may be seen, may of the signals discussed in relation to FIG. 70 are shown here. Here, smart phone 1512 transmits control commands (1588) to controller 1504. These control commands may be any of the control commands discussed in relation to FIG. 70. Controller 1504 transmits trainer location coordinates to smart phone 1512 (1590). Controller 1504 also sends trainer location coordinates to smart phone 1512 as well as a trainer mode (1592), an indication that the trainer is stationary (1594). Smart phone 1512 sends translated voice commands (1574), training commands (1576) and a lock down command (1578) based upon user selection or activation of the commands as discussed before. Some of these signals transmitted by controller 1504 are based on signals sent by trainer 1508. For example, trainer 1508 transmits the trainer location coordinates (1582), a trainer mode (1584), and an indication that the trainer is stationary (1586) to controller 1504. Controller 1504 transmits translated voice commands (1596), training commands (1598) and a lock down command (1599) based on associated signals received from smart phone 1512 as previously discussed.

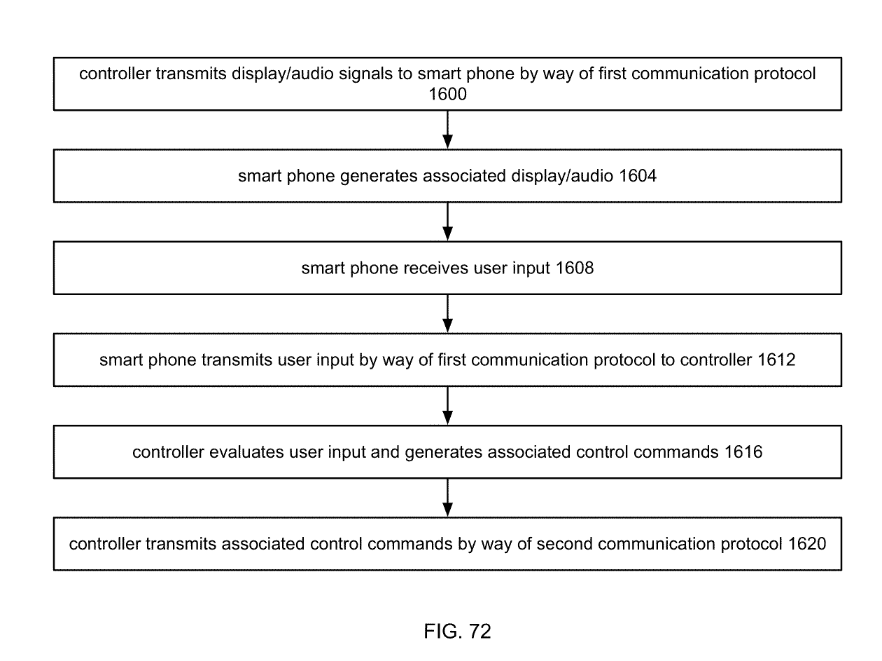

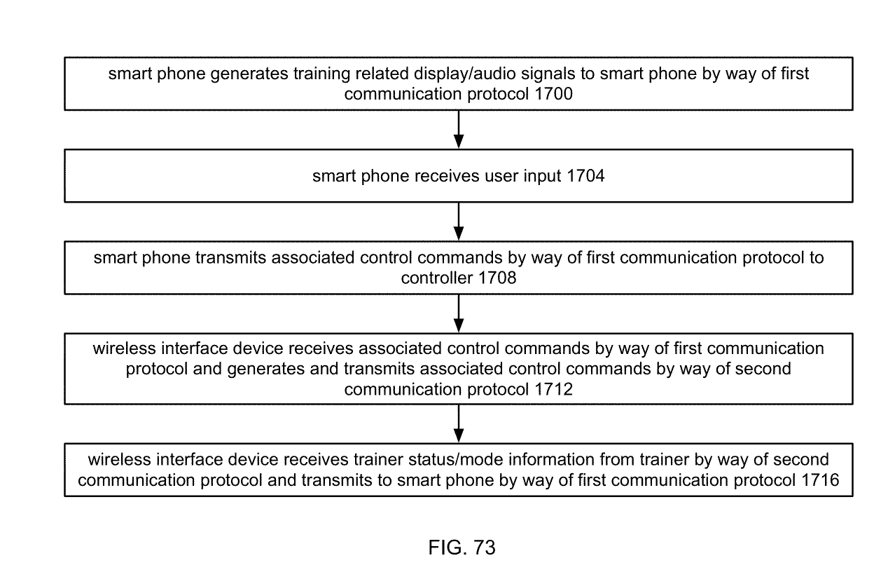

FIGS. 72 and 73 are flow charts that illustrate a method for training associated electronic fence systems 1500 and 1550. Referring to FIG. 72, a controller transmits display/audio signals to a smart phone by way of a first communication protocol (1600). The smart phone generates associated display/audio (1604). The smart phone then receives user input(s) (1608) and sends the user input to the controller by way of the first communication protocol (1612). The controller, in the described embodiment, evaluates the user input and generates associated control commands formatted into a format that the trainer is configured to recognize (1616). Finally, the controller transmits associated control commands by a way of a second communication protocol to the trainer (1620).

FIG. 73 illustrates an alternative embodiment of the invention in which the controller is replaced by a wireless interface device. Here, the interface device generates training related display/audio signals to the smart phone by way of a first communication protocol (1700). The smart phone accordingly generates the display/audio and receives user input (1704). The smart phone transmits associated control commands by way of the first communication protocol to the interface device (1708). The wireless interface device receives the associated control commands by way of the first communication protocol and generates and transmits associated control commands by way of the second communication protocol (1712). Finally, the wireless interface device receives trainer status/mode information from trainer by way of second communication protocol and transmits to the smart phone by way of the first communication protocol.

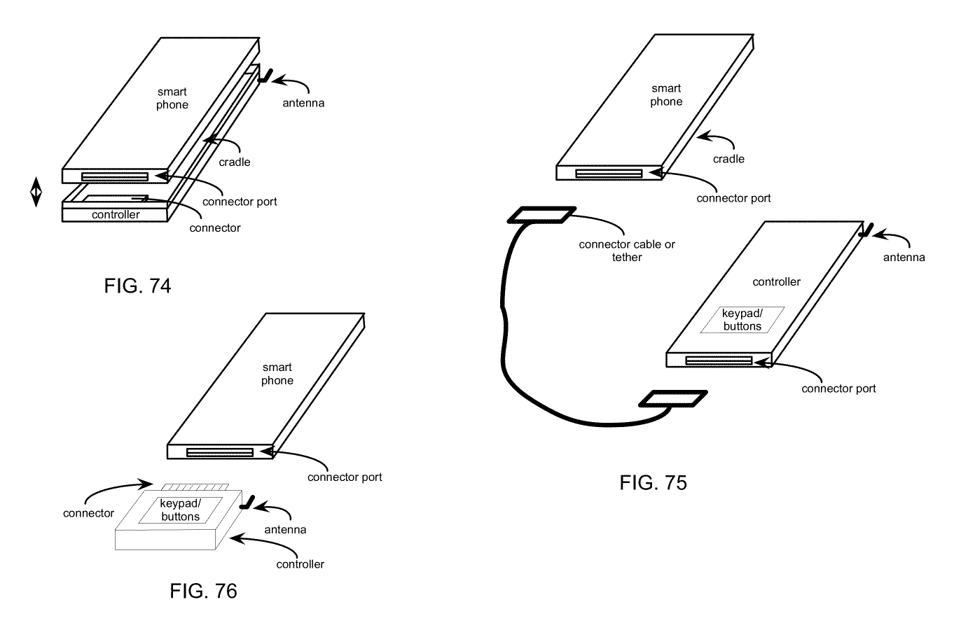

FIG. 74 illustrates one embodiment of a smart phone and controller in which the controller forms a cradle to receive and hold the smart phone. The controller includes a connector that couples to a connector port of the smart phone. The controller includes an antenna and radio transceiver circuitry configured to communicate according to the second communication protocol with a trainer.

FIG. 75 illustrates a controller and a smart phone that are configured to communicate by way of a tether or cable that is further configured to couple to connector ports of both the smart phone and the controller. Here, the controller includes a keypad and buttons to allow a user to generate user input directly on the controller as well as user input that is received by the smart phone. The controller includes a connector that couples to a connector port of the smart phone. The controller includes an antenna and radio transceiver circuitry configured to communicate according to the second communication protocol with a trainer.

FIG. 76 illustrates an embodiment in which the controller includes a connector that is configured to mate with a connector port of the smart phone. Here, rather than forming a cradle that physically can receive and hold the smart phone as in the embodiment of FIG. 74, the controller merely attaches to the smart phone as an add on device. In the described embodiment, the controller includes a keypad and buttons to allow a user to generate user input directly on the controller as well as user input that is received by the smart phone. The controller includes a connector that couples to a connector port of the smart phone. The controller includes an antenna and radio transceiver circuitry configured to communicate according to the second communication protocol with a trainer.

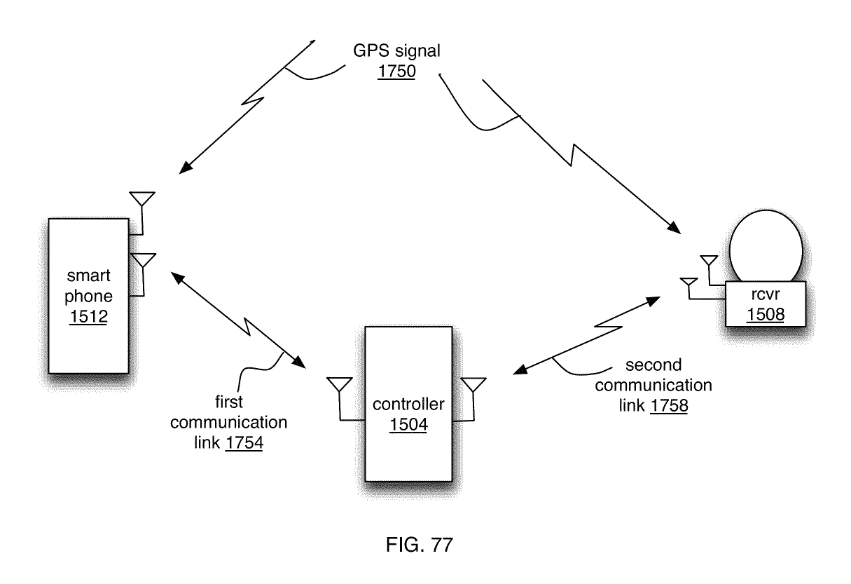

FIG. 77 is a functional block diagram of an electronic fence system according to one embodiment of the invention. As may be seen, both smart phone 1512 and receiver 1508 are configured to receive GPS signals to determine their own present locations. Receiver 1508 is a dog training receiver that may sometimes be referenced as a trainer. In one embodiment, each has dedicated transceiver circuitry and a dedicated antenna for receiving the GPS signals 1750 from one or more GPS satellites. Smart phone 1512 also communicates with controller 1504 via a first communication link 1754 according to a first communication protocol. The first communication protocol may be either Bluetooth or other personal area network communication protocol, an I.E.E.E. 802.11 or other WLAN protocol, or an infrared protocol such as IrDA. Smart phone 1512 may also be directly coupled via a tether, cable, or by mating connectors. Controller 1504 in turn communicates with receiver 1508 via a second communication link utilizing a second communication protocol that trainer/receiver 1508 is configured to recognize. In the described embodiment, the second communication link and associated protocol is a relatively lower frequency communication channel in relation to Bluetooth and I.E.E.E. 802.11 communication protocols. Utilizing a lower frequency communication signal supports longer range communications between the controller and the trainer/receiver 1508. In one embodiment, the lower frequency channel is within the range of 25 MHz to 250 MHz. In one particular embodiment, the lower frequency channel operates at a frequency that is approximately equal to 150 MHz.

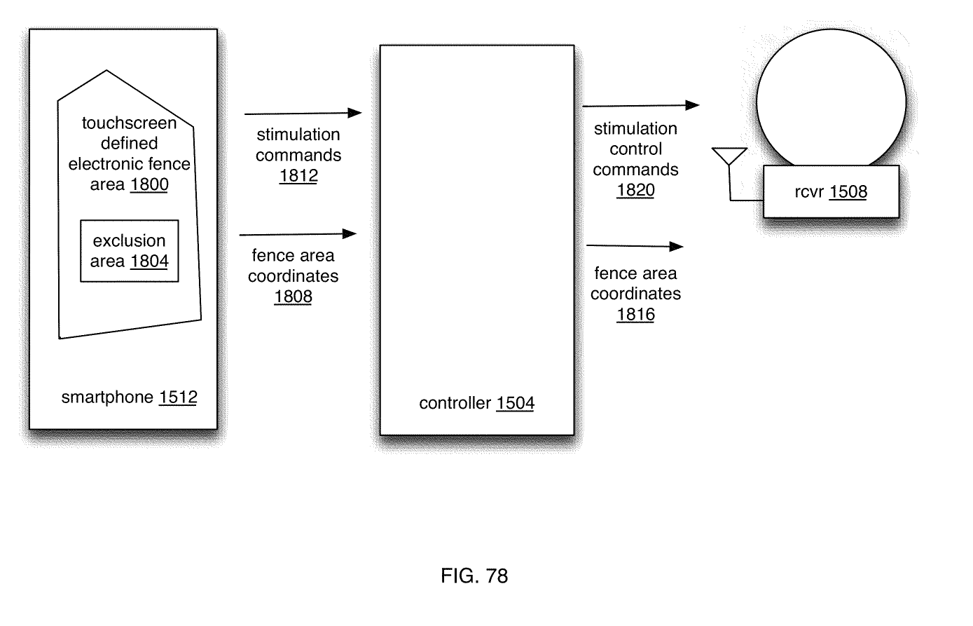

FIG. 78 illustrates one aspect of the described embodiments of the invention. A user utilizes smart phone technology to define an electronic fence area by selecting points on a touchscreen of the smart phone. In one particular embodiment, the smart phone generates a map or image of a terrain in relation to one or more GPS coordinates. The user then may touch boundary locations on the map or image. A smart phone logic is configured to translate the identified locations on the map or image into approximate GPS coordinates. The smart phone logic then graphically connects each identified location to establish an electronic fence area. As may be seen in FIG. 78, smartphone 1512 has a touchscreen defined electronic fence area 1800 shown on the display of smartphone 1512.

As may further be seen, in one embodiment of the invention, logic of smartphone 1512 is further configured to enable the user to define an exclusion area in which the stimulation modes of the trainer are disabled. For example, the trainer mode may be disabled for an area that includes a lake or pond to prevent excessive stimulation or other adverse effects upon the animal.

The electronic fence system is, in one embodiment, configured to also automatically disable stimulation if and when GPS signal strength falls below a specified threshold. For example, if a dog goes into a house and fails to receive GPS signals for a period of time, its estimated location can vary substantially and could cause the any one element of the electronic fence system to determine that the animal is approaching a boundary when, in fact, the animal is safely within a structure. Typically, GPS receiver systems include circuitry for predicting location even when GPS signals are not being received. Error in such systems and circuitry can, after a while, accumulate to produce grossly inaccurate approximations of location. As such, an animal may be stimulated when nowhere near a defined boundary. Thus, in one described embodiment, the stimulation is disabled when a GPS signal strength falls below a defined threshold. In another embodiment, the stimulation is disabled only when the GPS signal strength has been below the specified threshold for a specified period of time (e.g., 1-5 minutes). The specified period may be greater than 5 minutes in other embodiments.

Referring again to FIG. 78, smartphone 1512 sends fence area coordinates, exclusion area coordinates as well as other control commands to controller 1504 (1808). Smartphone 1512 also sends stimulation commands or an indication to disable stimulation to controller 1504 (1812). Controller 1504 forwards the fence area coordinates, exclusion area coordinates as well as other control commands (1816) as well as associated stimulation commands (1820) to receiver 1508. The stimulation control commands may also be to disable stimulation based on either GPS signal strength or location of the trainer/receiver 1508.

In one embodiment of the invention, the trainer/receiver 1508 makes determinations whether to stimulate the animal. Accordingly, trainer/receiver 1508 includes logic for evaluating a present location in relation to received fence area coordinates, and exclusion zone coordinates. Based upon such evaluation, trainer/receiver 1508 is configured to determine whether to apply a stimulation. Further, trainer/receiver 1508 is configured to disable stimulation if the signal strength of received GPS signals are below a specified threshold (or have been below for a specified period).

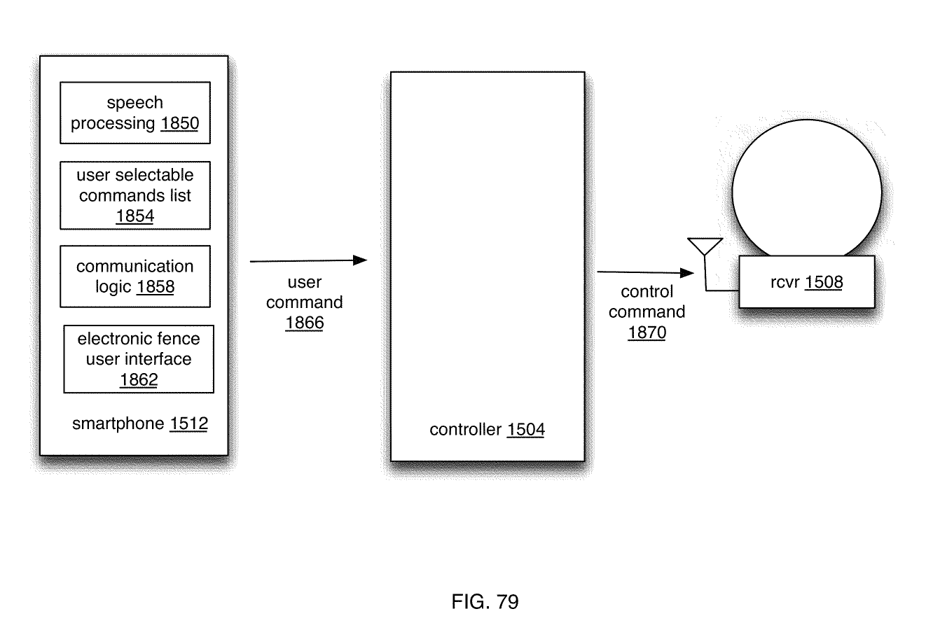

FIG. 79 is a functional block diagram that illustrates one embodiment of an electronic fence system. As may be seen, smartphone 1512 includes a speech processing block 1850 for translating user speech into text/digital data. A user selectable commands list logic 1854 is configured to compare the translated text/digital data to a list of user selectable commands. Smartphone 1512 also includes an electronic fence user interface 1862 for receiving and interpreting other electronic fence related commands that may coincide or be different from the commands listed in the user selectable commands list. Finally, smartphone 1512 includes communication logic 1858 that is configured to generate associated communication commands such as user commands 1866 that are transmitted to controller 1504. Based on the user commands 1866, controller 1504 sends control commands 1870. It should be understood that each embodiment that shows a controller 1504 may be modified by a interface device that provides a communication interface.

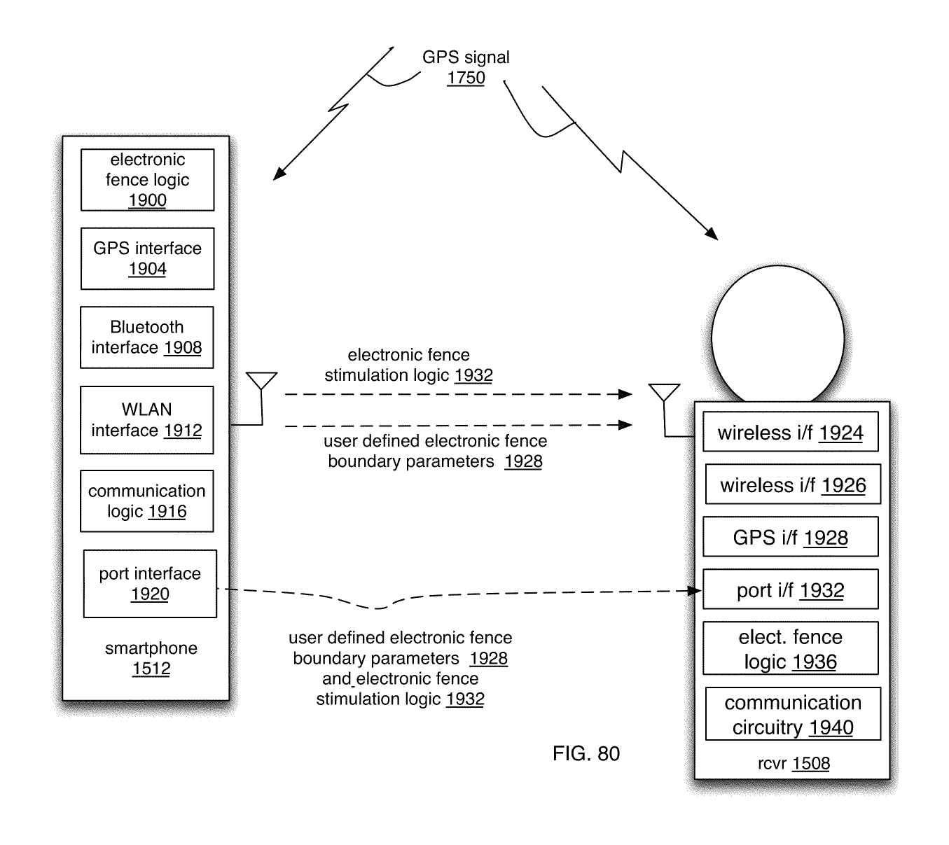

FIG. 80 is a functional block diagram of an alternative embodiment of the invention. As may be seen, smartphone 1512 includes electronic fence logic 1900, a GPS interface 1904, a Bluetooth interface 1908, a WLAN interface 1912, a communication logic 1916, and a port interface 1920. GPS interface 1904 allows the smart phone to receive GPS signals from one or more GPS satellites to determine its position. Bluetooth interface 1908 and WLAN interface 1912 allow smartphone 1512 to communicate wirelessly directly with receiver 1508. Port interface 1920 allows smartphone 1512 to be coupled by cable or tether or directly to receiver 1508. Alternatively, port 1920 may be configured to receive a connector for a memory device or hard drive.

A receiver 1508 includes one or more of a wireless interface 1924 and wireless interface 1926. Wireless interface 1924 is operable to communicate over a traditional electronic fence communication protocol with an electric fence controller. In one embodiment, wireless interface 1924 communicates over a 150 MHz frequency channel. Wireless interface 1926 is operable to communicate over at least one of a WLAN protocol or a Bluetooth protocol. Receiver 1508 further includes a GPS interface 1928 for receiving GPS data to enable receiver 1508 to determine its present location and electronic fence logic 1936 that enables receiver 1508 to support electronic fence operations according to the various embodiments of the invention. Receiver 1508 further includes a port interface 1932 to which a smart phone may be coupled by a wire or tether or directly to smartphone 1512. Alternatively, port interface 1932 can support receiving a portable hard drive or other memory device that includes electronic fence related data and commands.

Accordingly, as described in relation to other figures, smartphone 1512 is configured, using electronic fence logic 1900, to support the creation of a user defined electronic fence boundary (as previously described for multiple different embodiments). Subsequently, smartphone 1512 is configured to generate electronic boundary parameters in a specified form for receiver 1508. The generated boundary parameters may then be stored on a hard disk or other electronic memory that is coupled via port interface 1920. The generated boundary parameters may then be delivered to receiver 1508 by connecting the hard drive or memory device to the receiver 1508. Alternatively, the generated boundary parameters may be delivered via a wireless communication link (e.g., Bluetooth or an I.E.E.E. WLAN communication link). Thus, the boundary parameters may be delivered to receiver 1508 either wirelessly or via its own port interface.

Smartphone 1512 also may deliver the generated boundary parameters to receiver 1508 directly via a tether or cable 1922 connected directly to port interface 1920 of smartphone 1512. Additionally, smartphone 1512 may be, in one embodiment, coupled directly to receiver 1508 to deliver the boundary parameters. Finally, receiver 1508 includes electronic fence logic 1924.

In the described interface, smartphone 1512 is configured to deliver the boundary parameters wirelessly using either the Bluetooth interface 1908, the WLAN interface 1912 or via the port interface 1920 via a wire, tether, direct connection to receiver 1508 or memory for delivery to receiver 1508. Additionally, smartphone 1512 is configured to deliver associated electronic fence stimulation logic via the same communication means to receiver 1508.

In operation, therefore, smartphone 1512 receives GPS data to determine and support mapping operations as well as to support the creation of an electronic boundary in any of the aforementioned manners or methods. Thereafter, smartphone is operable to deliver electronic fence stimulation logic 1932 and user defined electronic fence boundary parameters 1928 to receiver 1508. This boundary information may also include defined exclusionary areas as specified before.

The receiver 1508 then is configured and operable to operate in an operational mode even if smartphone 1512 is turned off or otherwise not in communication with receiver 1508. Thus, receiver 1508 continuously compares a presently estimated location based upon GPS data and compares the presently estimated location. Based upon the user defined electronic fence boundary information it previously received, and based upon the electronic fence stimulation logic it previously received, receiver 1508 is operable to determine whether and how to stimulate an animal.

Further, in one embodiment, receiver 1508 is operable to disable all stimulation and containment of the animal if GPS signal strength 1750 has fallen below a specified level or threshold for a specified period. The specified period may be zero or it may be a specified number of minutes.

While FIG. 80 shows a smart phone in communication with receiver 1508, it should be understood that other devices may be used in place of smartphone 1512. For example, smartphone 1512 may be replaced by a controller 1504, a personal computer, a tablet or other computing device, a laptop computer, etc. One key aspect of the embodiment of FIG. 70 is that receiver 1508 receives defined electronic fence stimulation logic and electronic fence boundary parameters and may operate without any communicative coupling with a controller or smartphone to contain an animal within a specified boundary or to train the animal based upon GPS data the receiver 1508 receives from GPS satellites. Moreover, the trainer is configured to disable stimulation when GPS signals fall below a specified level.

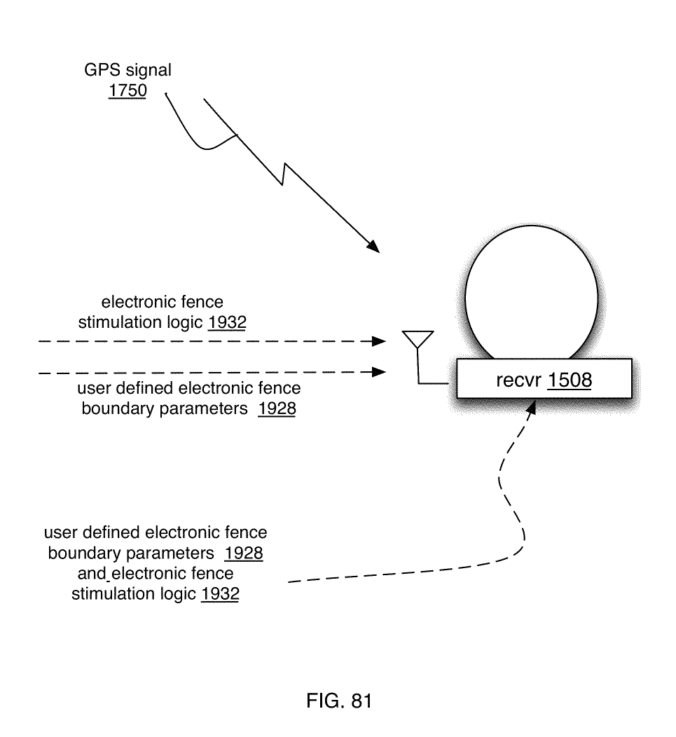

FIG. 81 is a functional block diagram of a receiver 1508 according to one embodiment of the invention. As may be seen, receiver 1508 is communicatively coupled to receive electronic fence stimulation logic 1932 and electronic fence boundary parameters 1928 either through a wireless communication channel or a direct connection (including a tethered or cabled connection or a direct connection). The communications for generating and delivering the stimulation logic and the electronic fence boundary parameters may be any one or more of a personal computer, a laptop computer, a portable computing device, a tablet, a controller, or a memory device.

Once receiver 1508 receives the stimulation logic and the electronic fence boundary parameters, receiver 1508 is configured and operable to determine when and how to stimulate an animal based upon received GPS data and an estimated location that is based upon the GPS data. Thus, the receiver is configured to operate autonomously without having to be in communication with any other controller or device having stimulation or control logic therein.

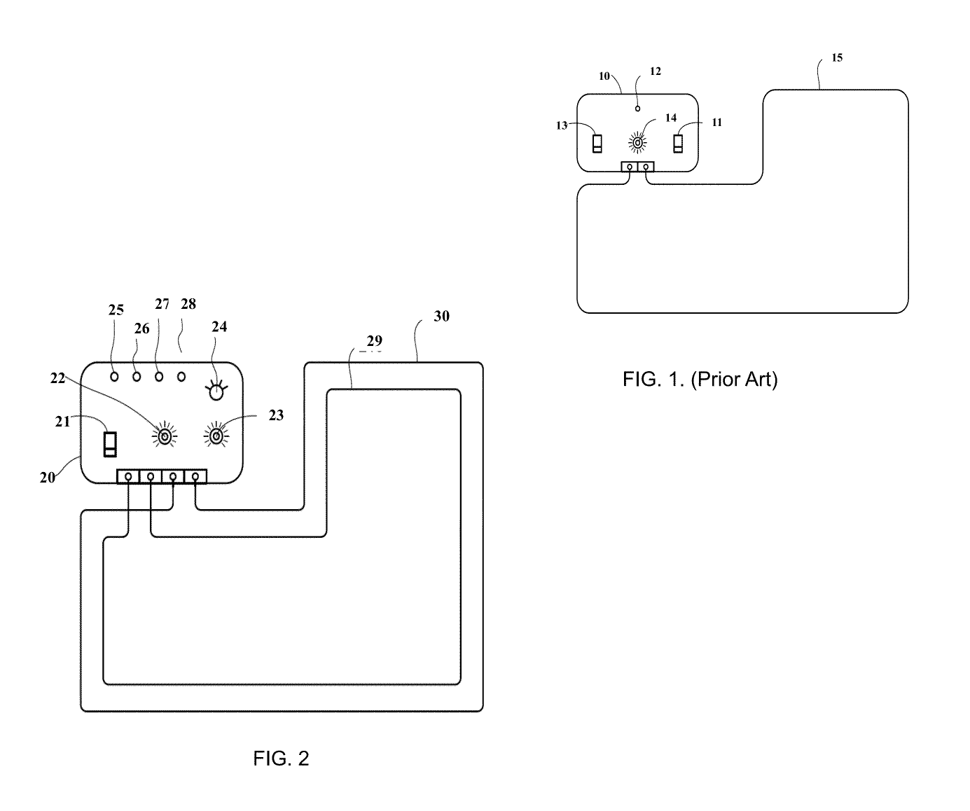

Each of the FIGS. 68-81 should be considered in view of FIGS. 1-67. Stated differently, the various operational modes and features described in relation to FIGS. 1-67 may be included within the embodiments associated with FIGS. 68-73. For example, referring to FIG. 70, the user defined boundary parameters transmitted by smart phone 1512 to controller 1504 may be parameters that define a first boundary area, a second boundary area, and/or a lock down mode boundary area. The translated voice commands may be communication signals that correspond to received training voice commands. For example, if the user speaks “lock down”, the translated voice commands may be signals that identify that the lock down command was given verbally. Alternatively, the translated voice command may merely be a defined control command that was identified based upon a translation by the smart voice of a received voice command.

While not shown here, in another embodiment, the smart phone and the controller are communicatively coupled via a wireless communication link. In one embodiment, the wireless communication link comprises a Bluetooth protocol or other personal area network communication protocol channel. The wireless communication channel may also operate according to a wireless local area network communication protocol such as I.E.E.E. 802.11 (any version) or an infrared communication protocol such as IrDA.

Generally, the embodiments of the invention may include one or more of the c oncepts illustrated in relation to the earlier figures including all current features of disclosed fence technology using GPS technology including—Plot by waypoint, plot by central point, plot by Transmitter as central, boundary within boundary, Warnings, etc.

In the embodiments of the invention, the functional portioning may vary. In one embodiment, the smart phone provides little electronic fence logic processing. Here, the smart phone largely works as a data entry device for transmitting to a controller that operates electronic fence related logic. Alternatively, the smart phone may include all operating logic described herein wherein the controller is replaced by an interface device that merely provides a communication channel interface to the receiver.

Regardless of the functional partitioning, the electronic fence system is customizable. According to design implementation, logic for generating display options for controlling the electronic fence system may be arranged and displayed to give the user options in many different manners. Moreover, known selection techniques such as shaking a cell phone in a specified manner may be used to associate such movements to defined electronic fence related commands. Additionally, specified voice commands may be associated with electronic fence modes. For example, while in an electronic fence mode, if the user shouts “STOP”, the smart phone may be programmed to correlate the STOP command to the lock down mode of operation. Accordingly, when the user shouts STOP, the smart phone transmits a lock down mode command.

The smart phone may readily be used to implement electronic fence modes defined herein such as the Jump/Rise modes of operation. The smart phone is further operable to receive and store all related information such as locations visited by the animal, number, type and location of stimulations, etc. One additional aspect of the smart phone is that cellular communications may be established between the smart phone/controller and the receiver.

The invention disclosed herein is susceptible to various modifications and alternative forms. Specific embodiments therefore have been shown by way of example in the drawings and detailed description. It should be understood, however, that the drawings and detailed description thereto are not intended to limit the invention to the particular form disclosed, but on the contrary, the invention is to cover all modifications, equivalents, and alternatives falling within the spirit and scope of the present invention as defined by the claims.

What is claimed is:

1. An electronic fence system capable of guiding animals to return to a defined area, comprising:
a smart phone;
a trainer attached to a collar worn by an animal; and
a controller that communicates with the smart phone using a first communication protocol over a first communication link and with the trainer using a second communication protocol over a second communication link wherein:
a user enters a command on the smart phone;
the smart phone receives the command and transmits an associated command to the controller; and
the controller generates a response to the trainer based upon the received command.

2. The system of claim 1 wherein the trainer receives control commands from the controller based upon user input received by the smart phone comprising at least one of electronic fence coordinate data and stimulation control commands.

3. The electronic fence system of claim 1 wherein the user input in based upon at least one of a selection of a touchscreen option, depression of a button or switch, or a voice command.

4. The electronic fence system of claim 1 wherein the system is operably configured to support a lock down mode of operation wherein the smart phone transmits a lock down mode command to the controller over the first communication link and the controller transmits a lock down mode command to the receiver over the second communication link.

5. The electronic fence system of claim 1 wherein the system is operably configured to support a jump/rise mode of operation wherein the smart phone generates jump/rise mode commands that are produced to the controller and further wherein the controller generates jump/rise commands to the receiver based upon the jump/rise commands received from the smart phone.

6. The electronic fence system of claim 1 wherein the system is operably configured to gradually increase stimulation based upon the continual selection of one of a soft button on a touchscreen display of the smart phone or a button or switch on either the smart phone or the controller.

7. The electronic fence system of claim 1 wherein the system is operably configured to jump to a defined stimulation level based upon selection of a soft button on a touchscreen display of the smart phone or depression of a button or switch on either the smart phone or the controller.

8. The electronic fence system of claim 1 wherein the system is operably configured to:
receive a voice command at the smart phone;
generate an associated command and transmitting the associated command to the coupled controller over the first communication link; and
transmit, from the controller to trainer, a second associated command over the second communication link.

9. The electronic fence system of claim 1 wherein the smart phone includes the controller wherein the controller is defined by hardware and/or software logic within the smart phone.

10. The electronic fence system of claim 1 wherein the controller is distinct from the smart phone but includes an interface for coupling to the smart phone.

11. The electronic fence system of claim 10 wherein the interface comprises a personal area network protocol communication link such as Bluetooth, a wireless local area network protocol communication link such as one of a plurality of IEEE 801.11 communication protocols, an infrared communication link or a cable.

12. The electronic fence system of claim 10 wherein the interface comprises a socket and matching connector.

13. The electronic fence system of claim 10 wherein the controller forms a cradle for receiving and securely attaching to the smart phone.

14. A controller for an electronic fence system, comprising:
first communication circuitry configured to communicate with a smart phone using a first communication protocol to exchange data and control communication signals to support an electronic fence system;
second communication circuitry configured to communicate with a trainer worn by an animal using a second communication protocol to exchange data and control communication signals to support the electronic fence system;
wherein:
the first communication protocol is one of a Bluetooth, IrDA, I.E.E.E. 802.11 wireless local area network (WLAN), or proprietary communication protocol;
the second communication protocol is characterized by a relatively lower frequency, relative to the Bluetooth and 802.11 WLAN protocol frequencies;
the controller receives fence boundary information and communicates with the trainer to prompt the trainer to stimulate the animal based upon the trainer's location in relation to the fence boundary information.

15. The controller of claim 14 wherein the controller transmits the fence boundary information and stimulation control commands to the trainer to enable the trainer to determine when and whether to stimulate an animal and how to stimulate the animal based on the location of the trainer in relation to the fence boundary information.

16. The controller of claim 14 wherein the controller identifies an exclusion area for which stimulation is deactivated to avoid inadvertent stimulation to the animal.

17. A method for an electronic fence system, comprising:
a smart phone receiving a command associated with an electronic fence system;
converting the command to a control command or fence boundary data by:
examining digital information based upon the command;
comparing the digital information to a list of electronic fence control commands;
selecting at least one electronic fence control command from the list of electronic fence commands or generating fence boundary data in a specified format; and
transmitting the converted command or fence boundary data to a fence system controller to process the converted command or fence boundary data.

18. The method of claim 17 wherein the smart phone receives voice commands and converts the voice commands to the digital information.

19. The method of claim 17 wherein the fence boundary data includes an exclusion area wherein the exclusion area is one for which stimulation is deactivated to avoid inadvertent stimulation to the animal.

20. A receiver to be worn by animal of an electronic fence system, comprising:
a global positioning satellite (GPS) communication interface for receiving GPS data from at least one GPS satellite;
at least one of a wireless communication interface or a port interface configured to be directly coupled to a device or memory device or to a tether or cable;
communication circuitry configured to communicate:
over a wireless communication channel;
through a direct connection to a controller, a smart phone or a memory device; or
via a cable or tether coupled to a controller, smart phone, computing device or memory device; and
electronic fence logic block configured to receive electronic fence stimulation logic and defined electronic fence boundary parameters and configured to stimulate an animal based upon the stimulation logic and the fence boundary parameters and further based upon an estimated location that is further based upon received GPS data.
